(19) United States
(12) Patent Application Publication
(10) Pub. No.: US 2015/0325128 A1
(43) Pub. Date: Nov. 12, 2015

(54) METHODS, SYSTEMS, AND DEVICES FOR PROVIDING TRANSPORTATION SERVICES

(71) Applicant: Elwha LLC, Bellevue, WA (US)

(72) Inventors: Richard T. Lord, Gig Harbor, WA (US); Robert W. Lord, Seattle, WA (US); Nathan P. Myhrvold, Medina, WA (US); Clarence T. Tegreene, Mercer Island, WA (US)

(21) Appl. No.: 14/318,182

(22) Filed: Jun. 27, 2014

Related U.S. Application Data
(60) Provisional application No. 61/989,394, filed on May 6, 2014.

(51) Int. Cl. G08G 1/00

(52) U.S. Cl. CPC G08G 1/20

(57) ABSTRACT

A method substantially as shown and described the detailed description and/or drawings and/or elsewhere herein. A device substantially as shown and described the detailed description and/or drawings and/or elsewhere herein.

### CROSS-REFERENCE TO RELATED APPLICATIONS

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application claims benefit of priority of U.S. Provisional Patent Application No. 61/989,394 titled RIDESHARING SCENARIOS, naming Richard T. Lord and Robert W. Lord as inventors, filed May 6, 2014, which was filed within the twelve months preceding the filing date of the present application or is an application of which a currently co-pending application is entitled to the benefit of the filing date.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein referenced method aspects. The circuitry and/or programming may be virtually any combination of hardware, software, and/or firmware configured to effect the herein referenced method aspects depending upon the design choices of the system designer, and limited to patentable subject matter under 35 USC 101.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1, including FIGS. 1A through 1BC, shows a high-level system diagram of one or more exemplary environments in which transactions and potential transactions may be carried out, according to one or more embodiments. FIG. 1 forms a partially schematic diagram of an environment(s) and/or an implementation(s) of technologies described herein when FIGS. 1A through 1BC are stitched together in the manner shown in FIG. 1AY, which is reproduced below in table format.

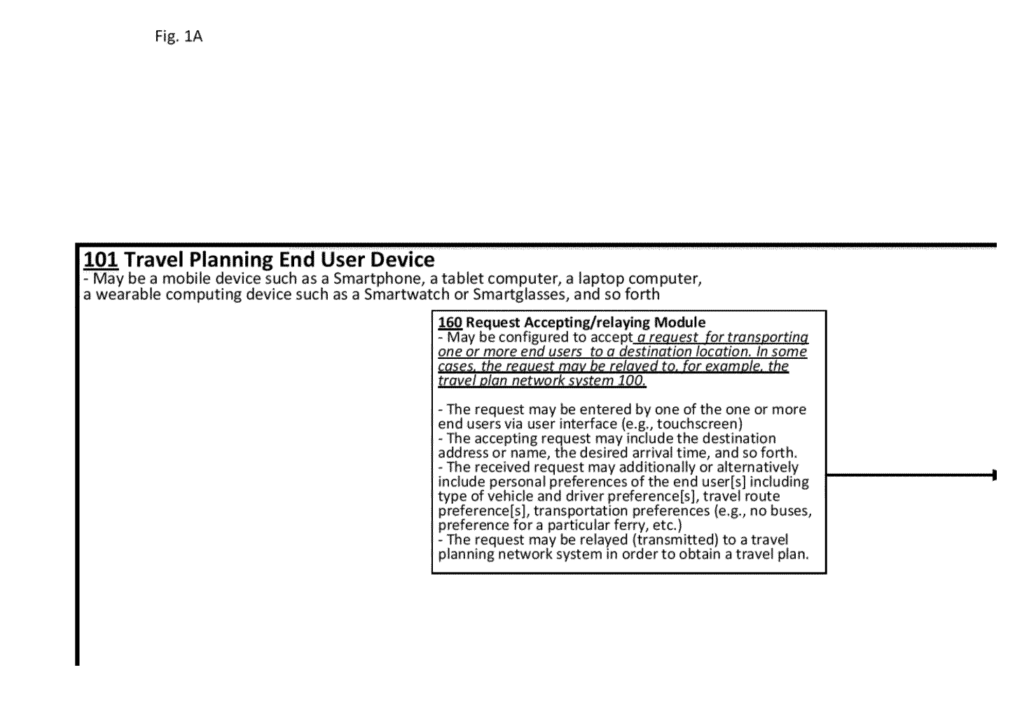

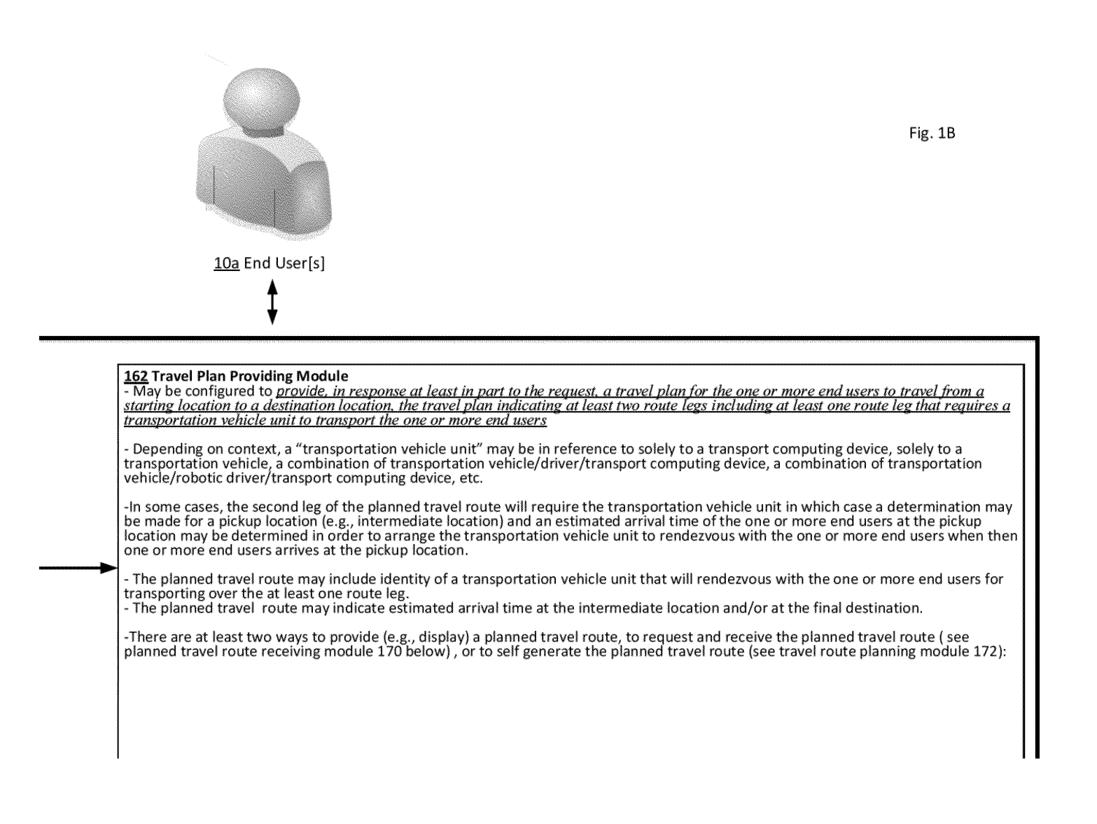

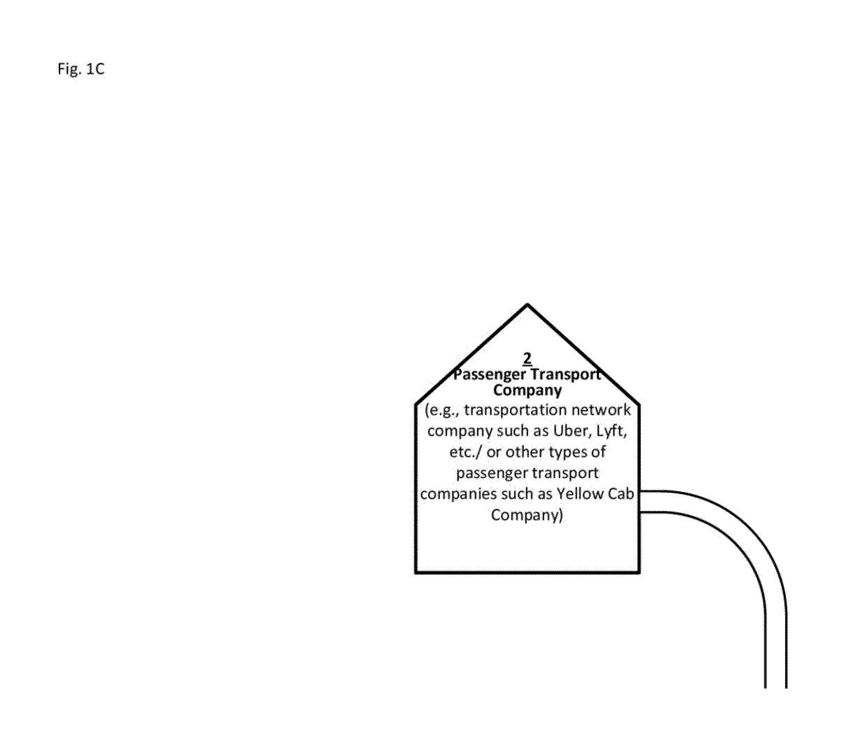

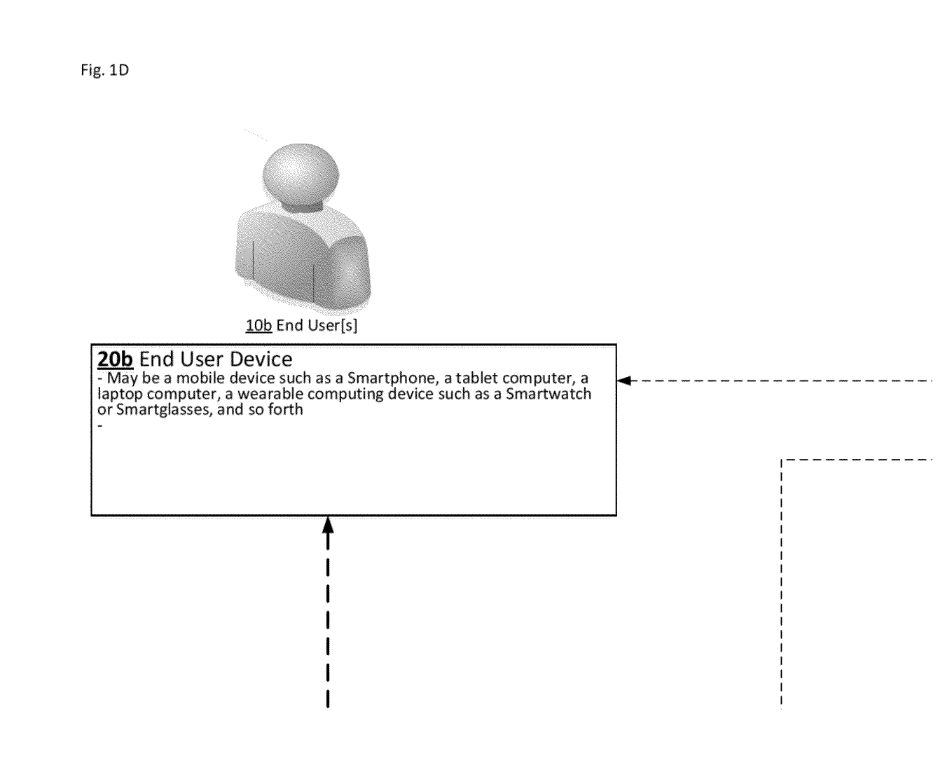

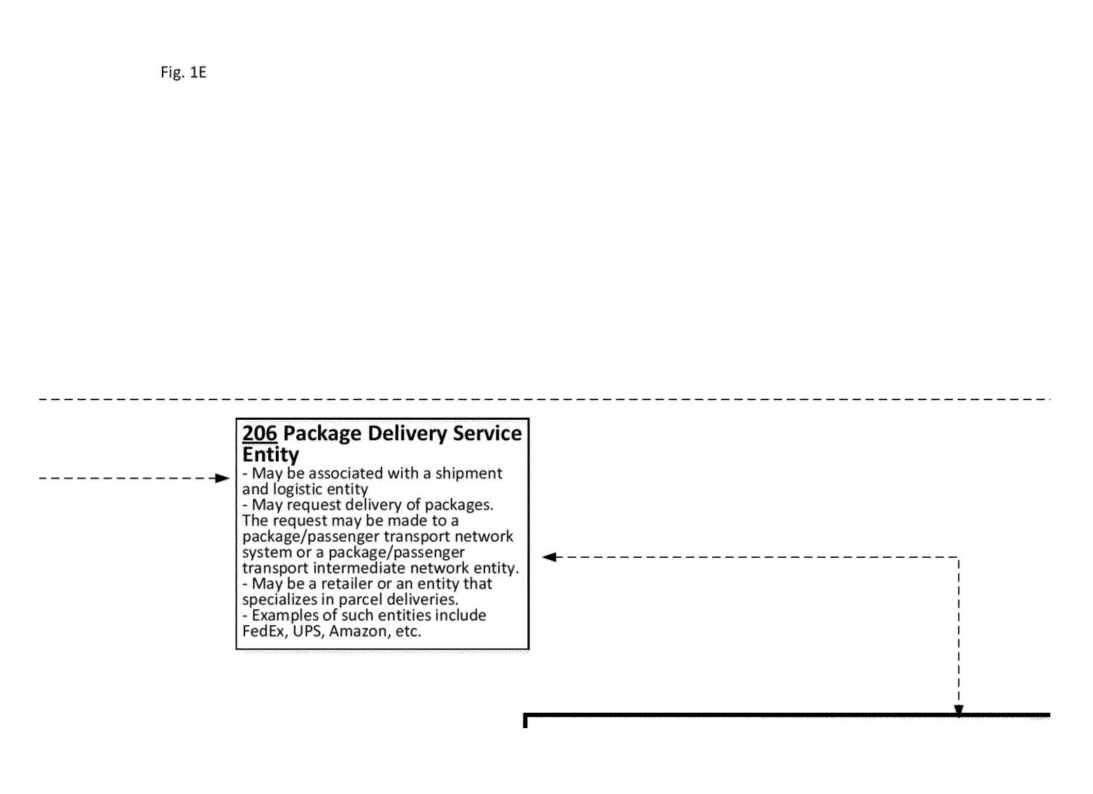

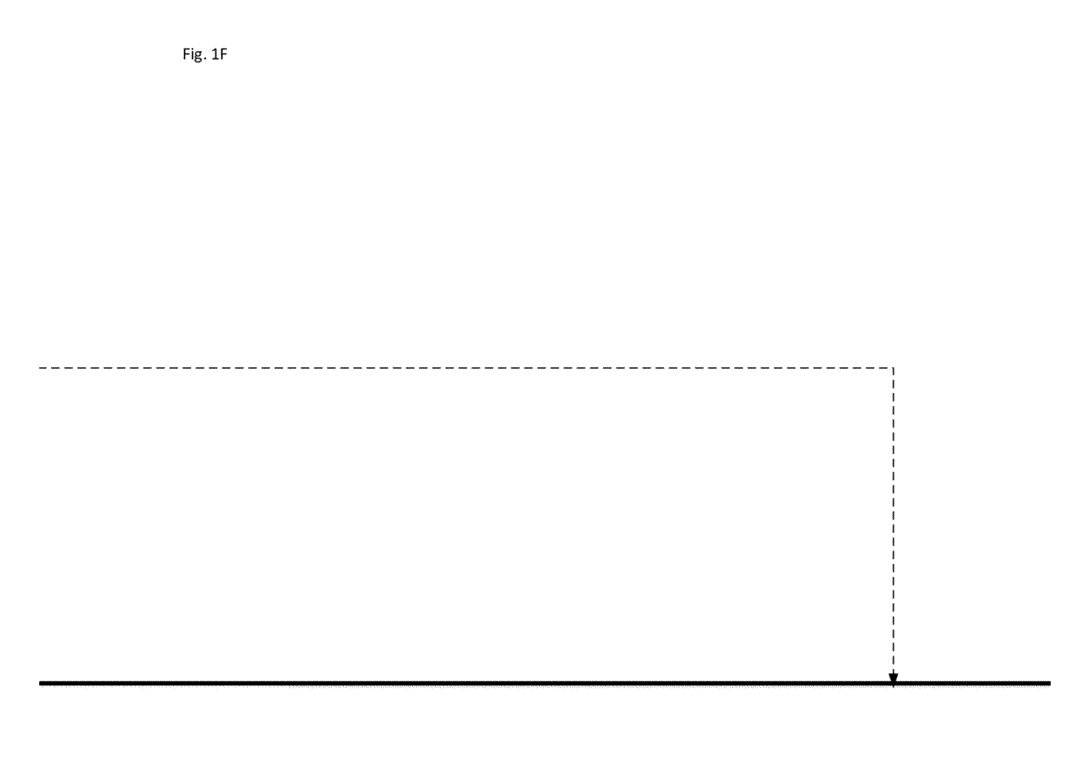

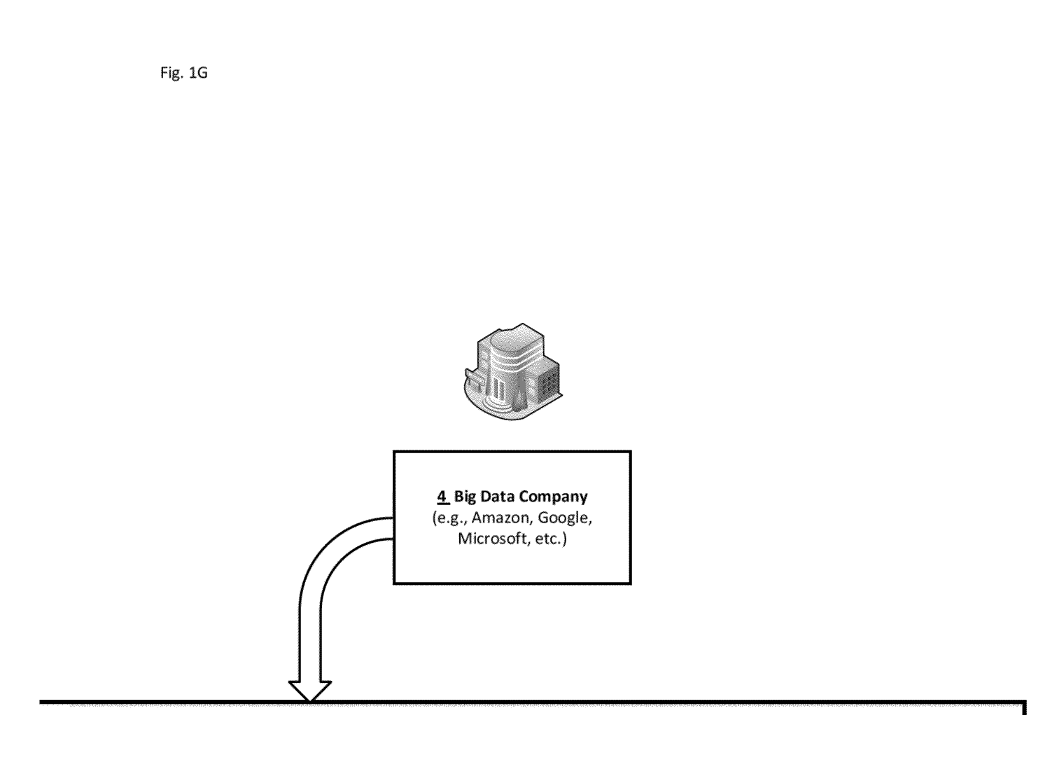

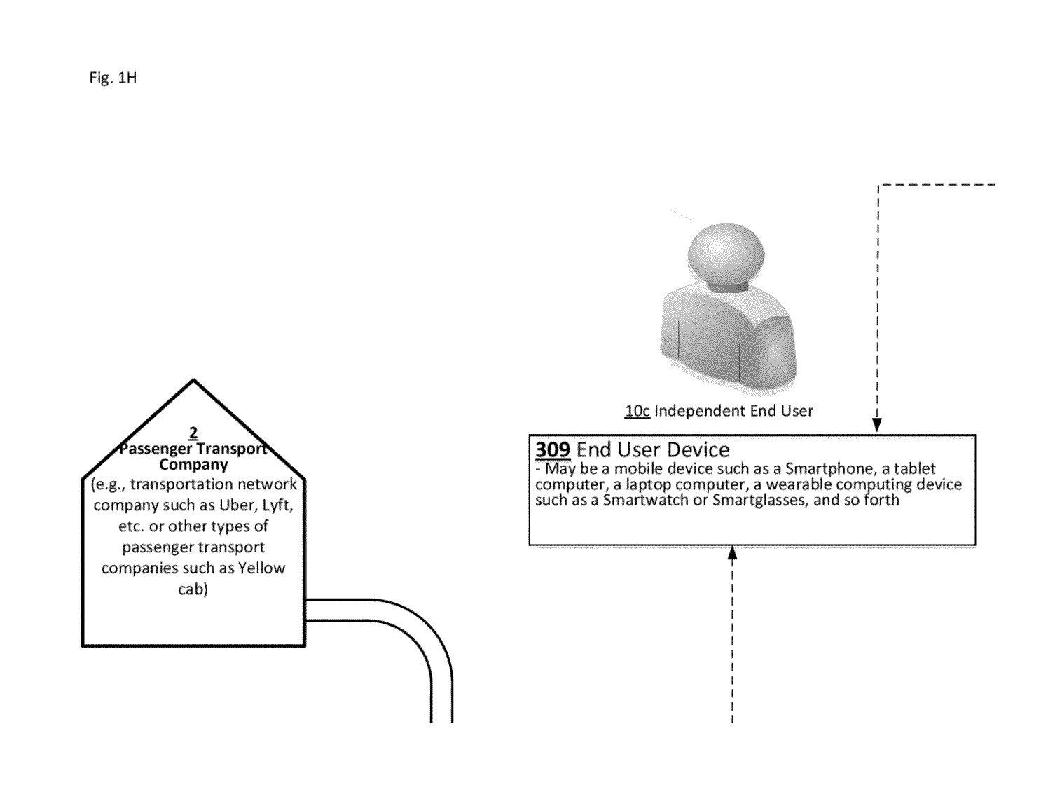

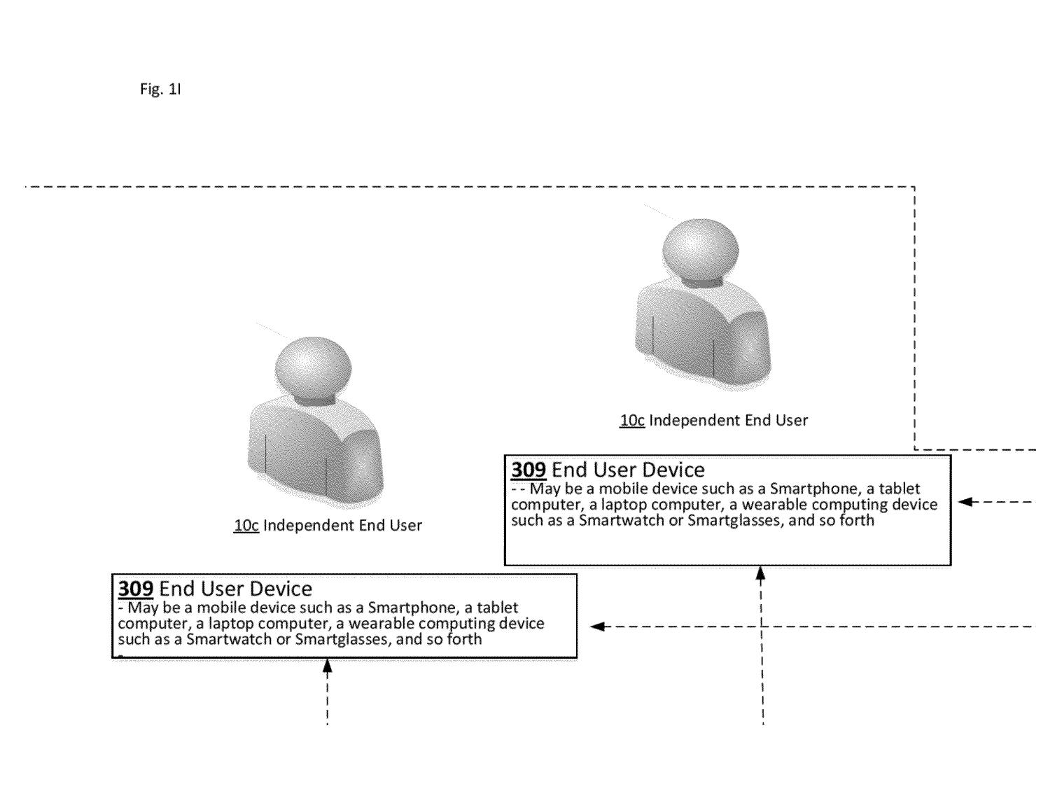

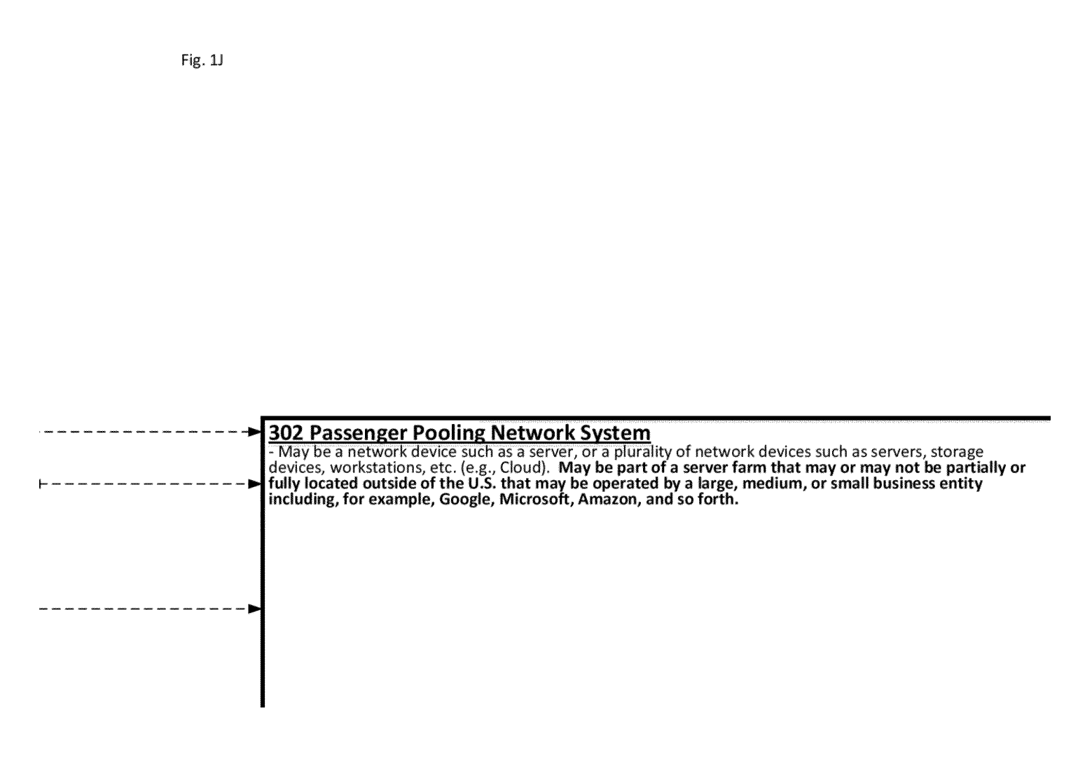

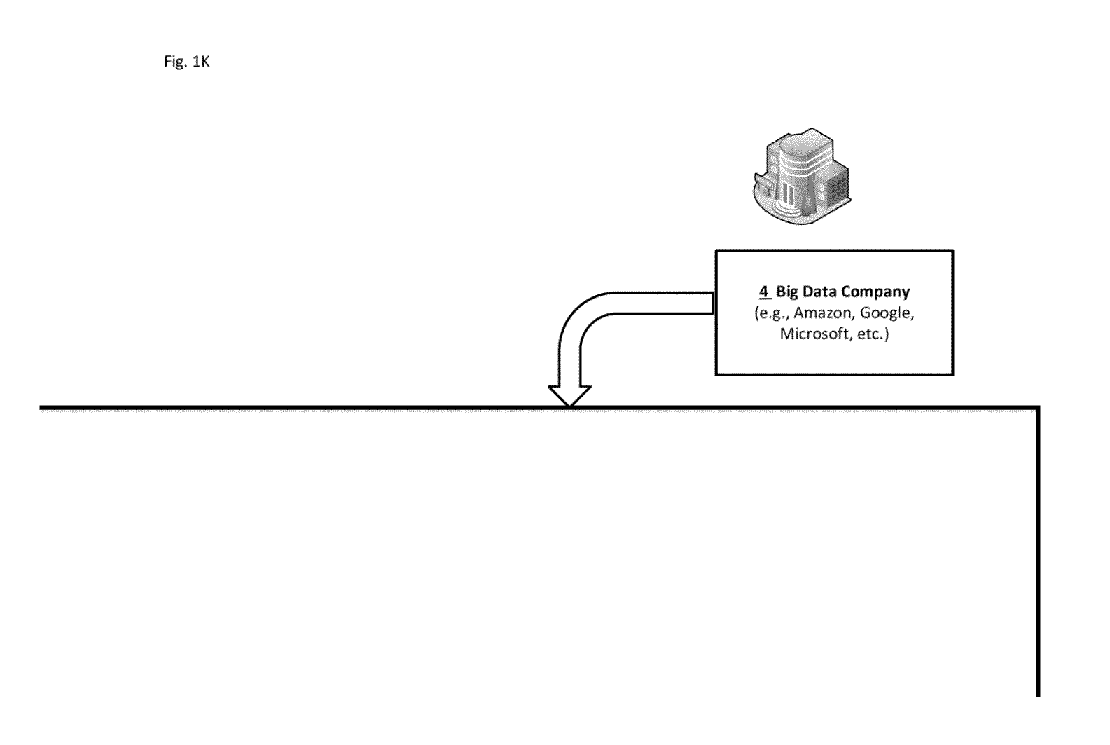

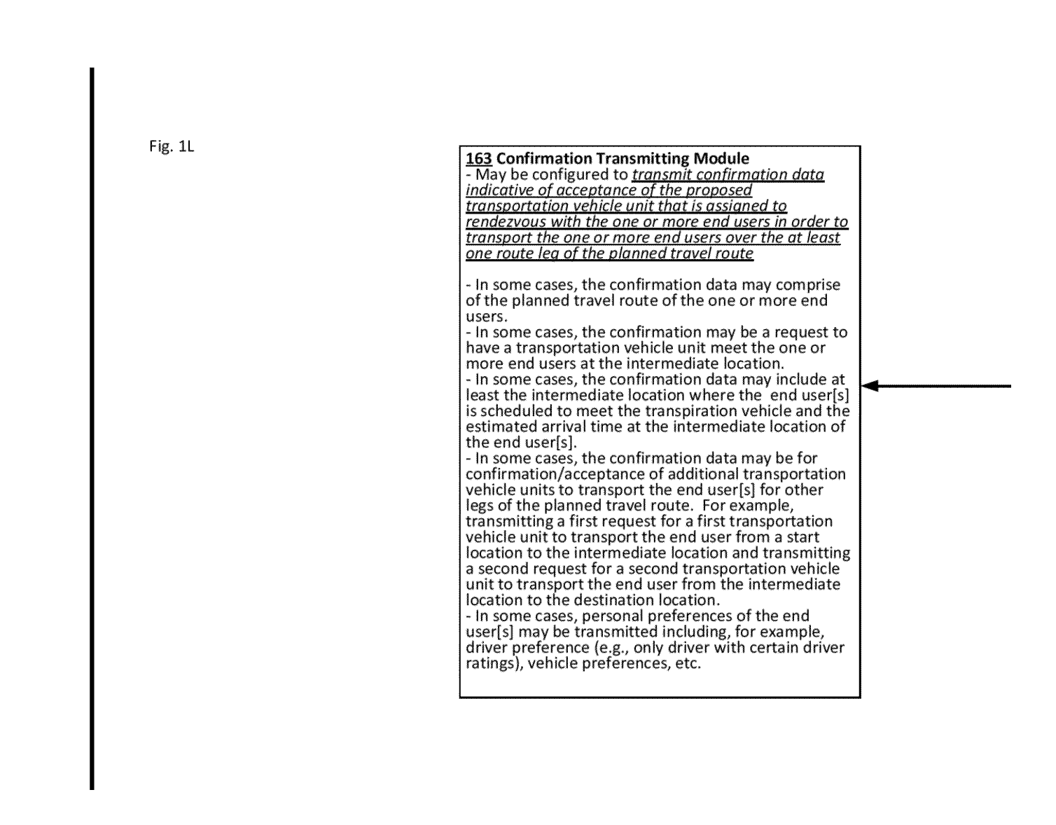

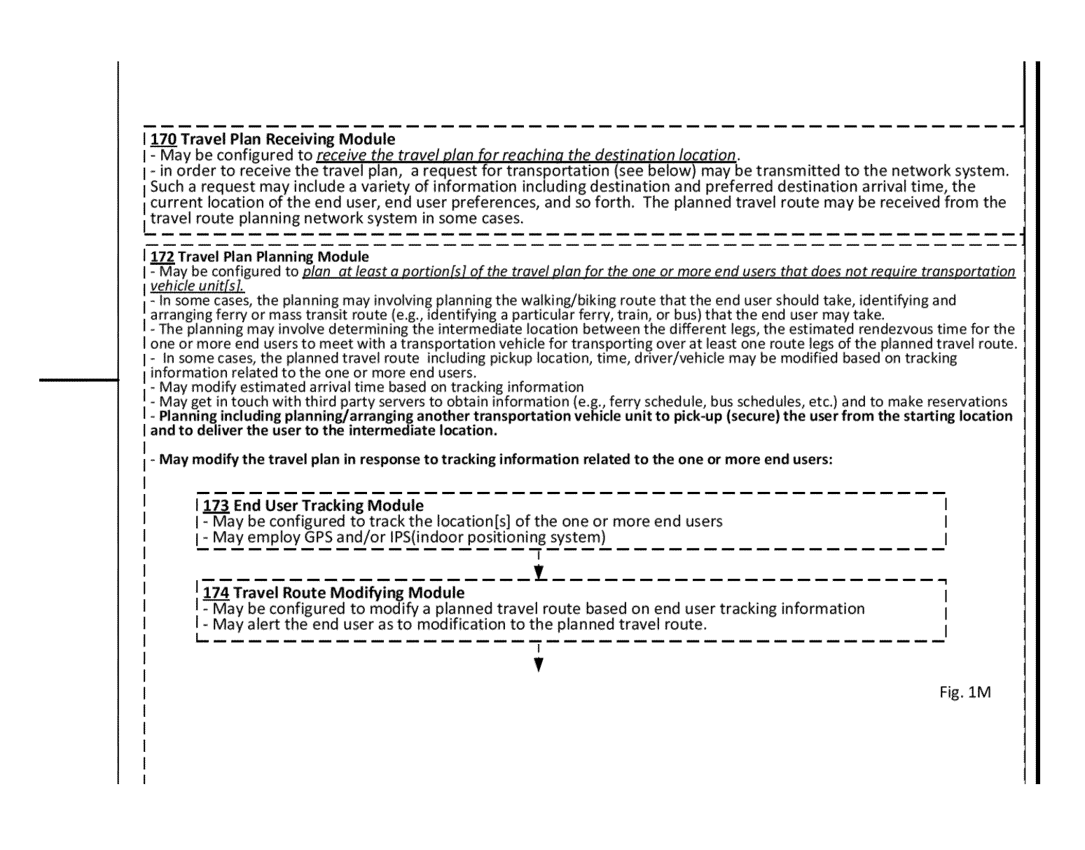

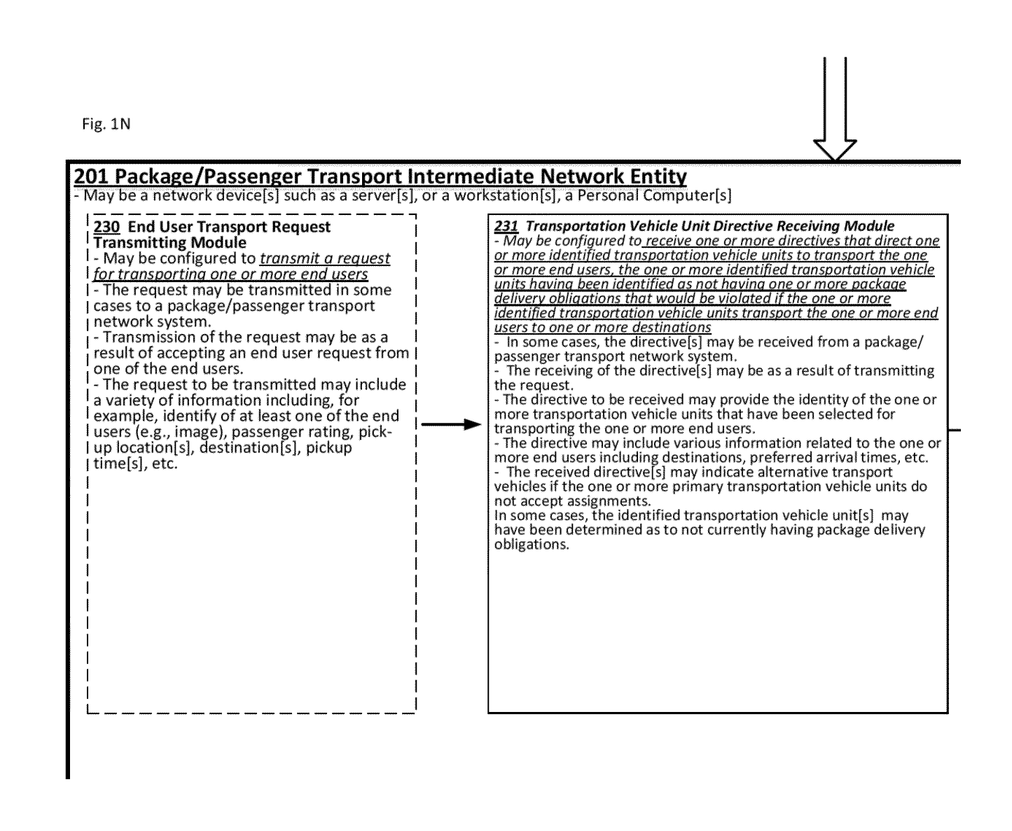

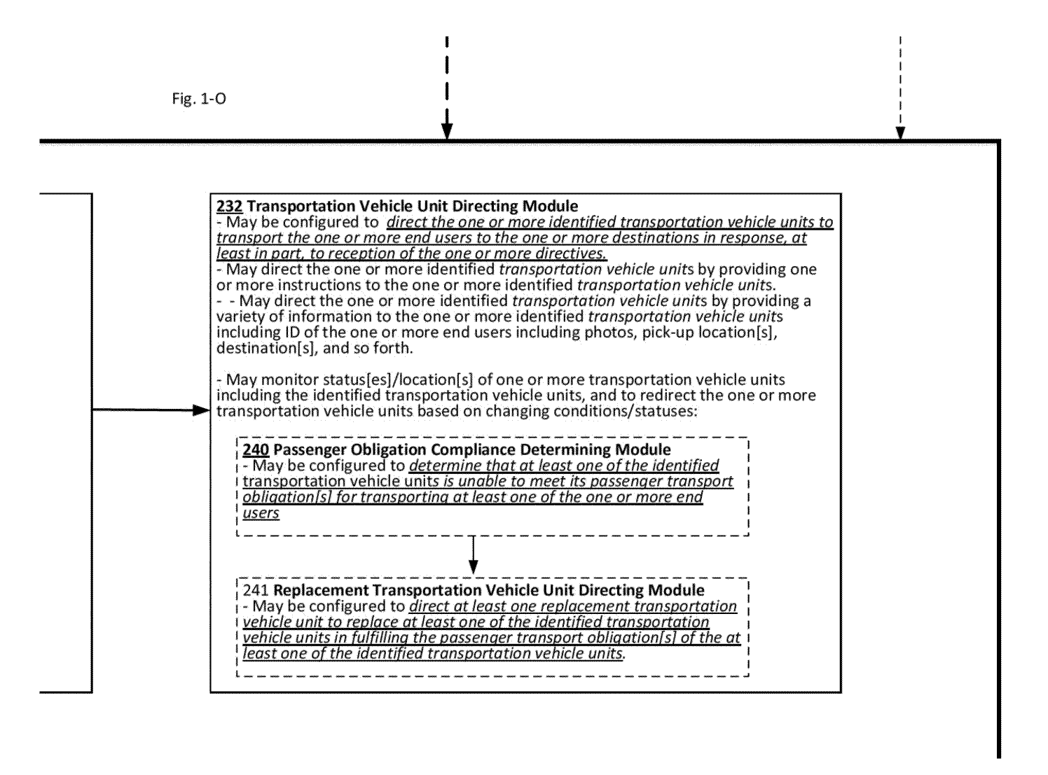

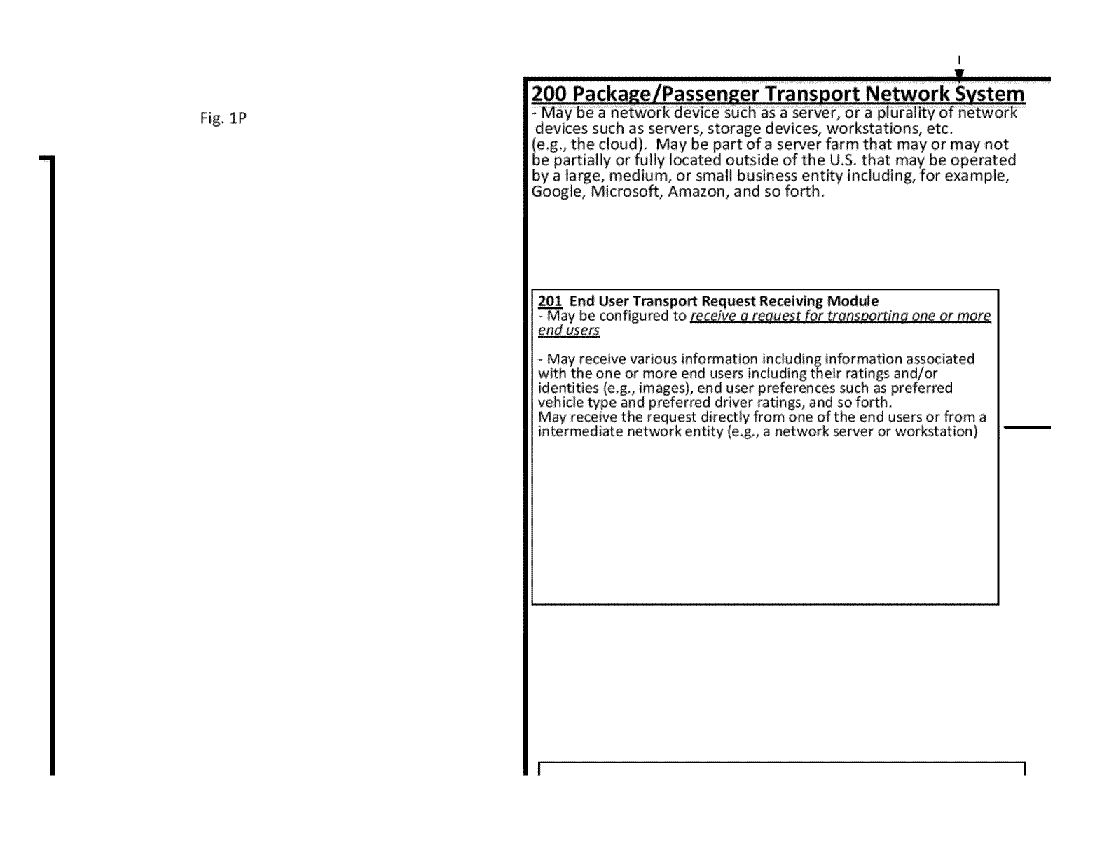

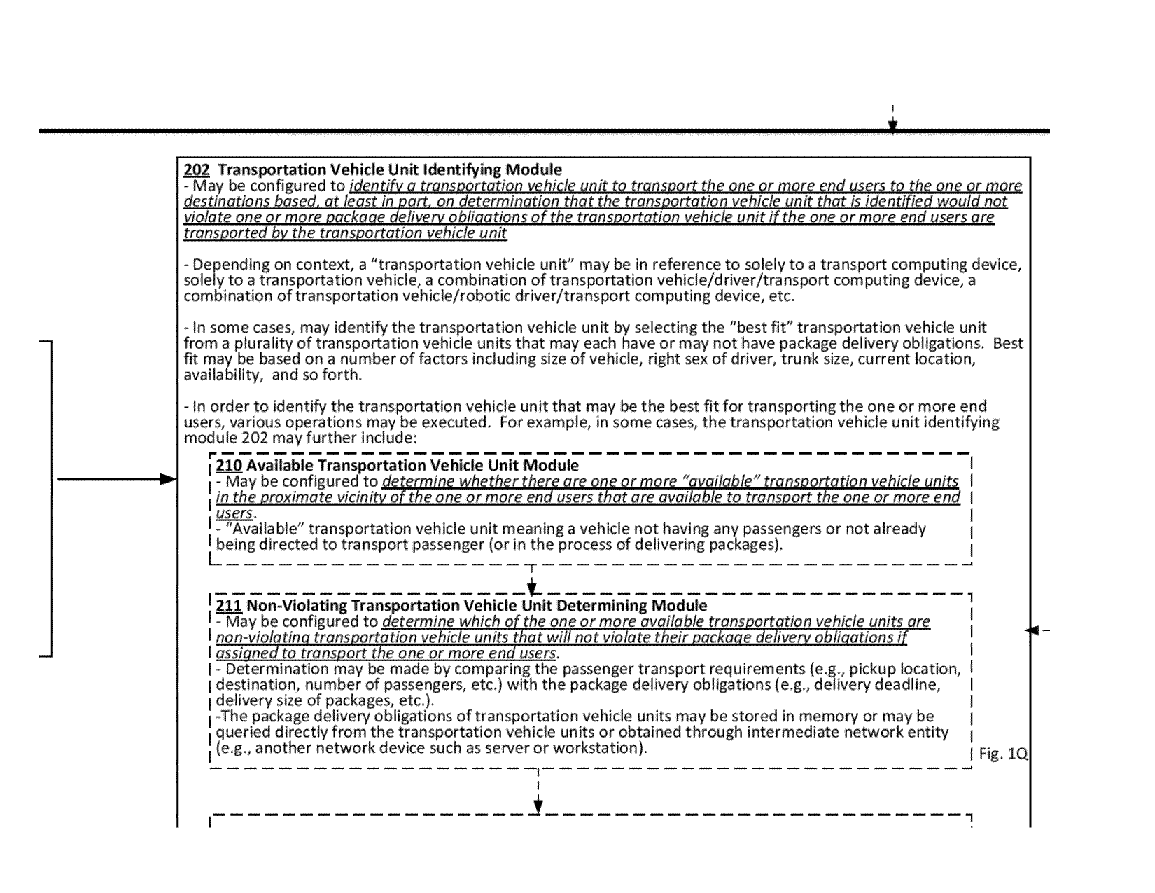

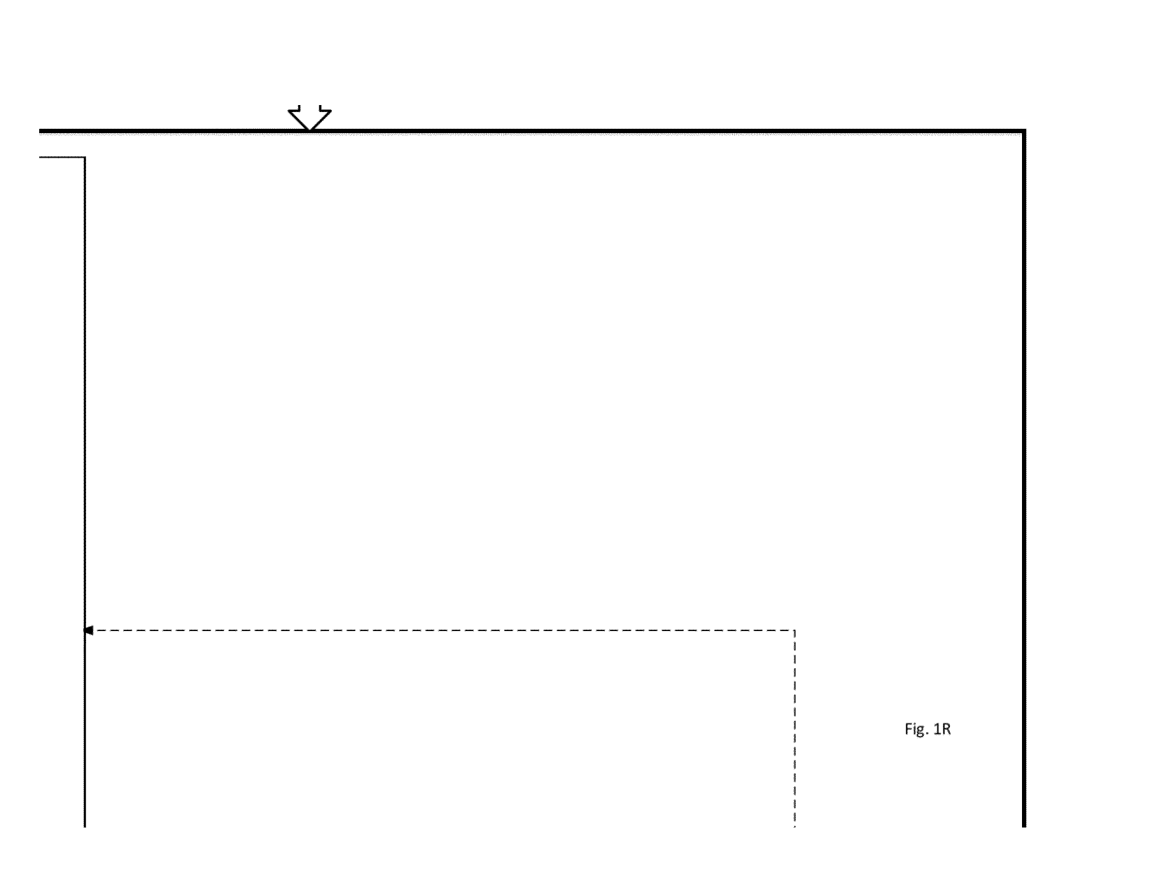

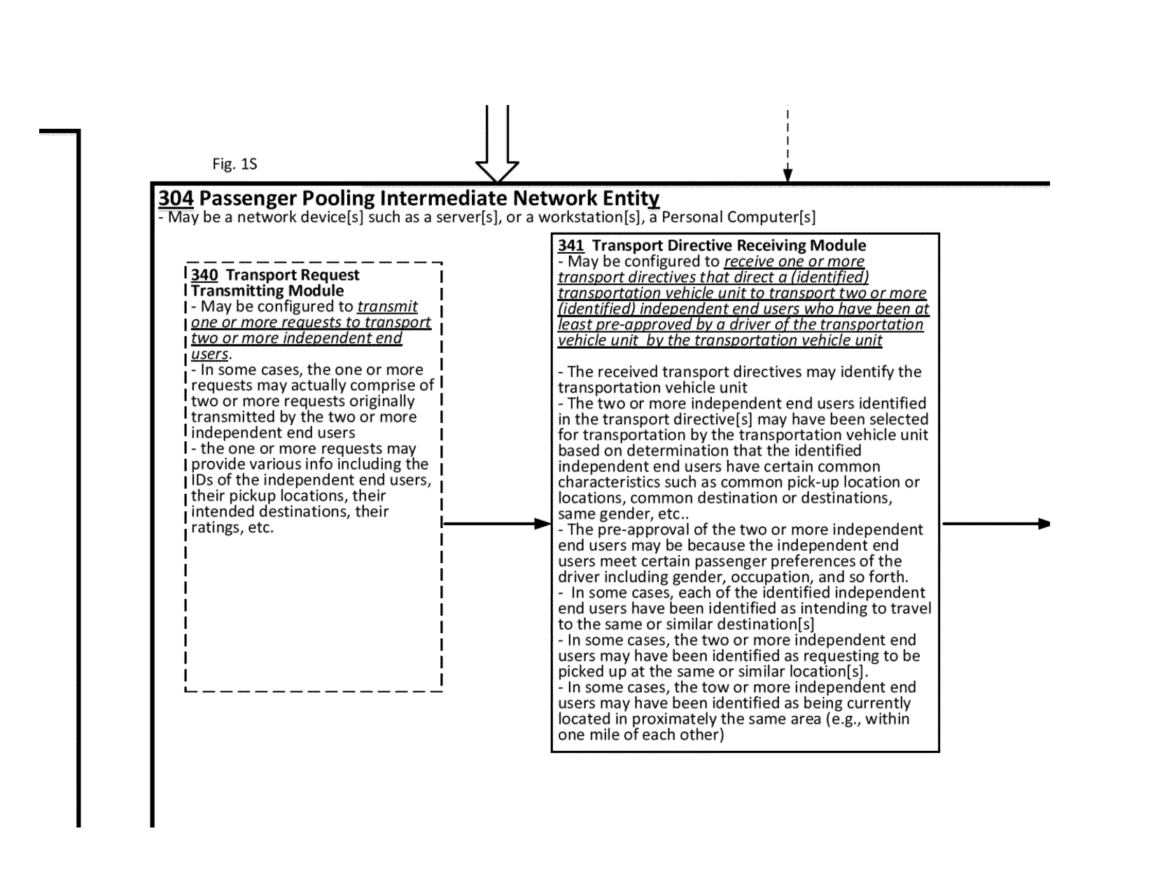

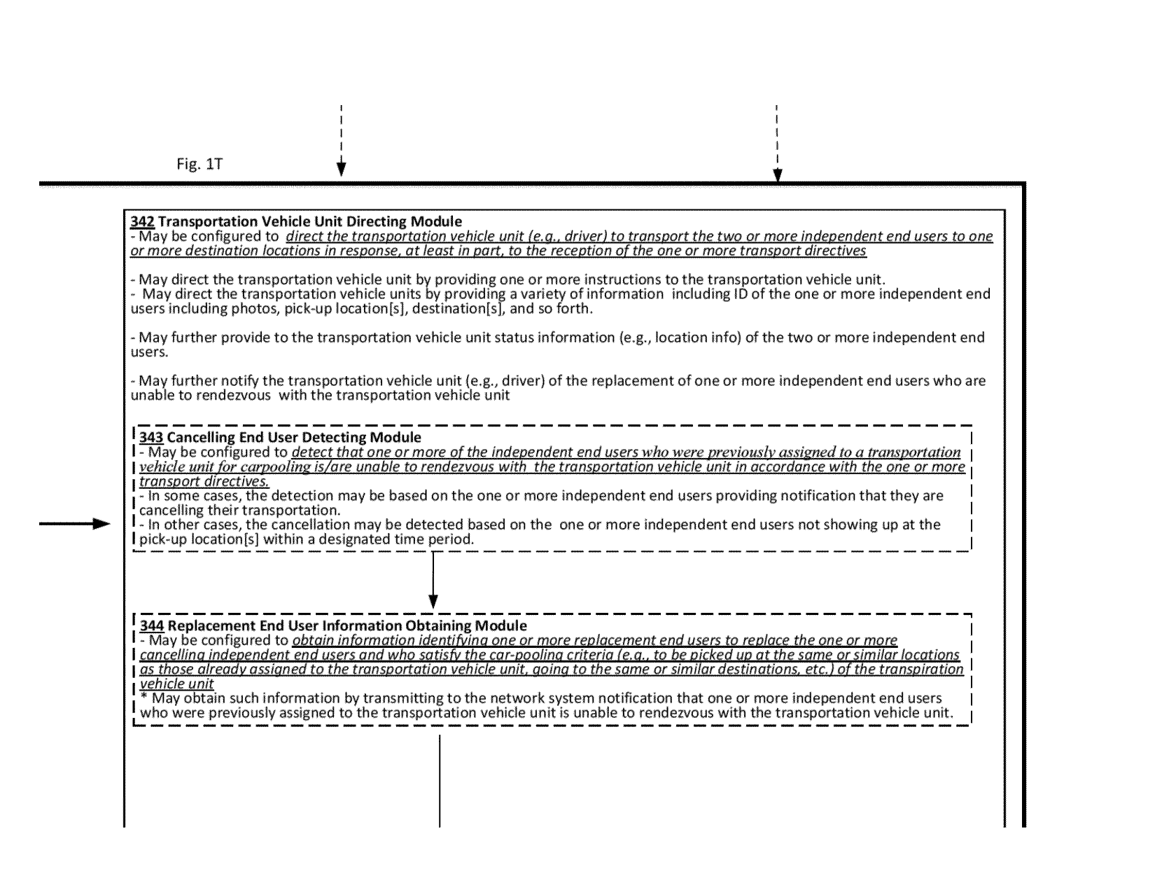

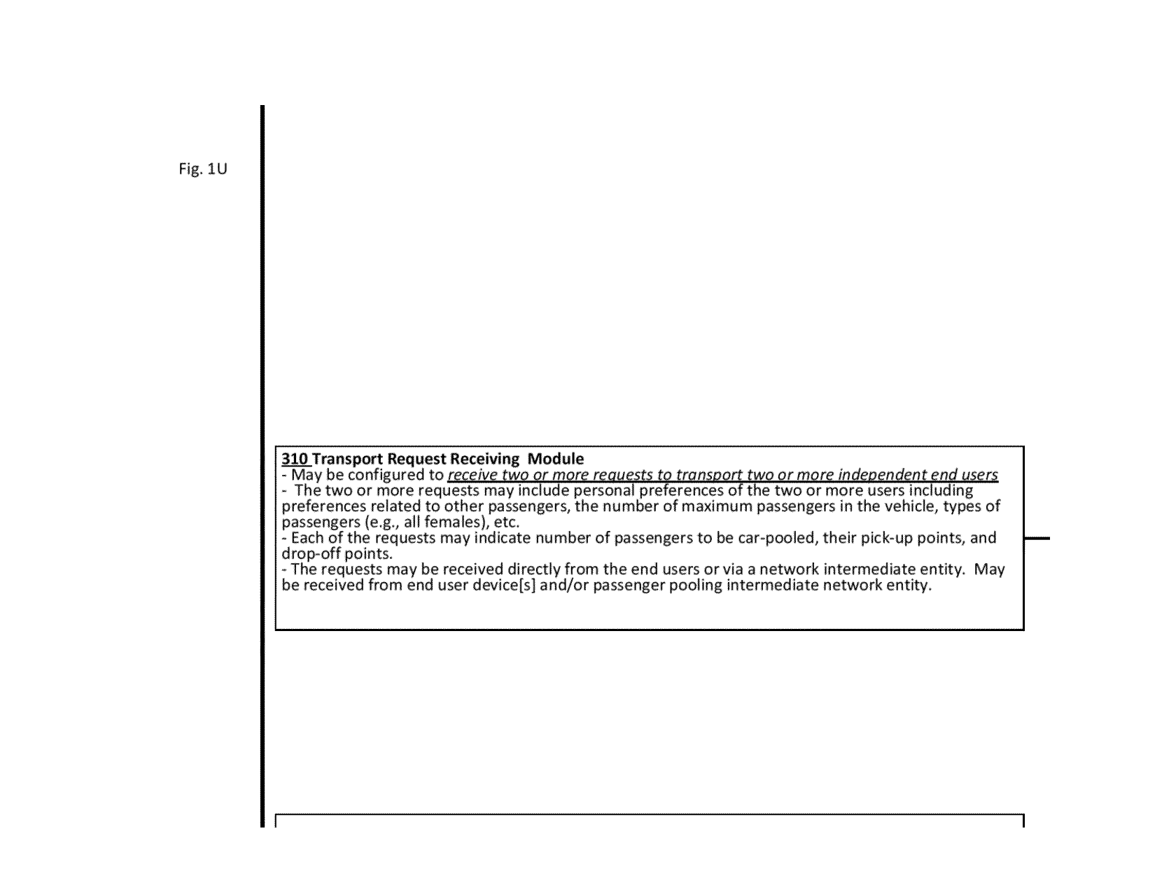

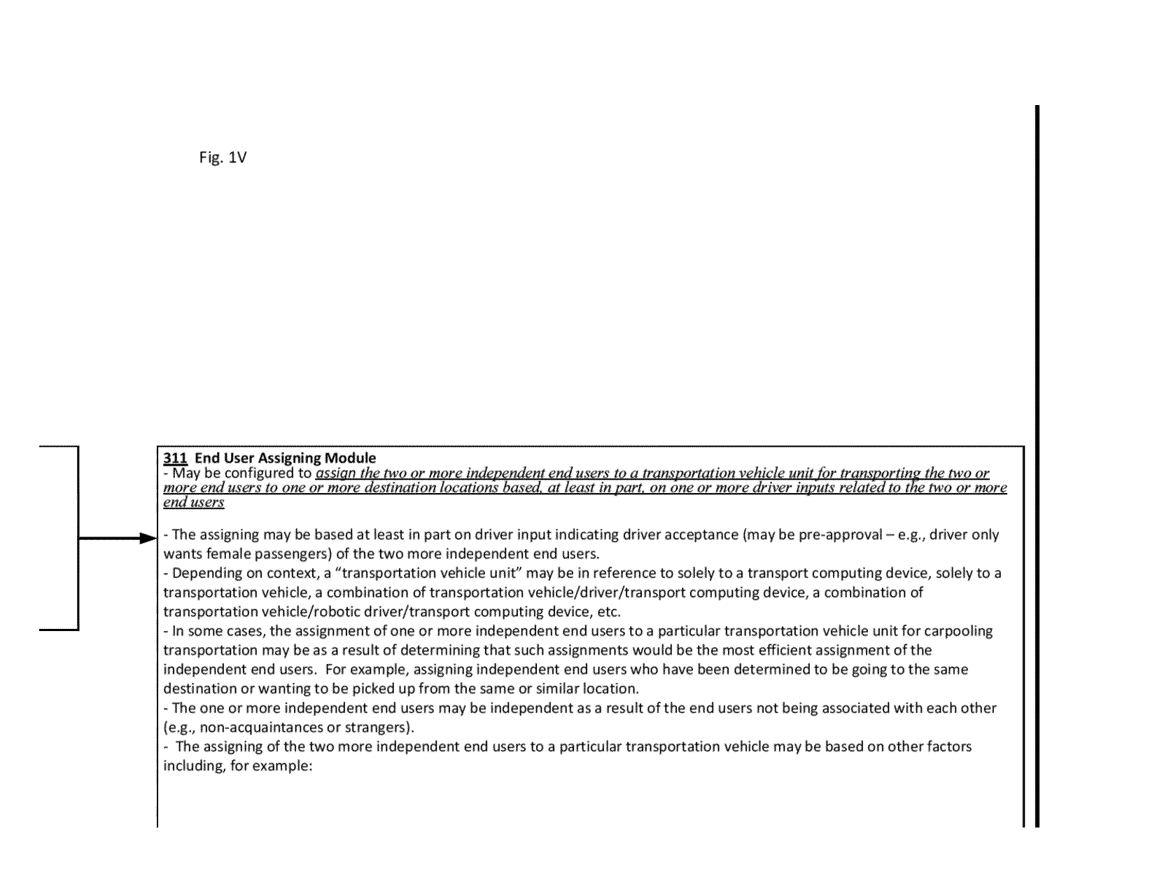

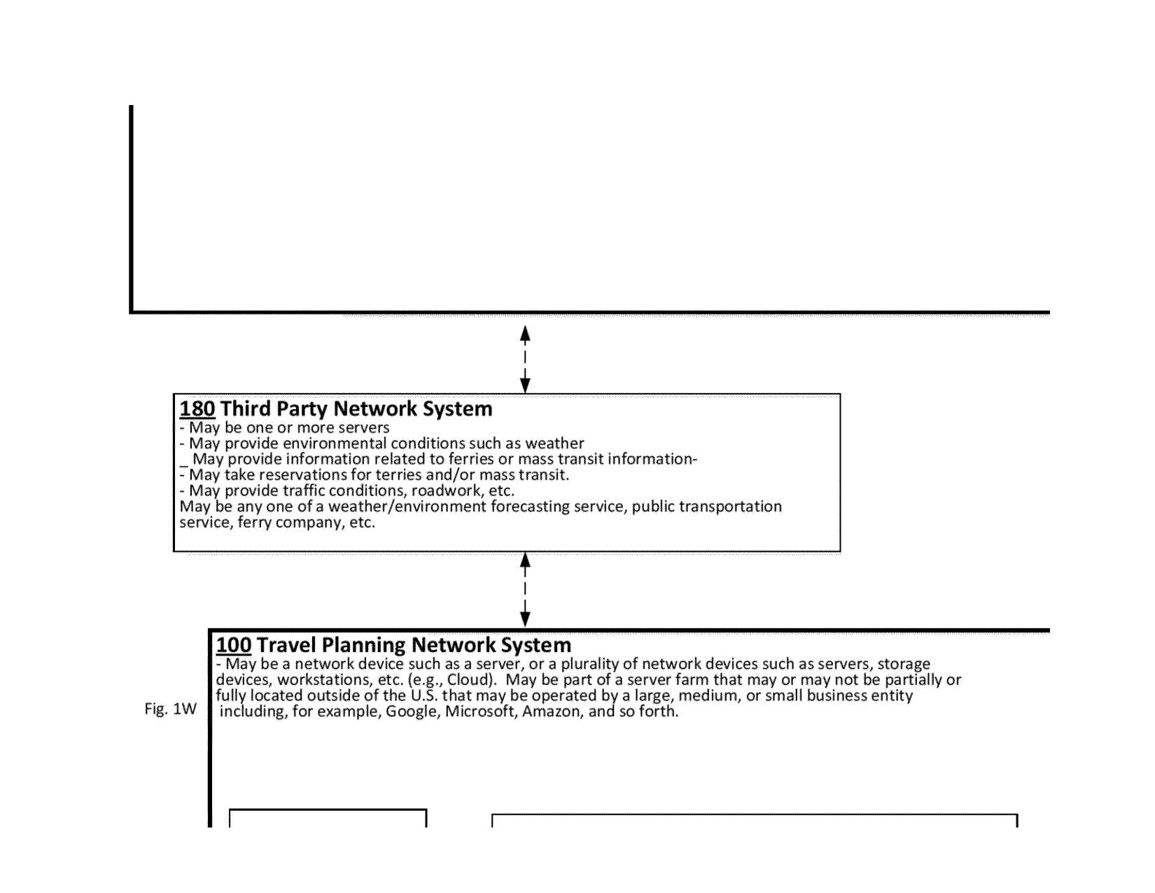

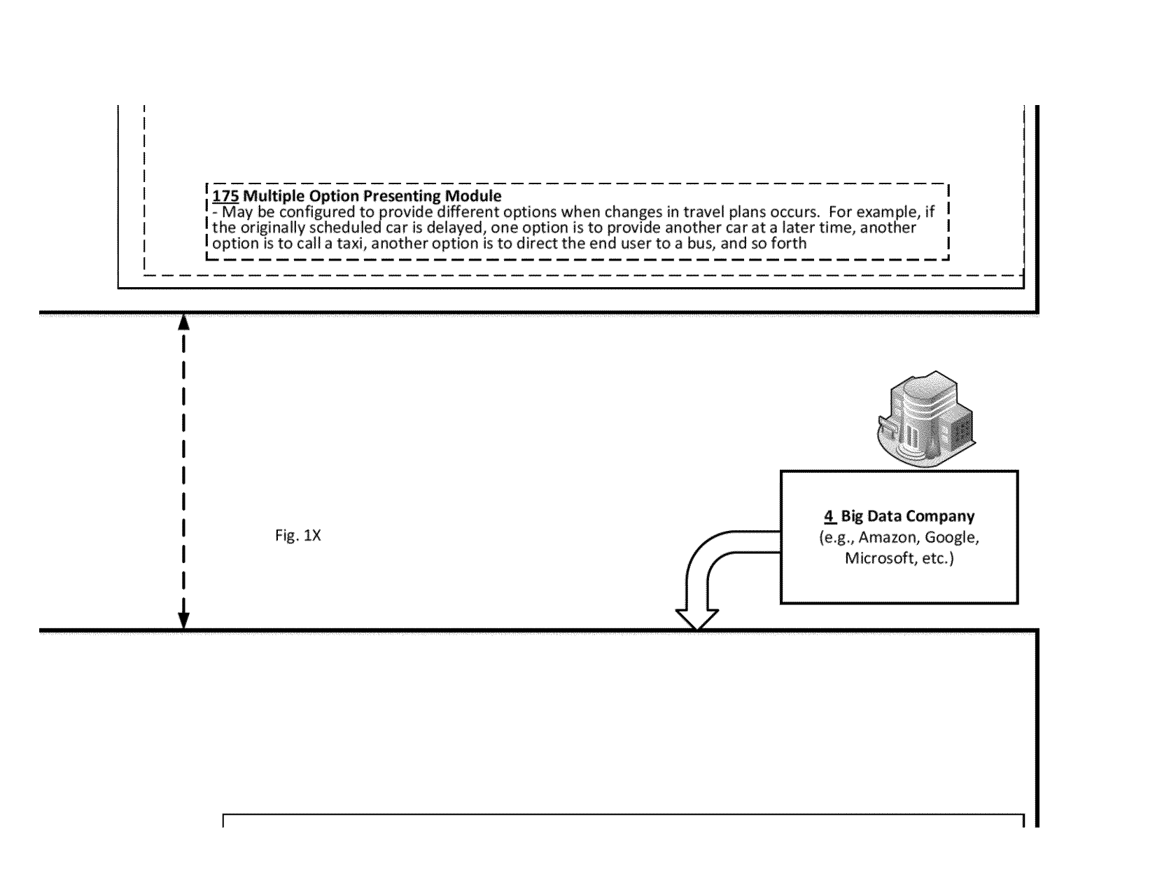

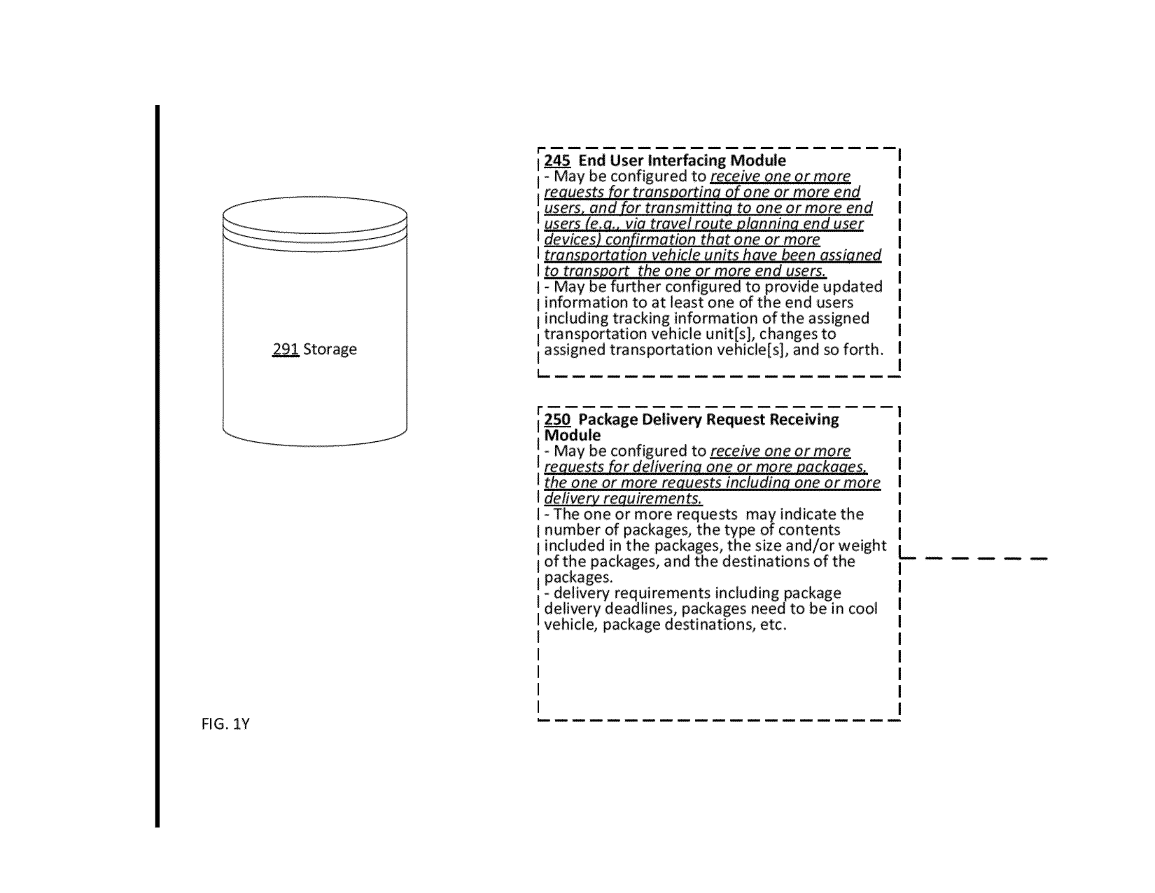

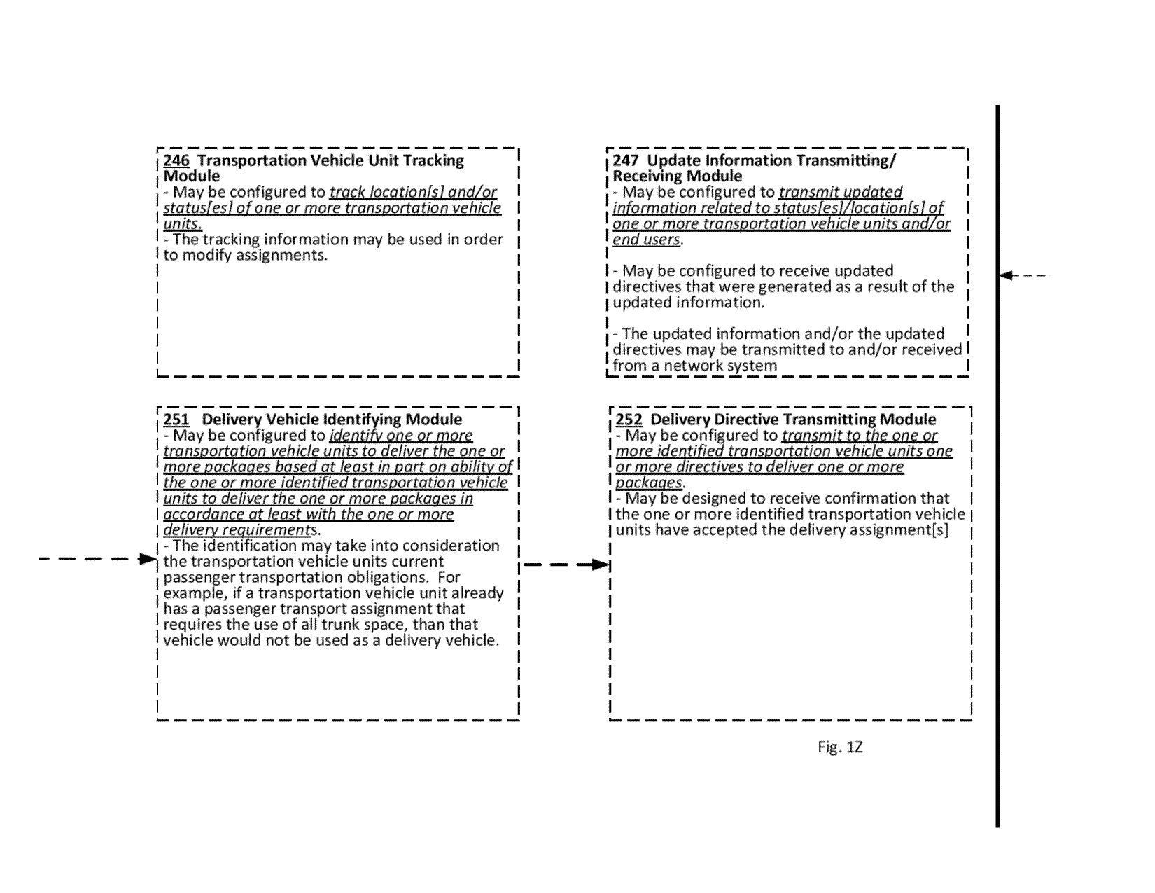

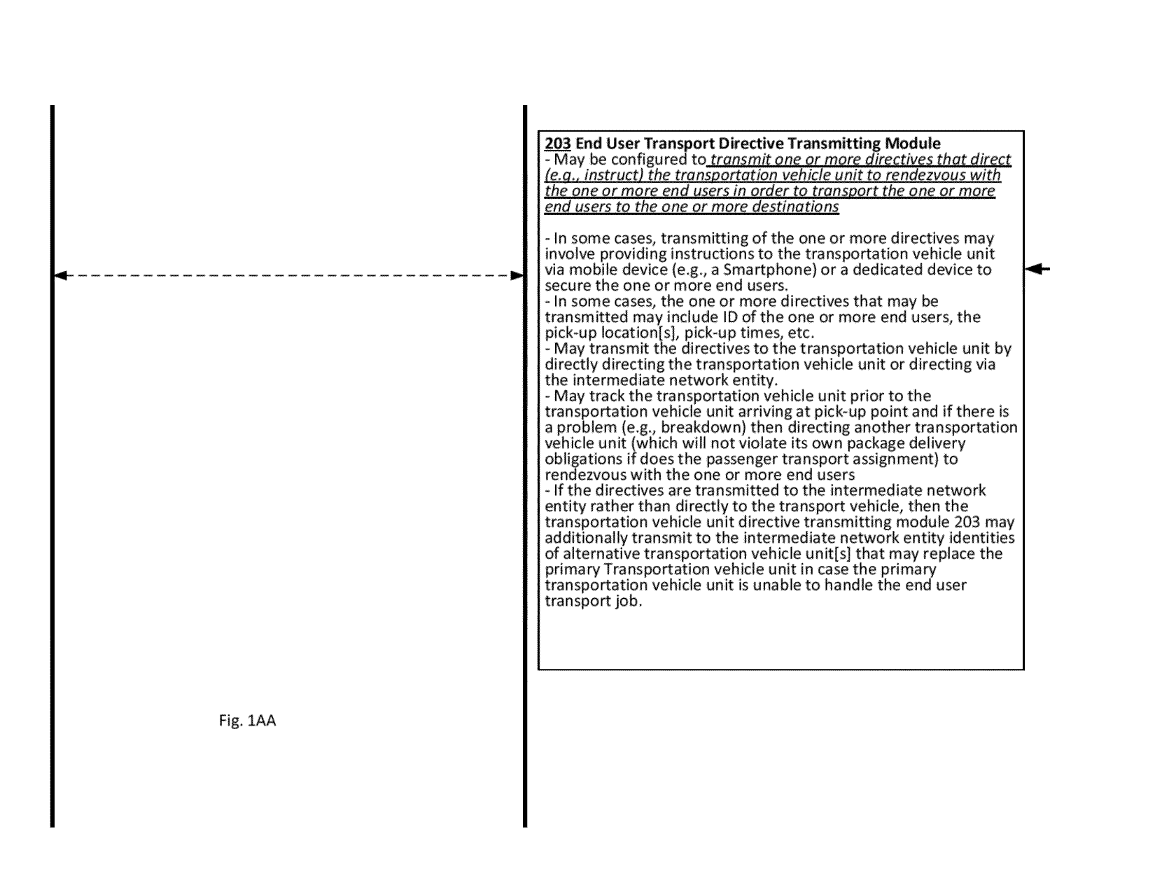

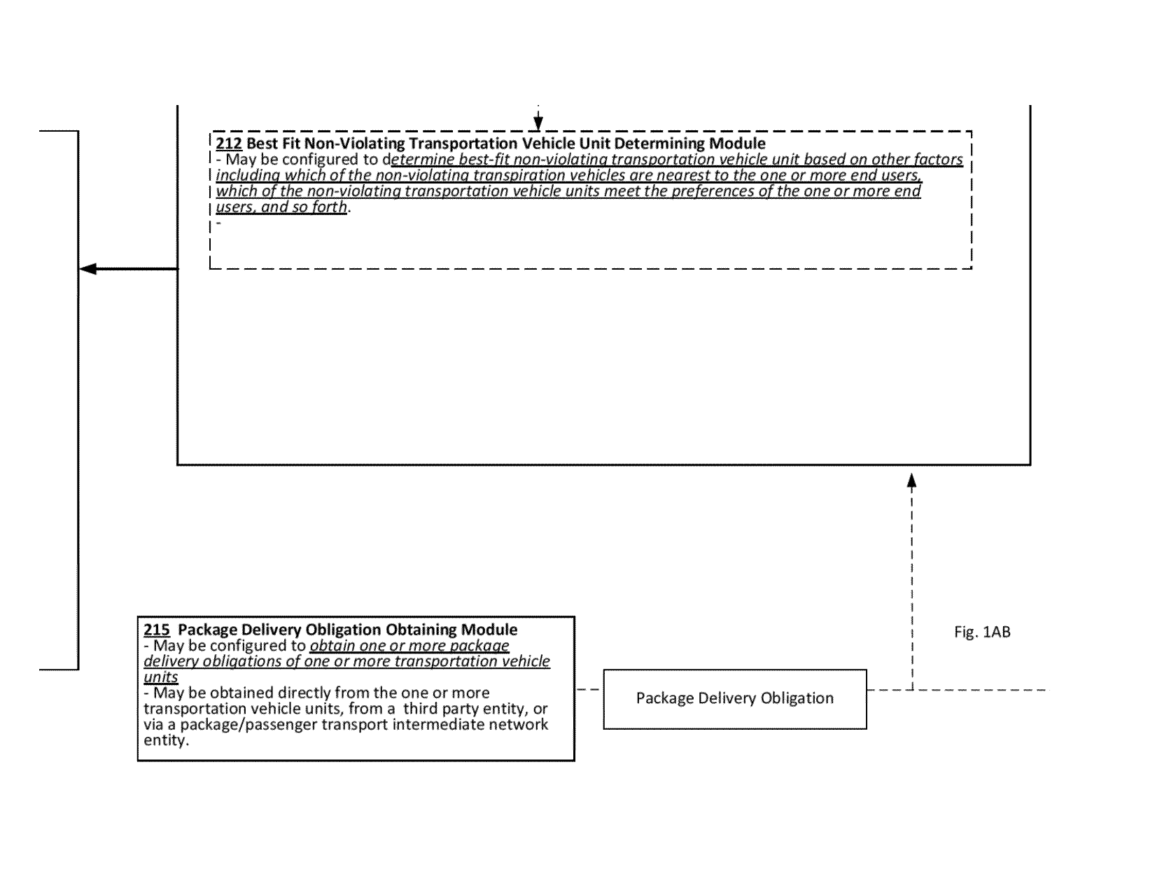

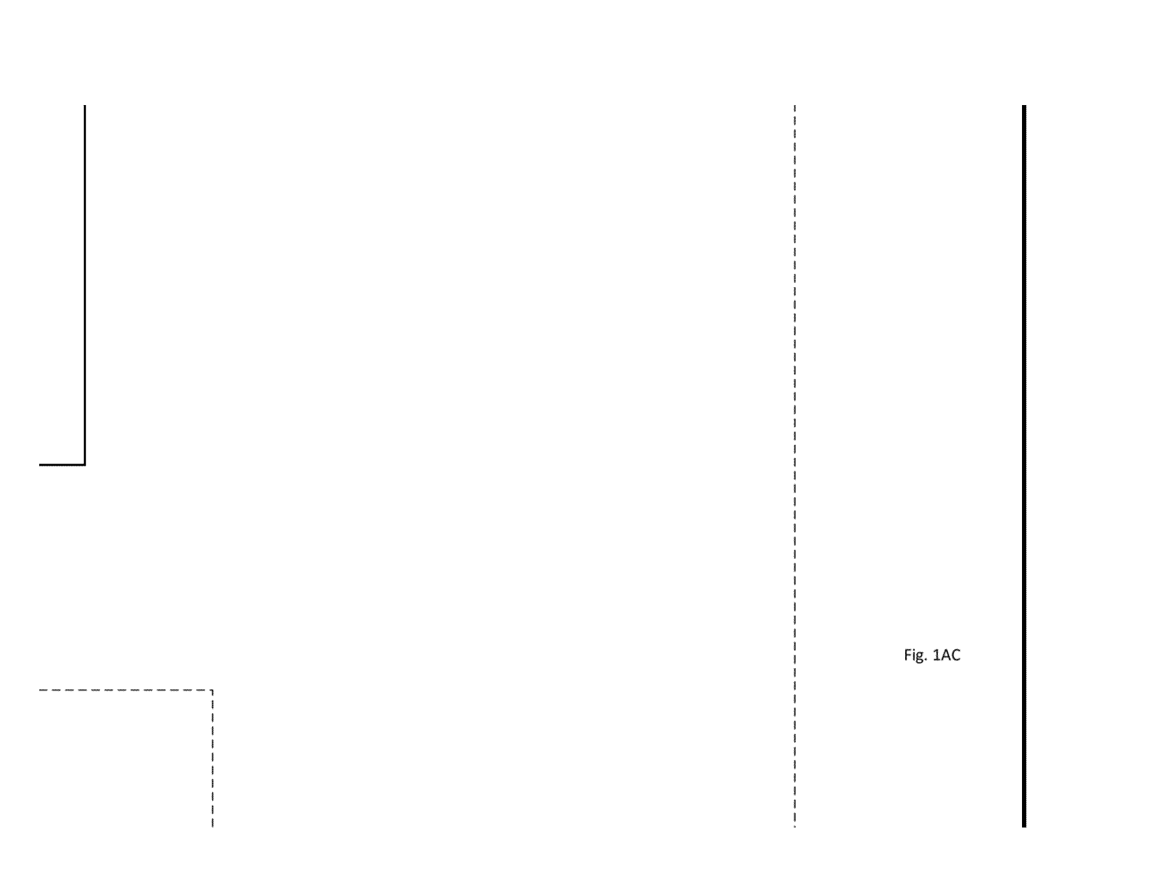

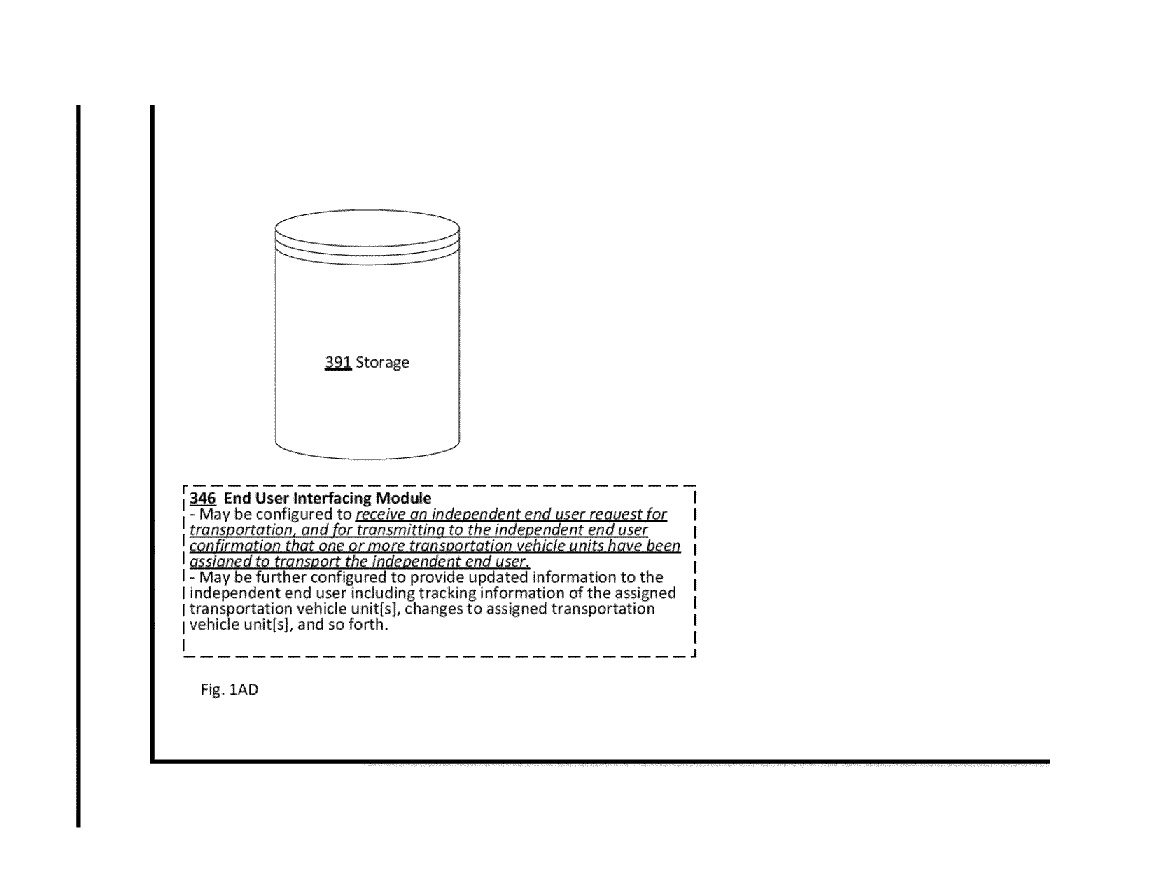

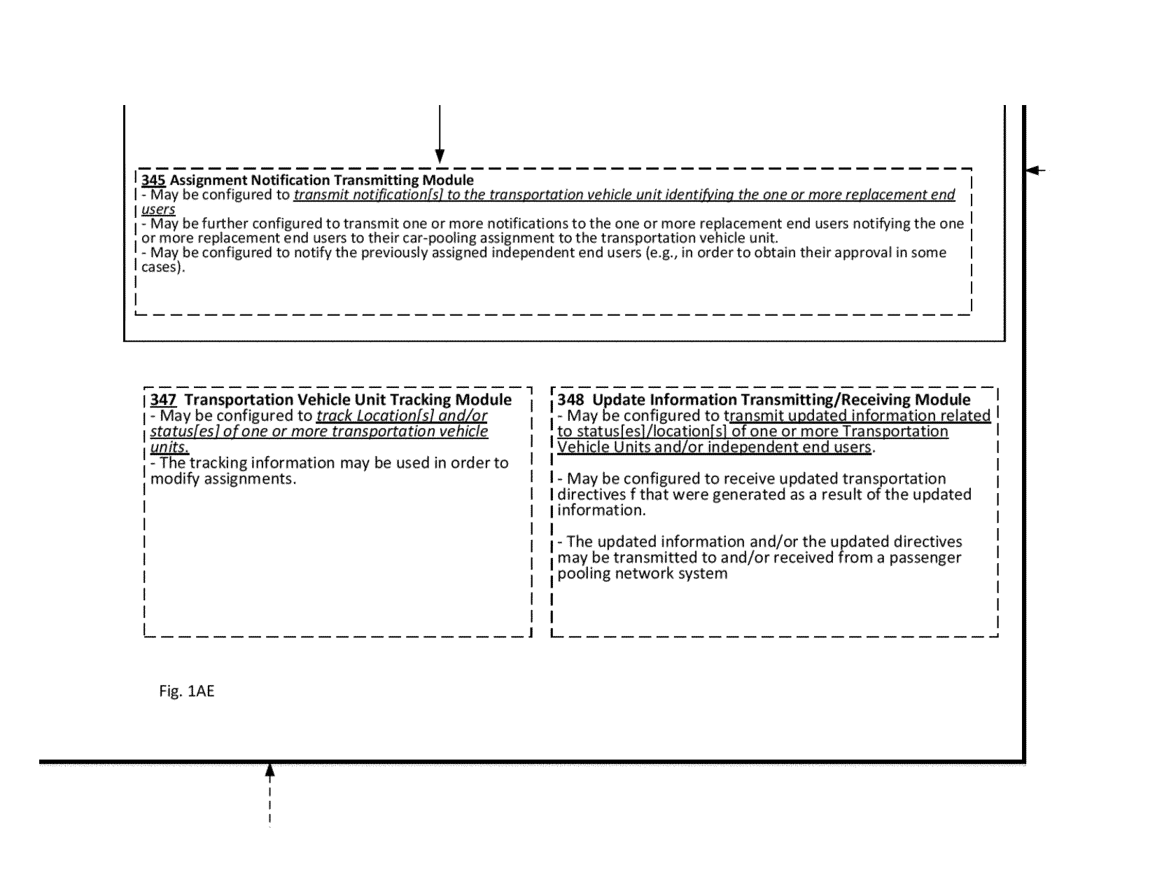

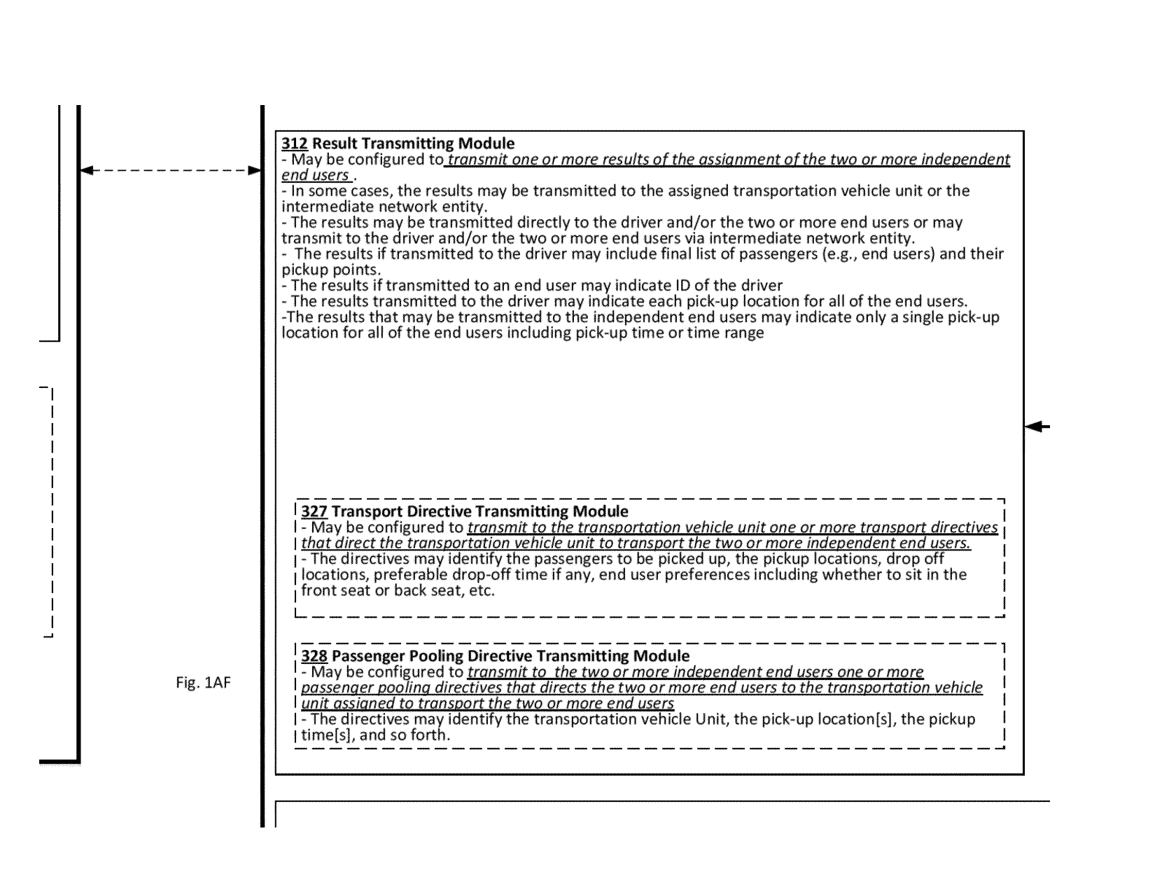

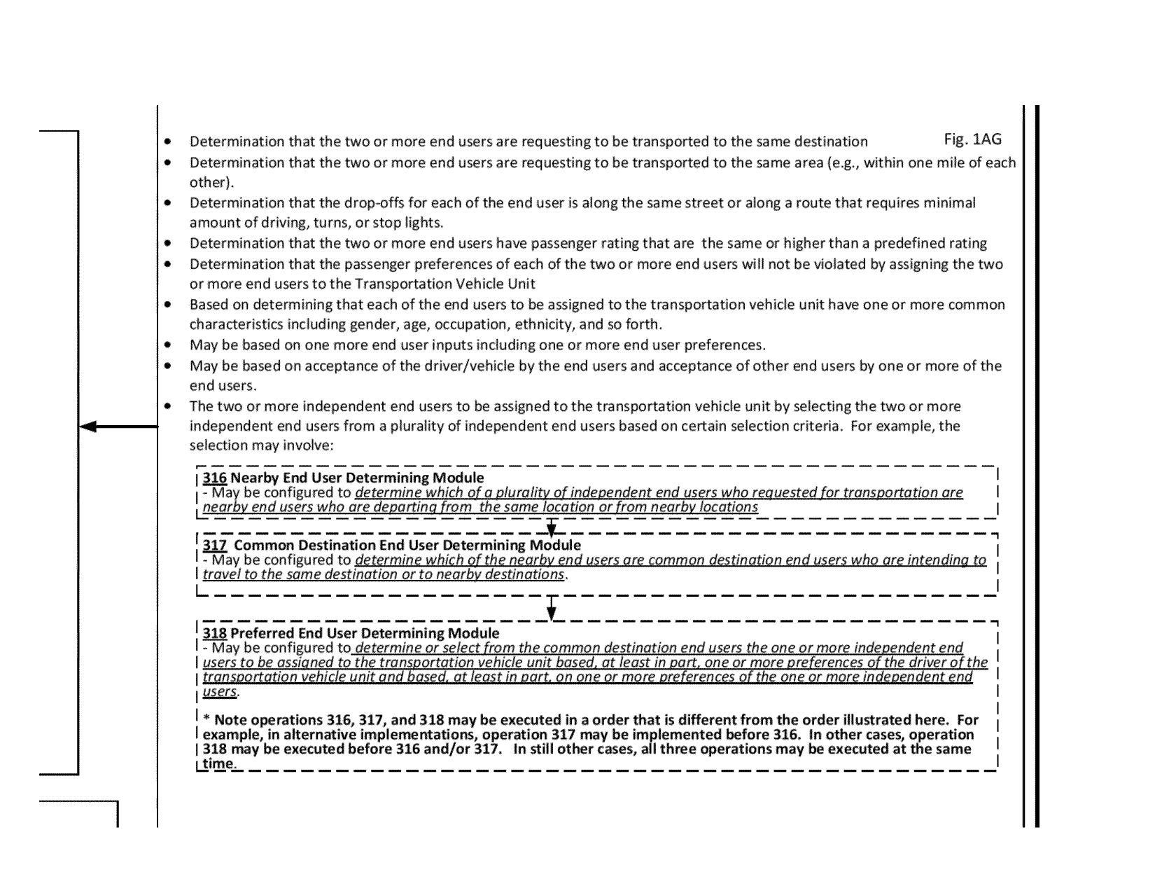

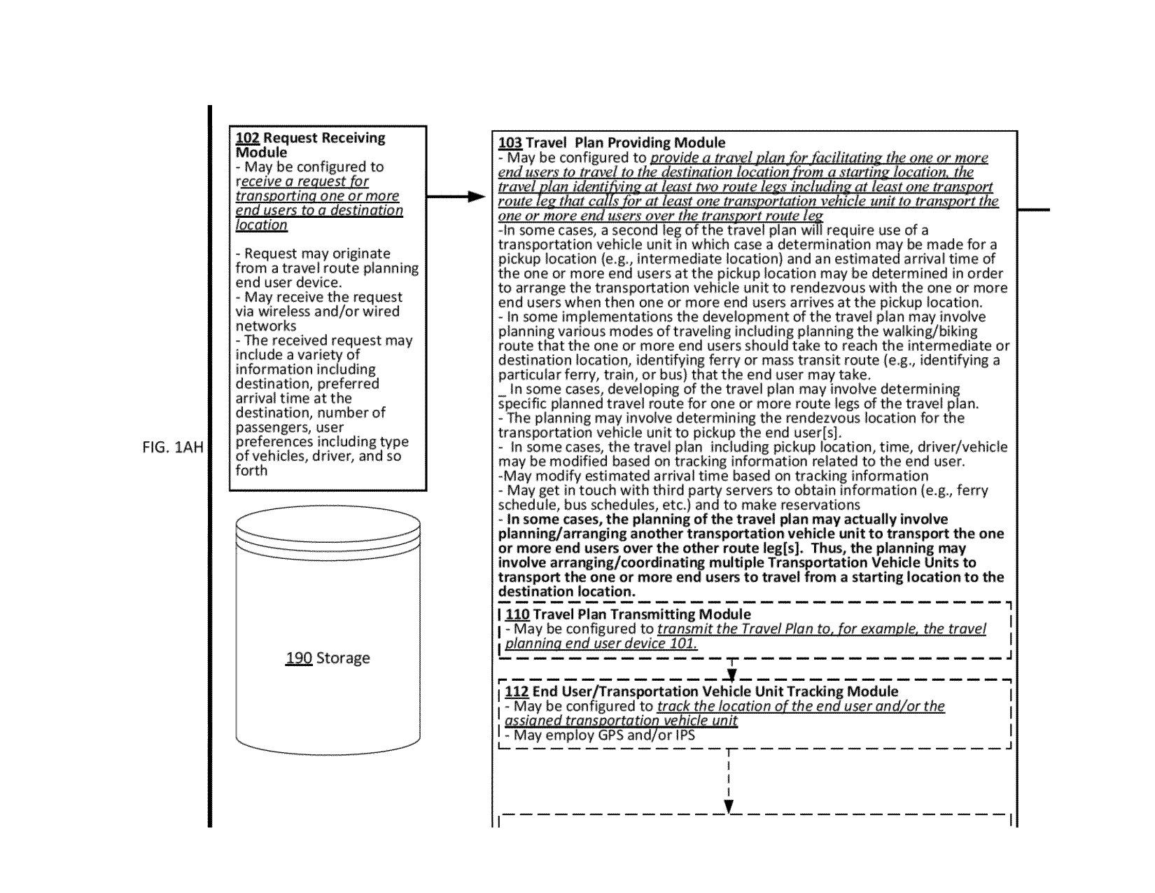

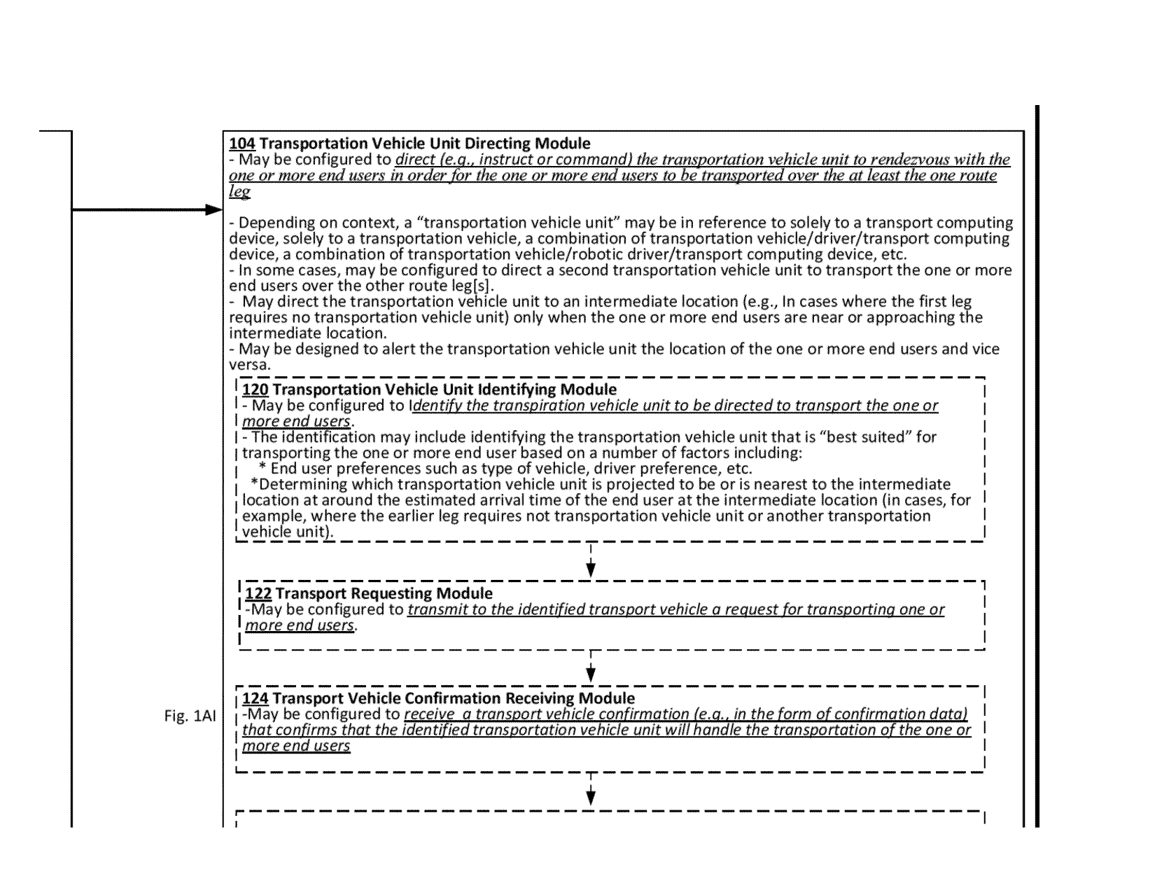

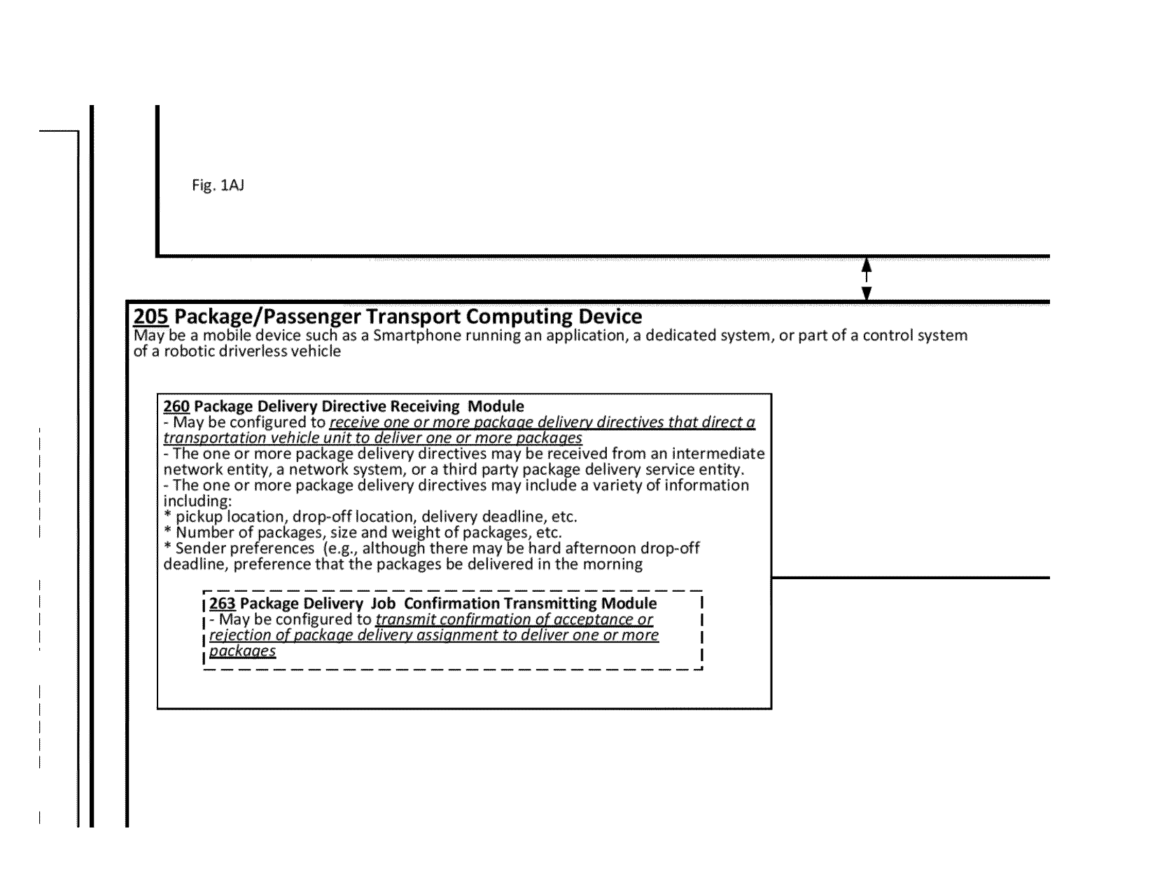

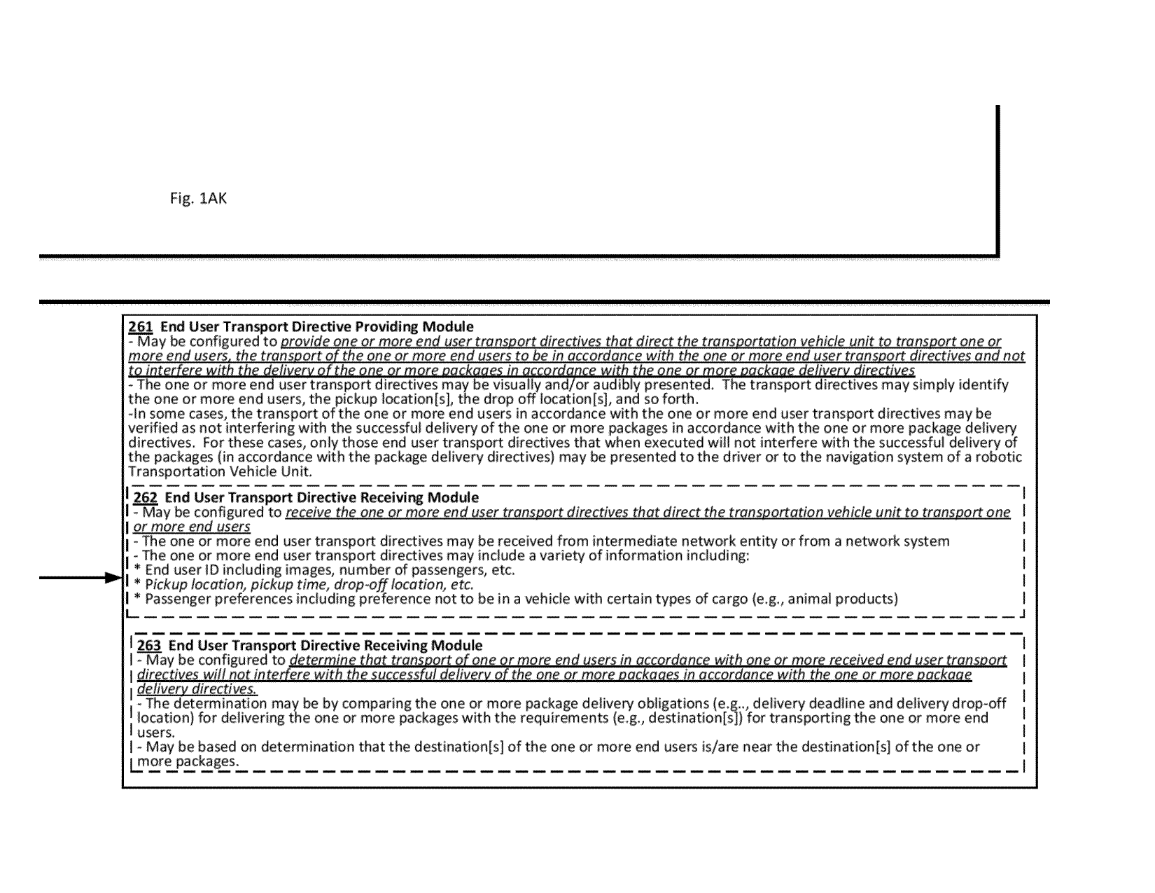

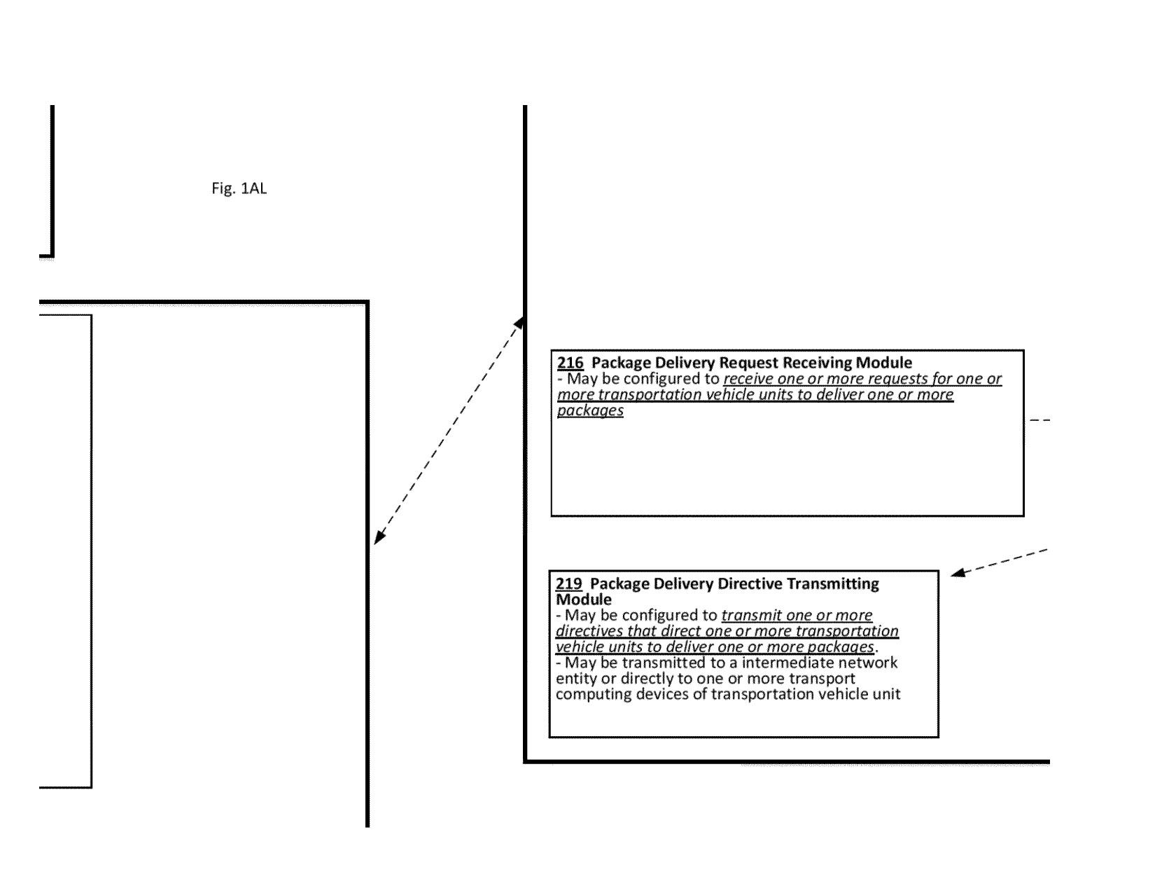

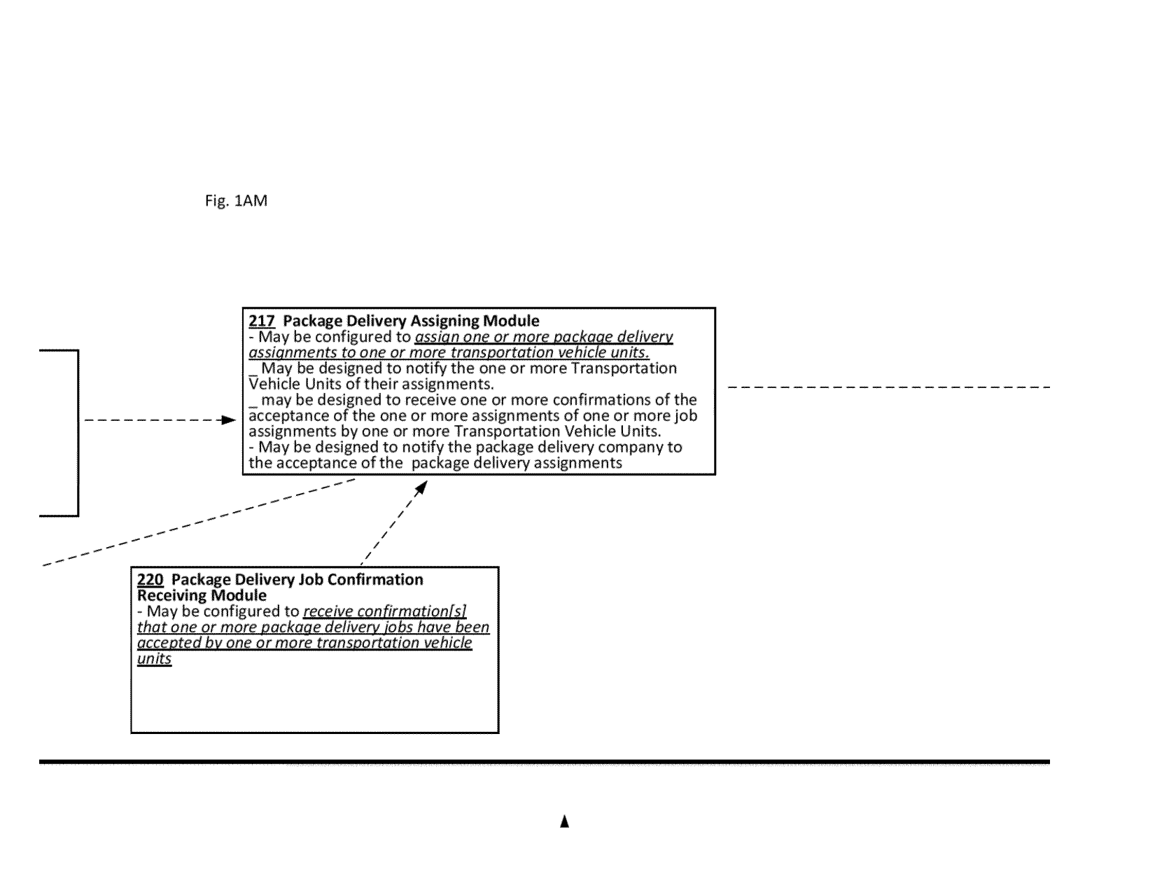

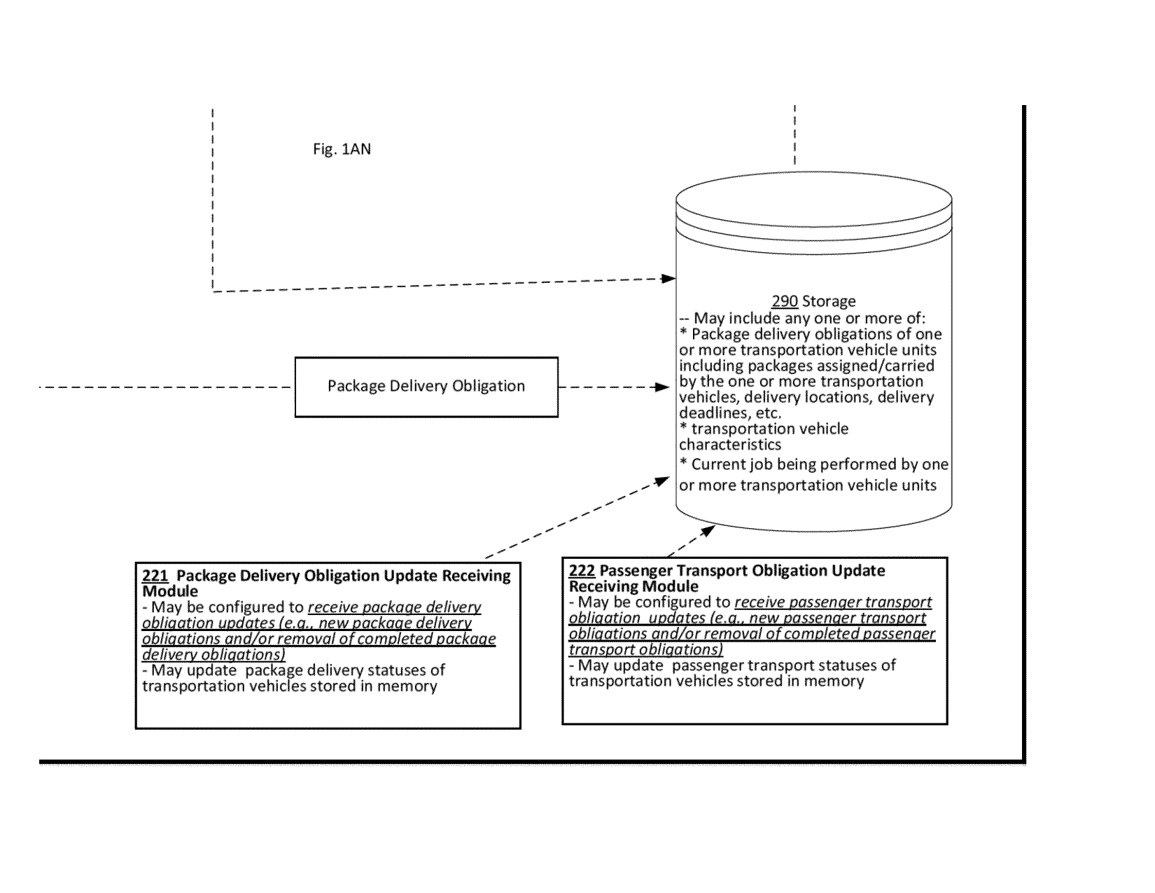

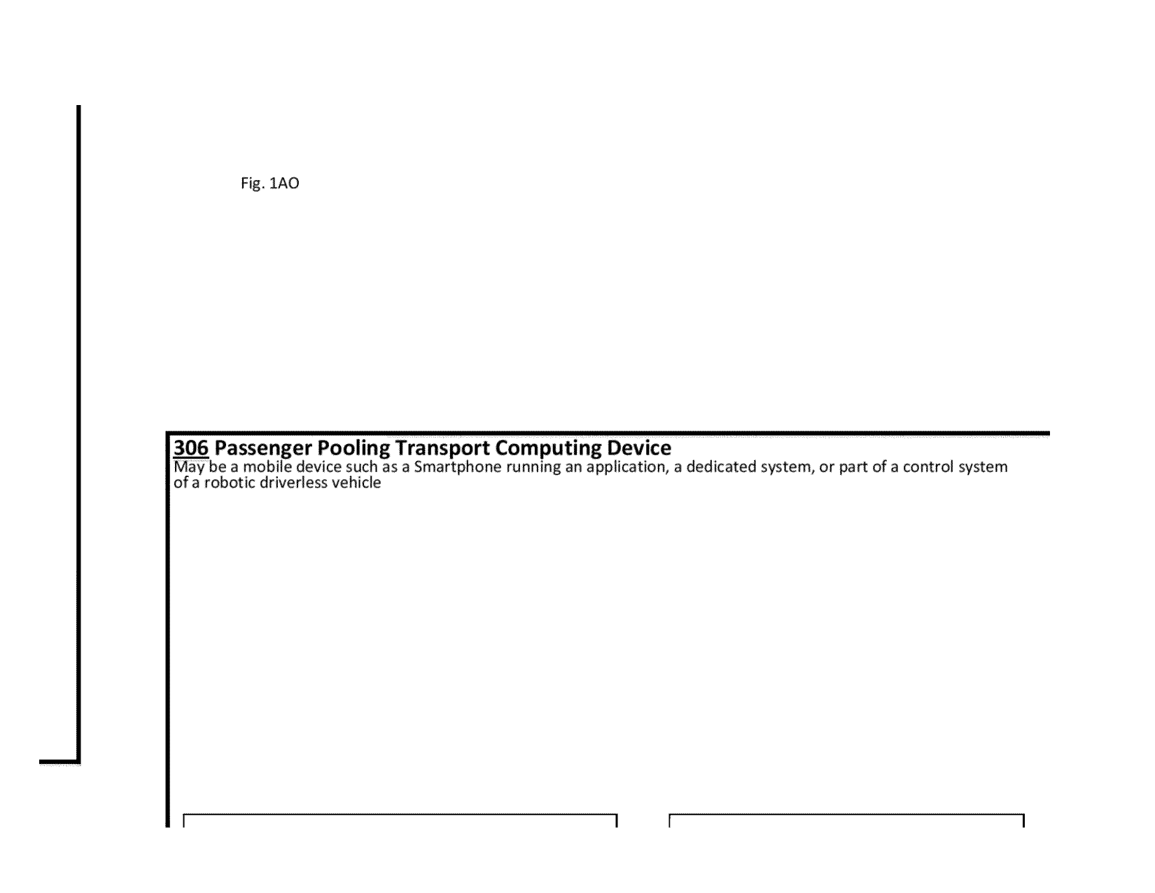

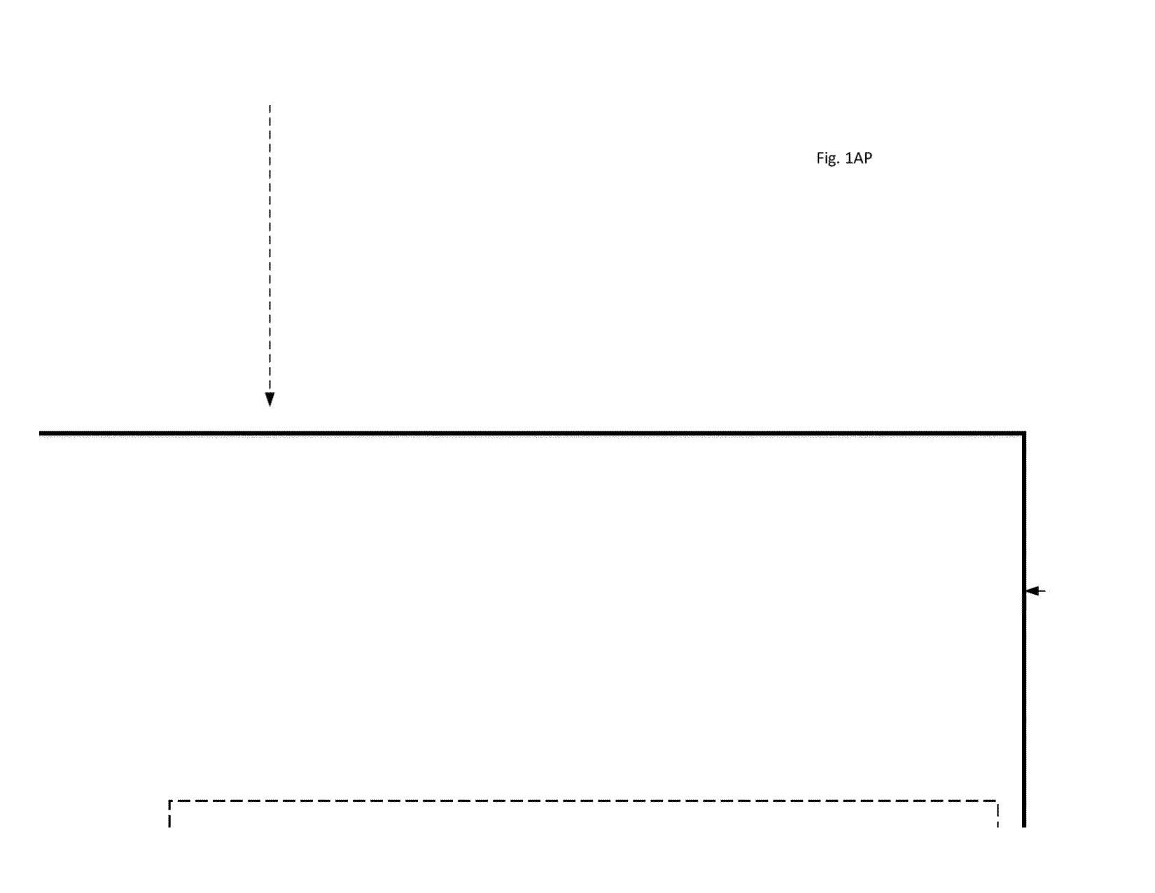

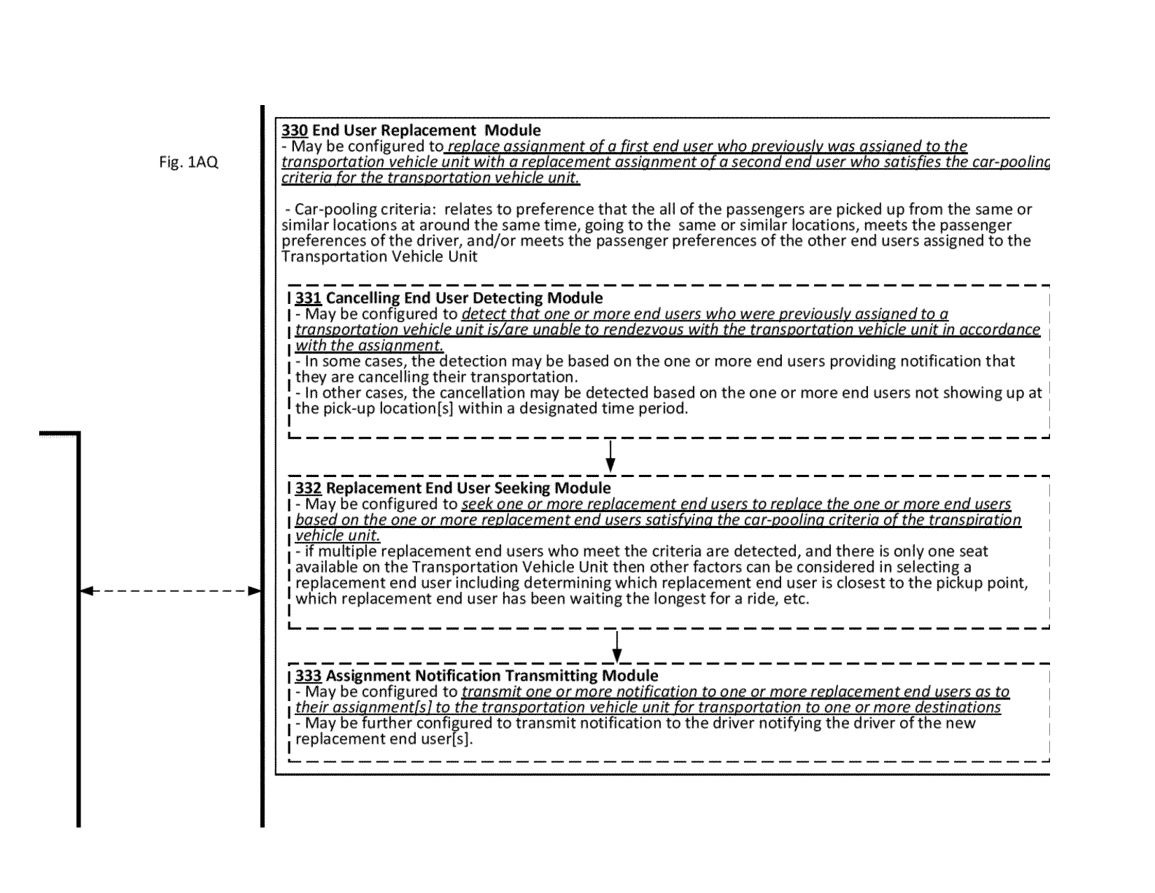

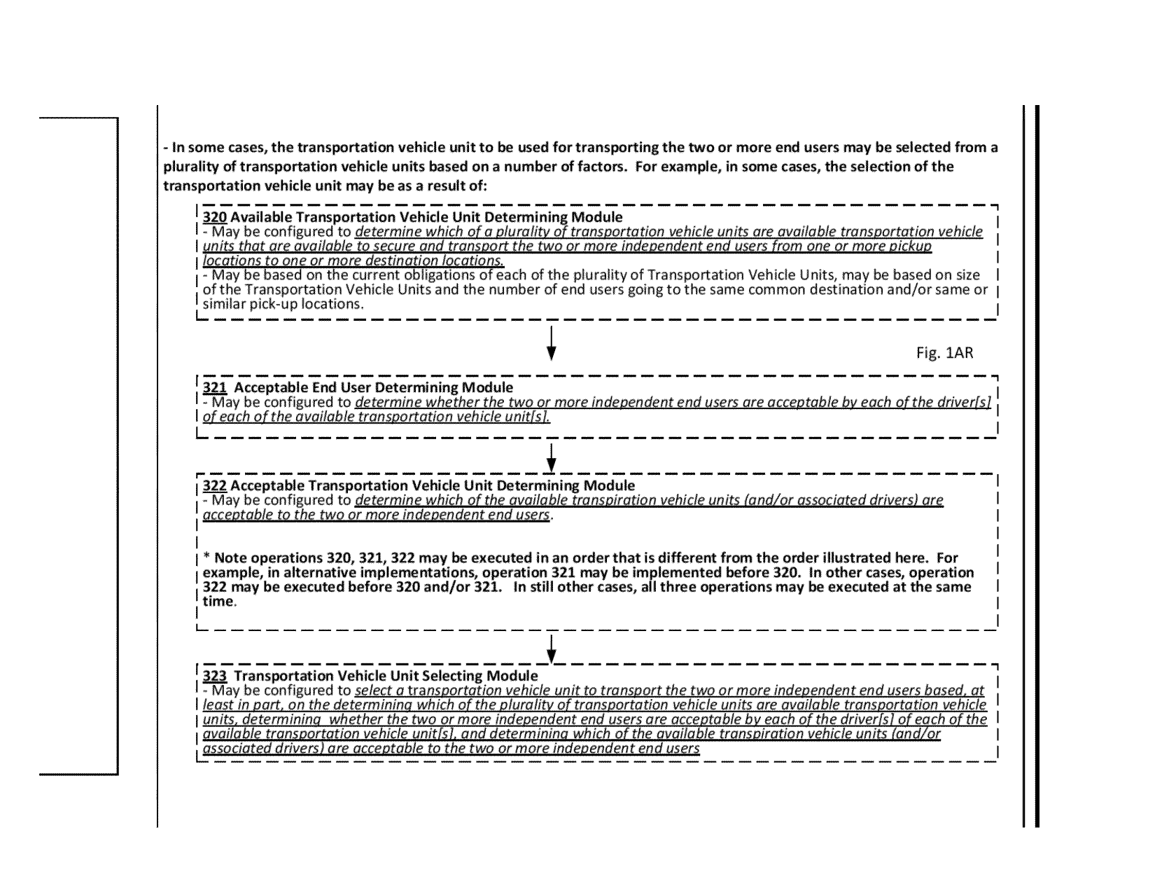

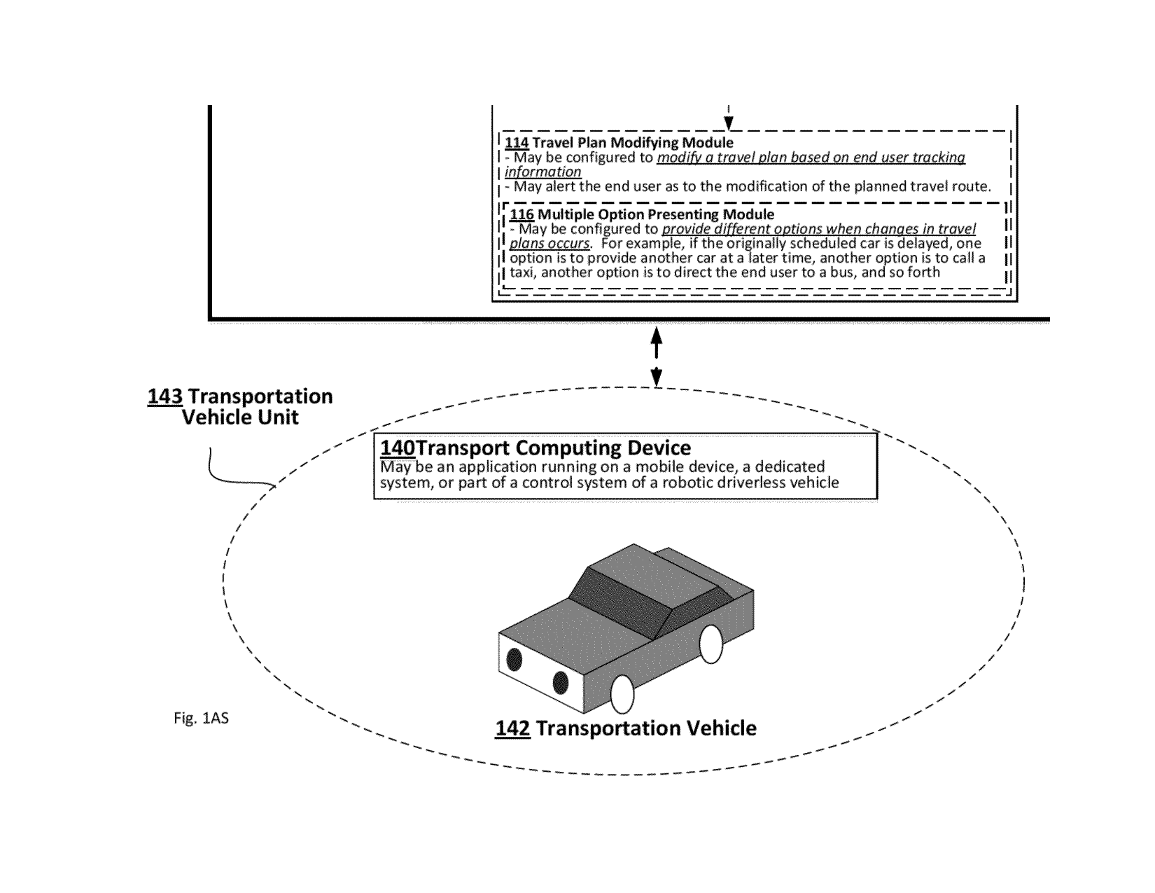

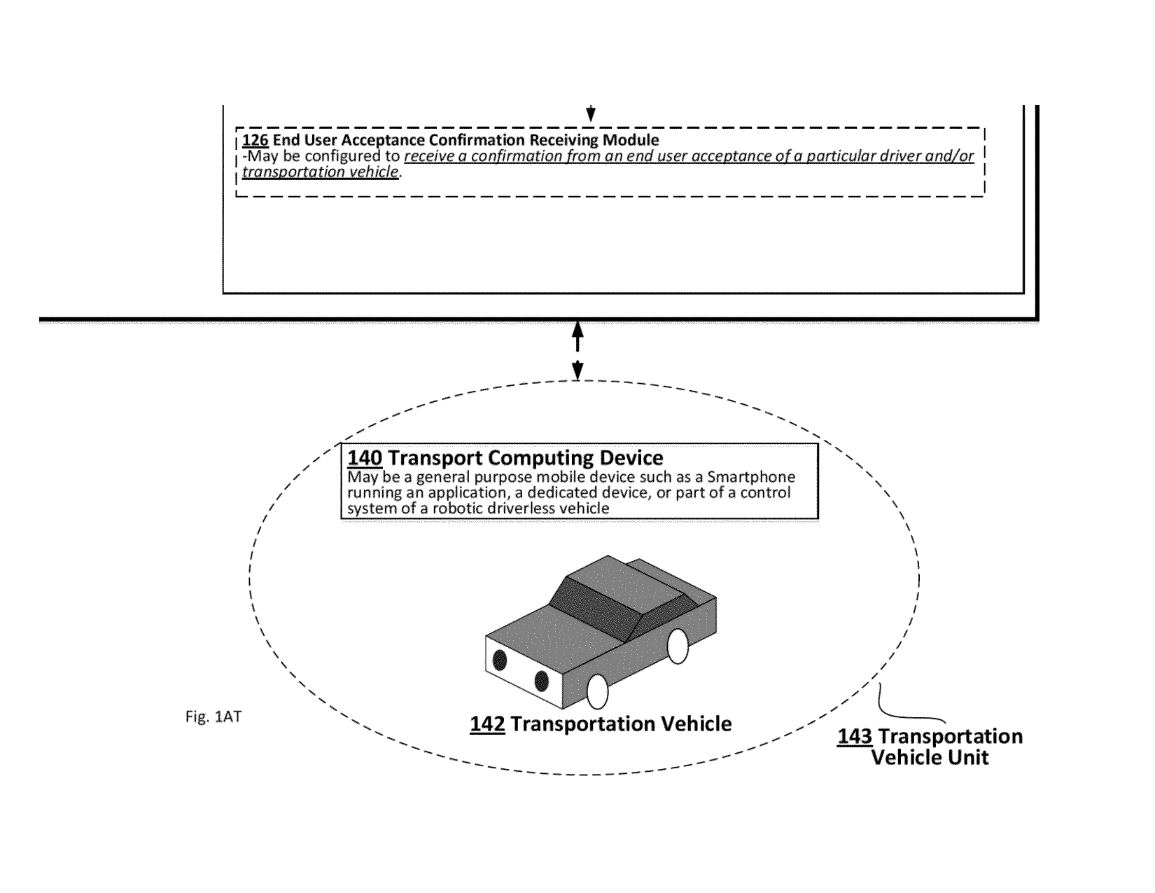

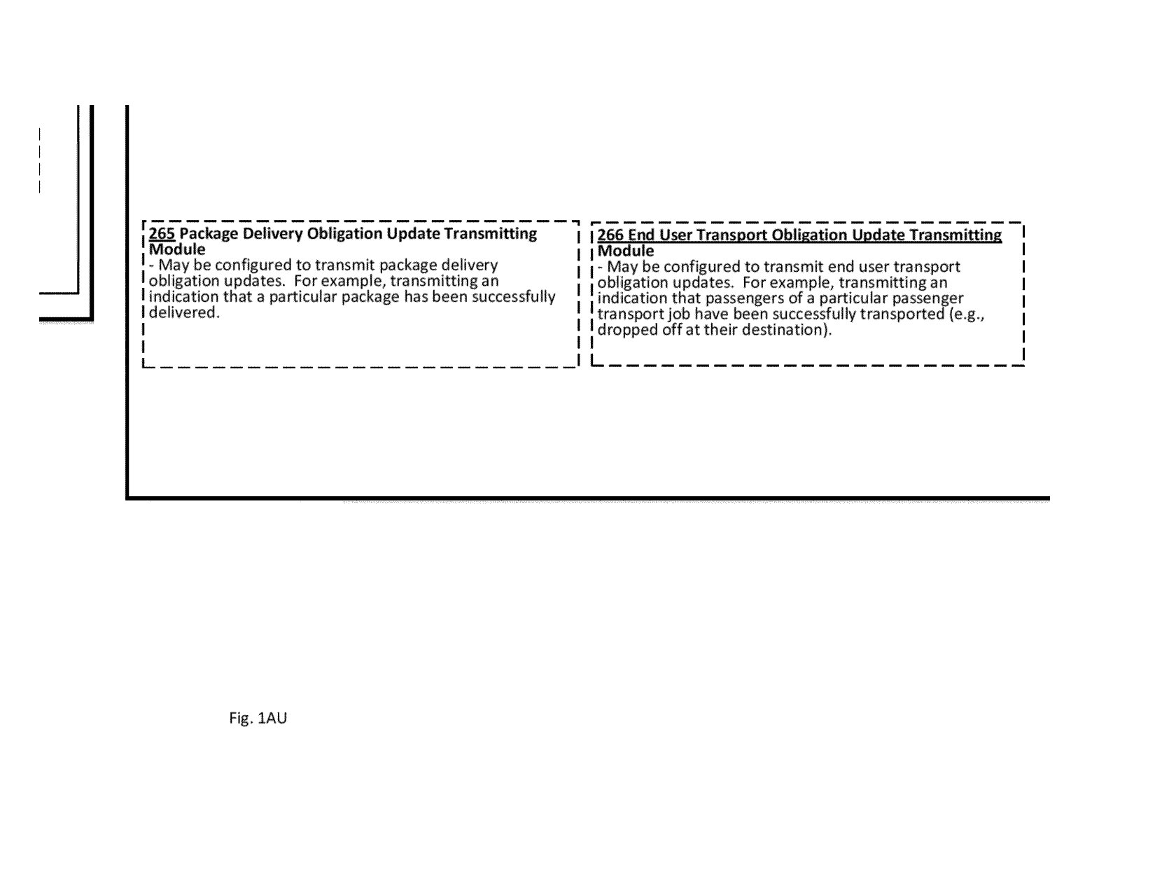

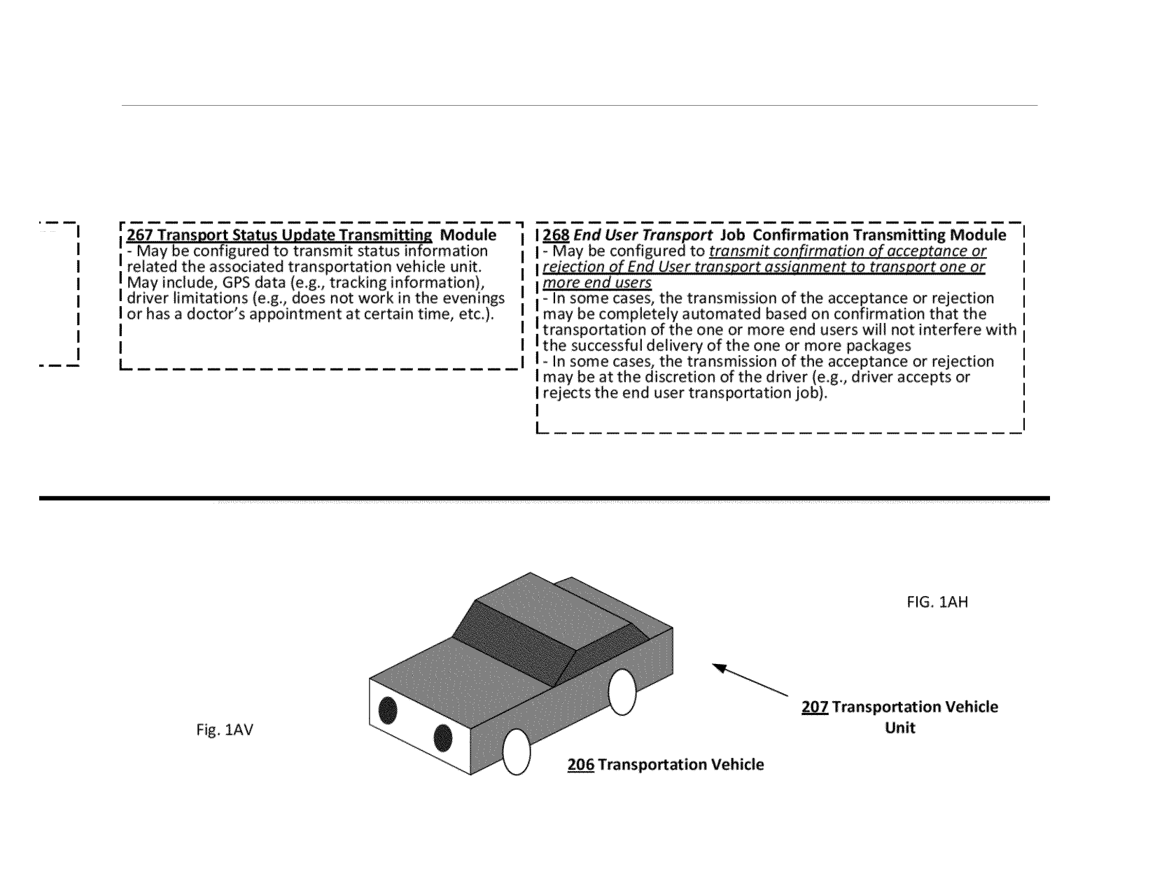

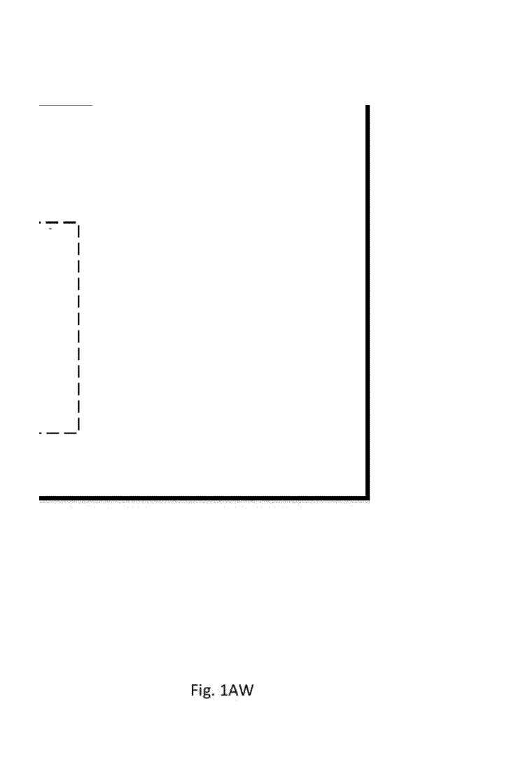

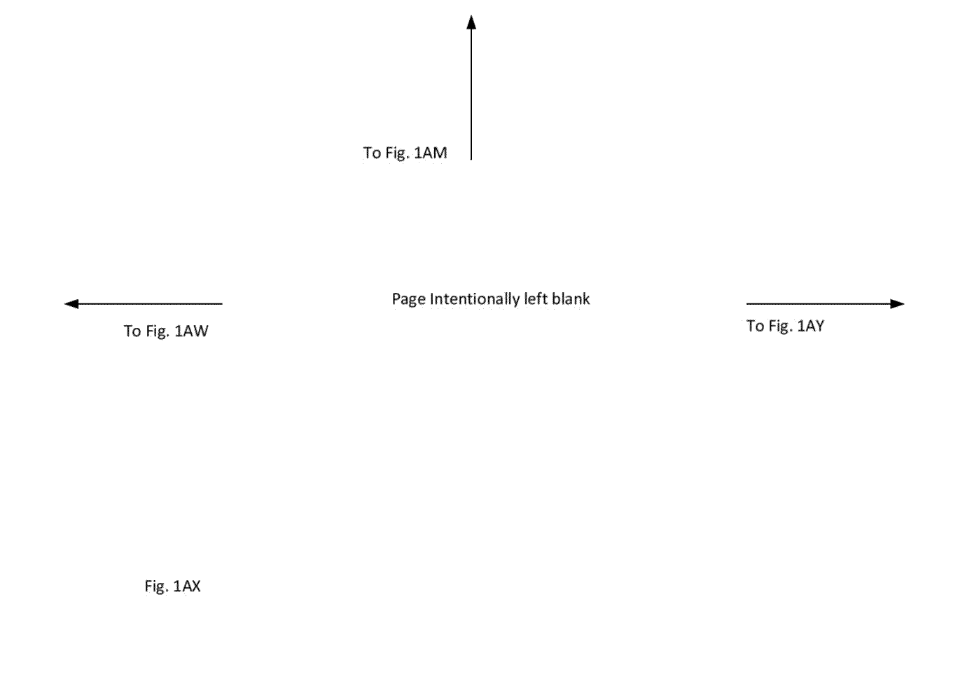

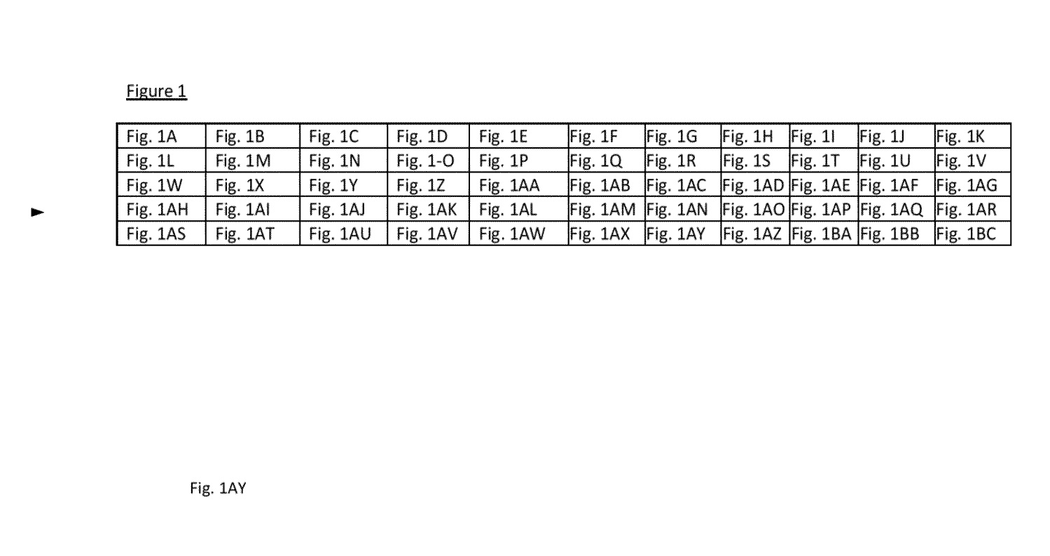

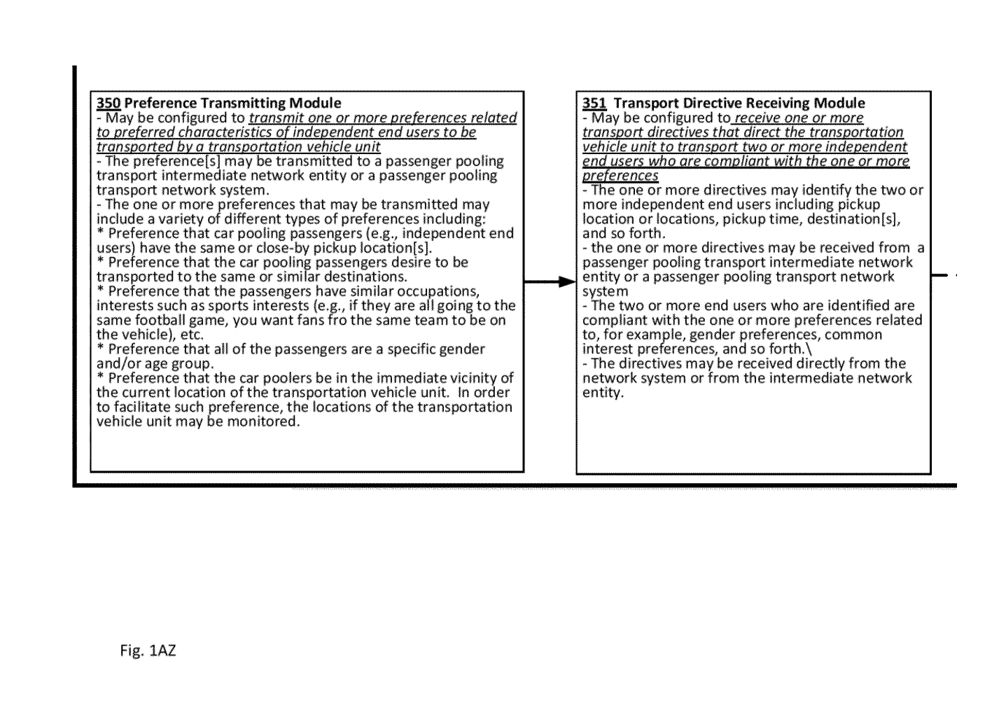

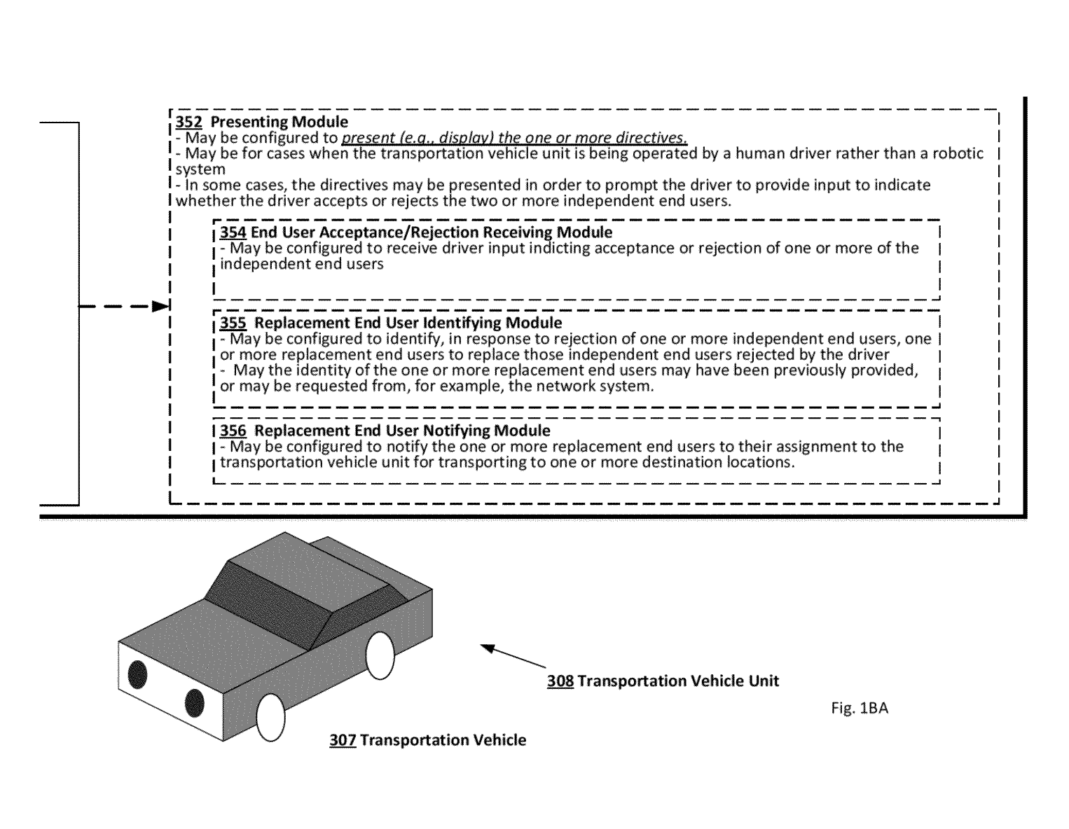

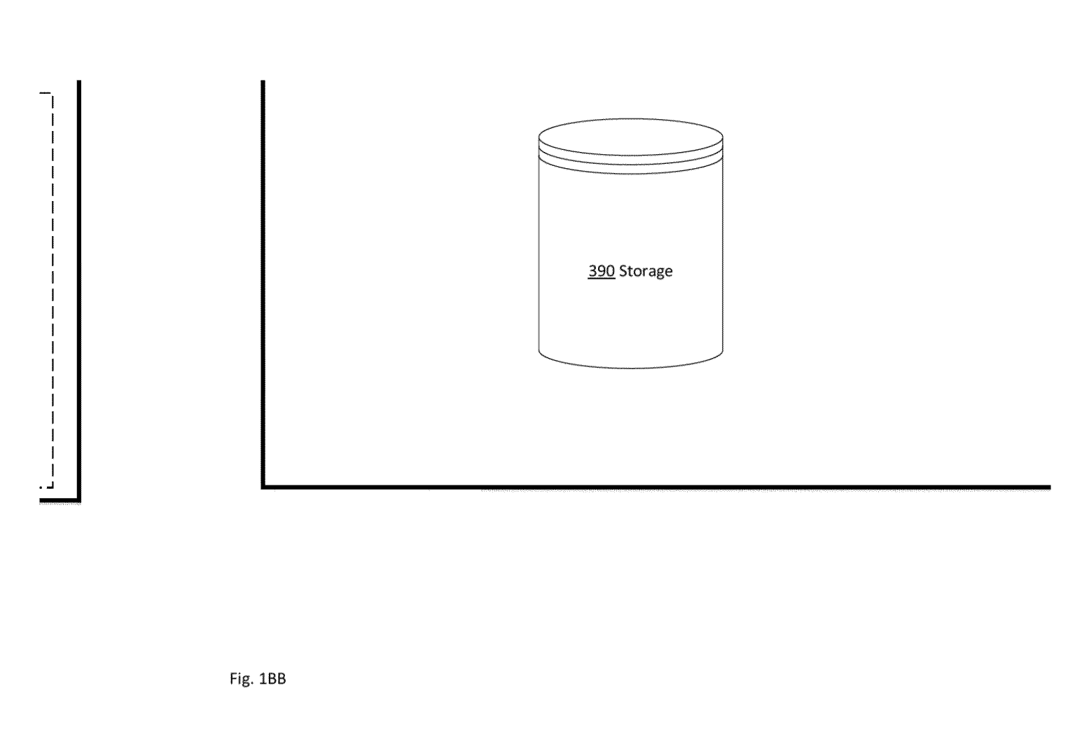

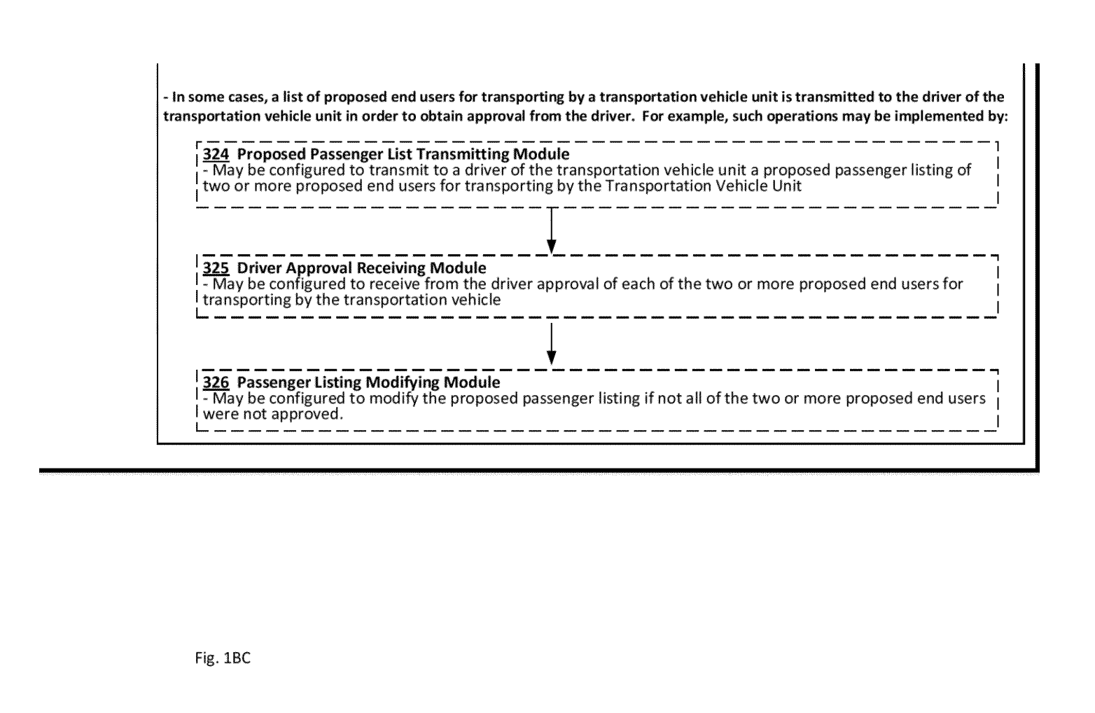

In accordance with 37 C.F.R. §1.84(h)(2), FIG. 1 shows “a view of a large machine or device in its entirety . . . broken into partial views . . . extended over several sheets” labeled FIG. 1A through FIG. 1BC (Sheets 1-55). The “views on two or more sheets form, in effect, a single complete view, [and] the views on the several sheets . . . [are] so arranged that the complete figure can be assembled” from “partial views drawn on separate sheets . . . linked edge to edge. Thus, in FIG. 1, the partial view FIGS. 1A through 1BC are ordered alphabetically, by increasing in columns from left to right, and increasing in rows top to bottom, as shown in the following table:

TABLE 1
Table showing alignment of enclosed drawings to form partial schematic of one or more
environments.

| Pos. | | | | | | | | | | X-Pos | X-Pos |
|---|---|---|---|---|---|---|---|---|---|---|---|
| (0,0) | X-Pos 1 | X-Pos 2 | X-Pos 3 | X-Pos 4 | X-Pos 5 | X-Pos 6 | X-Pos 7 | X-Pos 8 | X-Pos 9 | 10 | 11 |
| Y-Pos 1 | (1,1): | (1,2): | (1,3): | (1,4): | (1,5): | (1,6): | (1,7): | (1,8): | (1,9): | (1,10): | (1,11): |
| | FIG. | FIG. | FIG. | FIG. | FIG. | FIG. | FIG. | FIG. | FIG. | FIG. | FIG. |
| | 1A | 1B | 1C | 1D | 1E | 1F | 1G | 1H | 1I | 1J | 1K |
| Y-Pos 2 | (2,1): | (2.2): | (2,3): | (2,4): | (2,5): | (2,6): | (2,7): | (2,8): | (2,9): | (2,10): | (2,11): |
| | FIG. | FIG. | FIG. | FIG. | FIG. | FIG. | FIG. | FIG. | FIG. | FIG. | FIG. |
| | 1L | 1M | 1N | 1-O | 1P | 1Q | 1R | 1S | 1T | 1U | 1V |
| Y-Pos 3 | (3,1): | (3,2): | (3,3): | (3,4): | (3,5): | (3,6): | (3,7): | (3,8): | (3,9): | (3,10): | (3,11): |
| | FIG. | FIG. | FIG. | FIG. | FIG. | FIG. | FIG. | FIG. | FIG. | FIG. | FIG. |
| | 1W | 1X | 1Y | 1Z | 1AA | 1AB | 1AC | 1AD | 1AE | 1AF | 1AG |
| Y-Pos 4 | (4,1): | (4,2): | (4,3): | (4,4): | (4,5): | (4,6): | (4,7): | (4,8): | (4,9): | (4,10): | (4,11): |
| | FIG. | FIG. | FIG. | FIG. | FIG. | FIG. | FIG. | FIG. | FIG. | FIG. | FIG. |
| | 1AH | 1AI | 1AJ | 1AK | 1AL | 1AM | 1AN | 1AO | 1AP | 1AQ | 1AR |
| Y-Pos 5 | (5,1): | (5,2): | (5,3): | (5,4): | (5,5): | (5,6): | (5,7): | (5,8): | (5,9): | (5,10): | (5,11): |
| | FIG. | FIG. | FIG. | FIG. | FIG. | FIG. | FIG. | FIG. | FIG. | FIG. | FIG. |
| | 1AS | 1AT | 1AU | 1AV | 1AW | 1AX | 1AY | 1AZ | 1BA | 1BB | 1BC |

FIG. 1A, when placed at position (1,1), forms at least a portion of a partially schematic diagram of an environment(s) and/or an implementation(s) of technologies described herein.

FIG. 1B, when placed at position (1,2), forms at least a portion of a partially schematic diagram of an environment(s) and/or an implementation(s) of technologies described herein.

FIG. 1C, when placed at position (1,3), forms at least a portion of a partially schematic diagram of an environment(s) and/or an implementation(s) of technologies described herein.

FIG. 1D, when placed at position (1,4), forms at least a portion of a partially schematic diagram of an environment(s) and/or an implementation(s) of technologies described herein.

FIG. 1E, when placed at position (1,5), forms at least a portion of a partially schematic diagram of an environment(s) and/or an implementation(s) of technologies described herein.

FIG. 1F, when placed at position (1,6), forms at least a portion of a partially schematic diagram of an environment(s) and/or an implementation(s) of technologies described herein.

FIG. 1G, when placed at position (1,7), forms at least a portion of a partially schematic diagram of an environment(s) and/or an implementation(s) of technologies described herein.

FIG. 1H, when placed at position (1,8), forms at least a portion of a partially schematic diagram of an environment(s) and/or an implementation(s) of technologies described herein.

FIG. 1I, when placed at position (1,9), forms at least a portion of a partially schematic diagram of an environment(s) and/or an implementation(s) of technologies described herein.

FIG. 1J when placed at position (1,10), forms at least a portion of a partially schematic diagram of an environment(s) and/or an implementation(s) of technologies described herein.

FIG. 1K, when placed at position (1,11), forms at least a portion of a partially schematic diagram of an environment(s) and/or an implementation(s) of technologies described herein.

FIG. 1L, when placed at position (2,1), forms at least a portion of a partially schematic diagram of an environment(s) and/or an implementation(s) of technologies described herein.

FIG. 1M, when placed at position (2,2), forms at least a portion of a partially schematic diagram of an environment(s) and/or an implementation(s) of technologies described herein.

FIG. 1N, when placed at position (2,3), forms at least a portion of a partially schematic diagram of an environment(s) and/or an implementation(s) of technologies described herein.

FIG. 1O, when placed at position (2,4), forms at least a portion of a partially schematic diagram of an environment(s) and/or an implementation(s) of technologies described herein.

FIG. 1P, when placed at position (2,5), forms at least a portion of a partially schematic diagram of an environment(s) and/or an implementation(s) of technologies described herein.

FIG. 1Q, when placed at position (2,6), forms at least a portion of a partially schematic diagram of an environment(s) and/or an implementation(s) of technologies described herein.

FIG. 1R, when placed at position (2,7), forms at least a portion of a partially schematic diagram of an environment(s) and/or an implementation(s) of technologies described herein.

FIG. 1S, when placed at position (2,8), forms at least a portion of a partially schematic diagram of an environment(s) and/or an implementation(s) of technologies described herein.

FIG. 1T, when placed at position (2,9), forms at least a portion of a partially schematic diagram of an environment(s) and/or an implementation(s) of technologies described herein.

FIG. 1U, when placed at position (2,10), forms at least a portion of a partially schematic diagram of an environment(s) and/or an implementation(s) of technologies described herein.

FIG. 1V, when placed at position (2,11), forms at least a portion of a partially schematic diagram of an environment(s) and/or an implementation(s) of technologies described herein.

FIG. 1W, when placed at position (3,1), forms at least a portion of a partially schematic diagram of an environment(s) and/or an implementation(s) of technologies described herein.

FIG. 1X, when placed at position (3,2), forms at least a portion of a partially schematic diagram of an environment(s) and/or an implementation(s) of technologies described herein.

FIG. 1Y, when placed at position (3,3), forms at least a portion of a partially schematic diagram of an environment(s) and/or an implementation(s) of technologies described herein.

FIG. 1Z, when placed at position (3,4), forms at least a portion of a partially schematic diagram of an environment(s) and/or an implementation(s) of technologies described herein.

FIG. 1AA, when placed at position (3,5), forms at least a portion of a partially schematic diagram of an environment(s) and/or an implementation(s) of technologies described herein.

FIG. 1AB, when placed at position (3,6), forms at least a portion of a partially schematic diagram of an environment(s) and/or an implementation(s) of technologies described herein.

FIG. 1AC, when placed at position (3,7), forms at least a portion of a partially schematic diagram of an environment(s) and/or an implementation(s) of technologies described herein.

FIG. 1AD, when placed at position (3,8), forms at least a portion of a partially schematic diagram of an environment(s) and/or an implementation(s) of technologies described herein.

FIG. 1AE, when placed at position (3,9), forms at least a portion of a partially schematic diagram of an environment(s) and/or an implementation(s) of technologies described herein.

FIG. 1AF, when placed at position (3,10), forms at least a portion of a partially schematic diagram of an environment(s) and/or an implementation(s) of technologies described herein.

FIG. 1AG, when placed at position (3,11), forms at least a portion of a partially schematic diagram of an environment(s) and/or an implementation(s) of technologies described herein.

FIG. 1AH, when placed at position (4,1), forms at least a portion of a partially schematic diagram of an environment(s) and/or an implementation(s) of technologies described herein.

FIG. 1AI, when placed at position (4,2), forms at least a portion of a partially schematic diagram of an environment(s) and/or an implementation(s) of technologies described herein.

FIG. 1AJ, when placed at position (4,3), forms at least a portion of a partially schematic diagram of an environment(s) and/or an implementation(s) of technologies described herein.

FIG. 1AK, when placed at position (4,4), forms at least a portion of a partially schematic diagram of an environment(s) and/or an implementation(s) of technologies described herein.

FIG. 1AL, when placed at position (4,5), forms at least a portion of a partially schematic diagram of an environment(s) and/or an implementation(s) of technologies described herein.

FIG. 1AM, when placed at position (4,6), forms at least a portion of a partially schematic diagram of an environment(s) and/or an implementation(s) of technologies described herein.

FIG. 1AN, when placed at position (4,7), forms at least a portion of a partially schematic diagram of an environment(s) and/or an implementation(s) of technologies described herein.

FIG. 1AO, when placed at position (4,8), forms at least a portion of a partially schematic diagram of an environment(s) and/or an implementation(s) of technologies described herein.

FIG. 1AP, when placed at position (4,9), forms at least a portion of a partially schematic diagram of an environment(s) and/or an implementation(s) of technologies described herein.

FIG. 1AQ, when placed at position (4,10), forms at least a portion of a partially schematic diagram of an environment(s) and/or an implementation(s) of technologies described herein.

FIG. 1AR, when placed at position (4,11), forms at least a portion of a partially schematic diagram of an environment(s) and/or an implementation(s) of technologies described herein.

FIG. 1AS, when placed at position (5,1), forms at least a portion of a partially schematic diagram of an environment(s) and/or an implementation(s) of technologies described herein.

FIG. 1AT, when placed at position (5,2), forms at least a portion of a partially schematic diagram of an environment(s) and/or an implementation(s) of technologies described herein.

FIG. 1AU, when placed at position (5,3), forms at least a portion of a partially schematic diagram of an environment(s) and/or an implementation(s) of technologies described herein.

FIG. 1AV, when placed at position (5,4), forms at least a portion of a partially schematic diagram of an environment(s) and/or an implementation(s) of technologies described herein.

FIG. 1AW, when placed at position (5,5), forms at least a portion of a partially schematic diagram of an environment(s) and/or an implementation(s) of technologies described herein.

FIG. 1AX, when placed at position (5,6), forms at least a portion of a partially schematic diagram of an environment(s) and/or an implementation(s) of technologies described herein.

FIG. 1AY, when placed at position (5,7), forms at least a portion of a partially schematic diagram of an environment(s) and/or an implementation(s) of technologies described herein.

FIG. 1AZ, when placed at position (5,8), forms at least a portion of a partially schematic diagram of an environment(s) and/or an implementation(s) of technologies described herein.

FIG. 1BA, when placed at position (5,9), forms at least a portion of a partially schematic diagram of an environment(s) and/or an implementation(s) of technologies described herein.

FIG. 1BB when placed at position (5,10), forms at least a portion of a partially schematic diagram of an environment(s) and/or an implementation(s) of technologies described herein.

FIG. 1BC, when placed at position (5,11), forms at least a portion of a partially schematic diagram of an environment(s) and/or an implementation(s) of technologies described herein.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Thus, in accordance with various embodiments, computationally implemented methods, systems, circuitry, articles of manufacture, ordered chains of matter, and computer program products are designed to, among other things, provide an interface for the environment illustrated in FIG. 1.

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic, etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-levelprogramming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeroes and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media holds or transmits device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include, but are not limited to, a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server. The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

To the extent that formal outline headings are present in this application, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, any use of formal outline headings in this application is for presentation purposes, and is not intended to be in any way limiting.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

Although one or more users maybe shown and/or described herein, e.g., in FIG. 1, and other places, as a single illustrated figure, those skilled in the art will appreciate that one or more users may be representative of one or more human users, robotic users (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

Throughout this application, the word “implementation” may appear in various locations. This word is intended to designate implementations or instantiations of systems that may take any known form, including hardware, computer-implemented applications, modules, components, systems, collections, or any combination thereof.

Development of Transportation Networking Technologies

One of the newest trends in the field of transportation/commuting particularly in urban settings is the development of transportation networking services provided by web-based companies such as Uber and Lyft that allow users to retain drivers/vehicles for transportation services through, for example, mobile applications. The increasingly popularity of such ridesharing services have already made some of the early entrants into this new field household names. As with many new technological ventures, the functionalities provided through such services are somewhat limited. However, there appears to be ample opportunities for adding new and value adding functionalities to such services (as well as to more traditional transportation services such as Taxi services) in order to provide more robust transportation networking systems.

Travel Planning Feature

Referring to FIG. 1, e.g., FIG. 1B, an end user 10a (e.g., a prospective passenger or traveler) may be facilitated in reaching a destination from a starting point by having the end user's entire travel route from the starting point to a destination location planned including arranging one or more transportation vehicle units 143 (e.g., a transportation vehicle 142 and a human driver or a transportation vehicle 142 and a robotic driver) to transport the end user 10a for at least a portion or portions of the planned travel route (e.g., a travel or route plan to reach a destination location from a starting location). For example, in some cases, a planned travel route may be developed for an end user 10a that involves planning a travel route from a starting location to a final destination that includes at least two different route legs where at least one route leg requires one or more transportation vehicle units 143 to transport the end user 10a over the at least one route leg, and to arrange the one or more transportation vehicle units 143 to rendezvous with the end user 10a at the appropriate location and at the appropriate time in order to timely transport the end user 10a over the at least one route leg. Note that references in the following to a “transportation vehicle” may be in reference to an automobile (e.g., electrical, natural gas, or gasoline powered automobile). In some cases, a “planned travel route” for traveling to a destination location from a starting location may indicate, in addition to identifying one or more transportation vehicle units that may be initially designated for transporting an end user 10a for at least a portion of the overall trip, driving/walking/mass transit/ferry instructions or directions for traveling over the other portions of the overall trip. In some cases, a planned travel route may have textual information (e.g., street by street turn directions) and/or graphical information (e.g., a street map with a highlighted route).

In some cases, the development of a planned travel route for an end user 10a to reach a destination location from a starting point or location may involve planning at least first and second route legs of the overall trip to reach the destination location, where the first route leg involves no transportation vehicle unit (e.g., automobile) and where the second leg route leg calls for the use of a transportation vehicle unit 143. The developed planned travel route may at least identify the intermediate location (and time) where the transportation vehicle unit 143 may rendezvous with the end user 10a in order to be transported over the second route leg of the journey. For these cases, the development of the planned travel route may involve estimating the arrival time of the end user 10a at the intermediate location so that arrangements can be made to have a transportation vehicle unit 143 to rendezvous with the end user 10a in a timely manner at the intermediate location.

In some cases, the development of a planned travel route for an end user 10a may involve arranging (e.g., instructing, directing, and/or reserving) multiple transportation vehicle units 143 to transport the end user 10a over different portions of the entire planned travel route from a starting location to a destination location. For example, in some cases, the development of a planned travel route for an end user 10a may involve planning a travel route from the starting location to an intermediate location by arranging a first transportation vehicle unit to transport the end user 10a from the starting location to the intermediate location (e.g., first route leg), and then arranging a second transportation vehicle unit to transport the end user 10a from the intermediate location to the destination location (e.g., second route leg).

Referring particularly now to the end user device 101 of FIG. 1A, which may be used by an end user 10a in order to have a trip planned from a starting point to a destination location including having one or more transportation vehicle units 143 being arranged to transport the end user 10a for at least a portion of the trip. In various embodiments, the end user device 101 may be a general purpose computing device such as a mobile computing device (e.g., a Smartphone, a laptop computer, a tablet computer, and so forth) that is executing one or more applications. As illustrated in FIG. 1, the end user device 101 may include various logic modules for executing various functionalities. For purposes of this description, a “module” may be implemented using, for example, dedicated circuitry such as application specific integrated circuit (ASIC), or by employing programmable circuitry that is running a software program such as a microprocessor executing one or more programming instructions (or a field programmable gate array or FPGA executing programming instructions).

In some embodiments, the travel planning end user device 101 may communicate with a travel planning network system 100 in order to provide to one or more end users 10a a planned travel route (e.g., a travel plan) to reach a destination location from a starting point. The travel planning end user device 101 may further communicate with the travel planning network system 100 to arrange for one or more transportation vehicle units 143 (e.g., a transportation vehicle 142 such as an automobile and a human or robotic driver) to rendezvous with the one or more end users 10a at some point or points along the travel route between a starting location and a destination location (at some arranged point or point in time) to transport the one or more end users 10a over one or more route legs (e.g., portions) of the travel route.

As illustrated, the travel planning end user device 101 may include a request accepting/relaying module 160 that may be configured to receive (as well as relay to, for example, the travel plan network system 100) a request for transporting one or more end users 10a to a destination location. In some cases, the request may be entered by, for example, one of the one or more end users 10a via a user interface (e.g., touchscreen or keypad). In some cases, the request that may be submitted may include a variety of information including, for example, current location of the one or more end users 10a, the starting location, the destination location, the desired arrival time at the destination location, and so forth. In some cases, the request may also indicate certain preferences of an end user 10a including, for example, types of transportation vehicles or drivers (e.g., male) that the end user 10a prefers, preference for secondary transportation (e.g., mass transit as opposed to ferries for transporting the end user 10a during the portion or portions of the planned travel route that does not require an automobile), etc. As further illustrated, the travel planning end user device 101 may further include a travel plan providing module 162 that may be configured to provide, in response at least in part to the request, a travel plan for the one or more end users 10a for traveling from a starting location to a destination location, the travel plan indicating at least two route legs including at least one route leg that requires a transportation vehicle unit 143 to transport the one or more end users 10a.

In order to provide the travel plan, the travel plan may be entirely obtained from an external source (e.g., from a travel planning network system 100) or alternatively, at least a portion of the travel plan may be self-generated by the travel plan providing module 162. For example, in various embodiments, the travel plan providing module 162 may include a travel plan receiving module 170 that is configured to receive the travel plan for reaching the destination location from an outside source. In the same or alternative embodiments, the travel plan providing module 162 may include a travel plan planning module 172 that may be configured to plan at least a portion[s] (e.g., route legs) of a travel plan that may or may not require, for example, the use of transportation vehicle unit[s] 143 for transporting the one or more end users 10a. For these embodiments, the travel planning end user device 101 may have the logic needed in order to plan portions (e.g., route legs) of the overall travel plan that does not call for the use of an automobile (but instead requires the end user 10a to walk, bike, ferry, and/or use mass transit). The travel planning end user device 101 may then be designed to communicate with, for example, the travel planning network system 100 in order to have one or more transportation vehicle units reserved or instructed to transport the one or more end users 10a over one or more legs of the overall planned travel route. Note that in some cases, a travel plan may provide specific planned travel routes (e.g., street-by-street and turn-by-turn routing) for one or more route legs identified by travel plan.

In some cases, the travel route planning module 172 may also be further designed to modify a travel plan (as well as a planned travel route indicated by the travel plan) as a result of tracking the locations of the one or more end users 10a and determining that the end user[s] 10a has deviated from a planned travel route specified by, for example, the travel plan (e.g., taking a different route or being late or early at different route junctions). For example, the travel route planning module 172 may include an end user tracking module 173 that may be configured to track the location[s] of the one or more end users 10a. The travel route modifying module 174 may be configured to modify a travel plan (as well as a planned travel route specified by the travel plan) based on the end user tracking information. In some cases, the travel route planning module 172 may include a multiple option presenting module 175 that may be configured to provide (e.g., display) different options (e.g., use mass transit instead of a transportation vehicle unit or simply walk to the destination) when an end user 10a is detected as deviating from a planned travel route, as specified by a travel plan or is unable to continue with the travel plan (e.g., the one or more end users 10a unable to rendezvous with a transportation vehicle unit at the rendezvous time).

As further illustrated, the travel planning end user device 101 may further include a confirmation transmitting module 163 that is designed to transmit confirmation data indicative of acceptance of the proposed transportation vehicle unit that has been assigned to rendezvous with the one or more end users 10a in order to transport the one or more end users 10a over at least one route leg of the travel plan that was provided to the end user 10a. In some cases, the confirmation may be transmitted to a travel planning network system 100. In some cases the travel planning end user device 101 (as well as the travel planning network system 100) may be in communication with a third party network system 180 (e.g., weather forecasting service, department of transportation, ferry services, etc.) in order to obtain various services (e.g., transportation reservations) and/or information (e.g., weather, departure schedules for mass transit).

Referring now to the travel planning network system 100 that may be in communication with the travel planning end user device 101. In various embodiments, the travel planning network system 100 may be a network device (e.g., a server or a workstation) or a plurality of network devices (e.g., servers, workstations, storage devices, and so forth). In some embodiments, the travel planning network system 100 may be affiliated with small to mid-sized company (e.g., Uber, Lyft, Yellow Cab company), or alternatively, may be associated with a big data company 4 (e.g., Amazon, Google, Microsoft, etc.). In various embodiments, the travel planning network system 100 may be designed to plan travel routes for end users 10a in order to reach destinations. The travel planning network system 100 may also be designed to arrange and direct transportation vehicle units 143 to transport end users 10a for at least portions (e.g., route legs) of travel plans of the end users 10a for reaching destination locations.

As illustrated, the travel planning network system 100 may include one or more modules including, for example, a request receiving module 102 that may be configured to receive, among other things, a request for transporting one or more end users 10a to a destination location. In some cases, the request may be received from a travel planning end user device 101. The travel planning network system 100 may further include a travel plan providing module 103 that may be configured to provide (e.g., develop or generate) a travel plan for facilitating the one or more end users 10a to travel to the destination location from a starting location, the travel plan identifying at least two route legs including at least one transport route leg that calls for at least one transportation vehicle unit to transport the one or more end users over the transport route leg. As part of the planning process, arrangements may be made to have the transportation vehicle unit 143 that may be identified in the planned travel route to rendezvous with the one or more end users 10a at an appropriate location and time in order to transport the one or more end users 10a over the at least one route leg of the planned travel route.

As further illustrated, the travel plan providing module 103 may further include a travel plan transmitting module 110 that may be configured to transmit the generated planned travel route to, for example, the travel planning end user device 101. As also illustrated, the travel plan providing module 103 may additionally or alternatively include an end user/transportation vehicle unit tracking module 112 that may be configured to track the location of an end user 10a and/or transportation vehicle unit 143 assigned to transport the end user 10a. The travel plan providing module 103 may further include a travel plan modifying module 114 that may be configured to modify a travel plan based on end user tracking information. The travel plan modifying module 114 may further comprise a multiple option presenting module 116 that may be configured to provide options (e.g., suggestions for a different transportation vehicle unit 143 at different rendezvous point or pickup time, suggestion to use mass transit, etc.) when changes in travel plans occurs. As further illustrated, the travel planning network system 100 may further include storage 190 (e.g., volatile and/or non-volatile memory) for storing various information including generated planned travel routes of end users 10a, end user preferences related to vehicles, drivers, transportation modes, etc., driver and end user ratings, and so forth.

As illustrated, the travel planning network system 100 may be in communication with one or more transportation vehicle units 143 via transport computing devices 140 (e.g., a dedicated system or a general purpose computing device such as a mobile computing device such as a Smartphone running specialized applications). Note that each transportation vehicle unit 143 may comprise a transportation vehicle 142, a robotic or human driver, and a transport computing device 140.

The travel planning network system 100 may further include a transportation vehicle unit directing module 104 that may be configured to direct (e.g., instruct or command) the transportation vehicle unit 143 (as called for by the travel plan provided by the travel plan providing module 103) to rendezvous with the one or more end users 10a in order for the one or more end users 10a to be transported over the transport route leg. As further illustrated, the transportation vehicle unit directing module 104 may further include a transportation vehicle unit identifying module 120 (which may be configured to identify the transportation vehicle unit to be directed to transport the one or more end users), a transport requesting module 122 (which may be configured to transmit to the identified transport vehicle a request for transporting one or more end users 10a), a transport vehicle confirmation receiving module 124 (which may be configured to receive a confirmation that confirms that the identified transportation vehicle unit will handle the transportation of the one or more end users 10a), and/or an end user acceptance confirmation receiving module 126 (which may be configured to receive a confirmation from an end user 10a acceptance of a particular driver and/or transportation vehicle.

Package/Passenger Transportation Feature

Referring now to FIG. 1D illustrating an end user 10b who may submit, via an end user device 20b, a request for one or more transportation vehicle units 207 for transporting the end user 10b (and/or for transporting one or more other end users 10b) to one or more destination locations. In response to the request, one or more transportation vehicle units 207 (e.g., a transportation vehicle 206, a human or robotic driver, and a package/passenger transport computing device 205) may be directed to transport the end user 10b. In some cases, the one or more transportation vehicle units 207 that are directed (e.g., instructed) to transport the end user 10b may have been identified or ascertained not to have one or more package delivery obligations (e.g., not to have any package delivery obligations) that would be violated if the one or more transportation vehicle units 207 transport the one or more end users 10b to the one or more destination locations. In some cases, the end user 10b may request for the one or more transportation vehicle units 207 by using, for example, an end user device 20b (e.g., a computing device such as a laptop or a Smartphone). In order to facilitate arrangement of transportation to the one or more destination locations, the end user device 20b may be in communication with a package/passenger transport intermediate network entity 201 and/or a package/passenger transport network system 200.

Referring particularly now to the package/passenger transport network system 200 of FIG. 1 (see, for example, FIG. 1P), which may be a network device such as a server or a workstation, or a plurality of network devices (e.g., servers, workstations, storage devices, etc.—e.g. the “cloud”). In some cases, the package/passenger transport network system 200 may be associated with (e.g., controlled by) a small to mid-sized company (e.g., Uber, Lyft, Yellow Cab Company) or may be associated with, for example, a big data company 4 (e.g., Amazon, Google, Microsoft, etc.). In various embodiments, the package/passenger transport network system 200 may include one or more modules including, for example, an end user transport request receiving module 201 that may be configured to receive, among other things, a request for transporting one or more end users 10b. In some cases, the request may be received from a package/passenger transport intermediate network entity 201 (e.g., a server[s] or a workstation[s] that may or may not be located entirely or partially in the U.S.) or may be received directly from an end user device 20b associated with an end user 10b.

As further illustrated, the package/passenger transport network system 200 may further include a transportation vehicle unit identifying module 202 that may be configured to, among other things, identify (e.g., ascertain or find) a transportation vehicle unit 207 (e.g., a transportation vehicle 206, a robotic or human driver, and a package/passenger transport computing device 205, which may be a dedicated device or a general purpose computing device such as a Smartphone running specialized application[s]) to transport the one or more end users 10b to the one or more destinations based, at least in part, on determination that the transportation vehicle unit 207 that is identified would not violate one or more package delivery obligations of the transportation vehicle unit 207 if the one or more end users 10b are transported by the transportation vehicle unit 207.

In some cases, the transportation vehicle unit identifying module 202 may further include an available transportation vehicle unit module 210, a non-violating transportation vehicle unit determining module 211, and/or a best fit non-violating transportation vehicle unit determining module 212. The available transportation vehicle unit module 210 may be designed to determine whether there are one or more “available” transportation vehicle units 207 in the proximate vicinity of the one or more end users 10b that are available to transport the one or more end users 10b. The non-violating transportation vehicle unit determining module 211, in contrast, may be designed to determine which of the one or more available transportation vehicle units (e.g., transportation vehicle unit 207) are “non-violating” transportation vehicle units that will not violate their package delivery obligations if assigned to transport the one or more end user 10b. On the other hand, the best fit non-violating transportation vehicle unit determining module 212 may be designed to determine a “best-fit non-violating” transportation vehicle unit based on other factors including which of the non-violating transportation vehicles are nearest to the one or more end users 10b, which of the non-violating transportation vehicle units meet the preferences of the one or more end users 10b, which of the non-violating transportation vehicle units have drivers who will accept the one or more end users 10b as passengers, and so forth.

As further illustrated, in various embodiments, the package/passenger transport network system 200 may further include an end user transport directive transmitting module 203 that may be configured to transmit one or more directives that direct (e.g., instruct) the transportation vehicle unit 207 to rendezvous with the one or more end users 10b in order to transport the one or more end users 10b to the one or more destination locations.

As also illustrated, the package/passenger transport network system 200 may additionally or alternatively include one or more other modules/components including, for example, a package delivery obligation obtaining module 215 (e.g., a module for obtaining package delivery obligations of transportation vehicle units 207), a package delivery request receiving module 216 (e.g., a module for receiving requests for delivery of one or more packages by one or more transportation vehicle units 207), and/or a package delivery assigning module 217 (e.g., a module that may be designed to assign one or more package delivery assignments to one or more transportation vehicle units 207 in response to the package delivery request receiving module 216 receiving one or more requests for delivery of one or more packages). As illustrated, the package delivery obligation obtaining module 215 and/or the package delivery assignment module 217 may provide to the transportation vehicle unit identifying module 202 or storage 290 package delivery obligation[s] of one or more transportation vehicle units 207.

In some cases, the package/passenger transport network system 200 may additionally or alternatively include a package delivery directive transmitting module 219, a package delivery job confirmation receiving module 220, a package delivery obligation update receiving module 221, and/or a passenger transport obligation update receiving module 222. The package delivery directive transmitting module 219 may be designed to transmit one or more directives that direct one or more transportation vehicle units 207 to deliver one or more packages. In some cases, the transmission of the directives may be in response to the package delivery assigning module 217 assigning the one or more package delivery assignments to the one or more transportation vehicle units 207. The directives to be transmitted may be transmitted directly to the one or more transportation vehicle units 207 in some cases, while in other cases the directives may be transmitted to the one or more transportation vehicle units 207 via a package/passenger transport intermediate network entity 201.

The package delivery job confirmation receiving module 220 may be designed to receive one or more confirmations that one or more package delivery jobs have been accepted by one or more transportation vehicle units 207. In contrast, the package delivery obligation update receiving module 221 that may be configured to receive package delivery obligation updates (e.g., updates that indicates whether, for example, a package (e.g., a parcel) has been successfully delivered) directly from one or more transportation vehicle units 207 and/or from a package/passenger transport intermediate network entity 201. Similarly, the passenger transport obligation update reeving module 222 may be designed to receive passenger transport obligation updates (e.g., updates that indicate that passengers or end users 10b have been successfully transported to their destinations) directly from one or more transportation vehicle units 207 and/or from a package/passenger transport intermediate network entity 201.

In various embodiments, the package/passenger transport network system 200 may communicate with one or more end users 10b and/or one or more transportation vehicle units 207 via a package/passenger transport intermediate network entity 201. In some cases, the package/passenger transport network system 200 may be in communication with a package delivery service entity 206 (e.g., FedEx, UPS, Amazon, and so forth). For example, in some cases, a package delivery service entity 206 may transmit directly to the package/passenger transport network system 200 (or via the package/passenger transport intermediate network entity 201) one or more requests for one or more transportation vehicle units for use in delivering one or more packages.

In some cases, the package delivery service entity 206 may request not just packages to be transported by one or more transportation vehicle units 207 but also one or more personnel (e.g., one or more delivery persons) to assist in delivery of the packages. For example, when the package/passenger transport network system 200 arranges one or more transportation vehicle units 207 to pick-up and deliver one or more packages in response to receiving a request for package delivery from the package delivery service entity 206, the package/passenger transport network system 200 may also arrange for the one or more transportation vehicle units 207 to pick-up and transport at least one delivery personnel to assist in delivery of the one or more packages.

Turning particularly now to the package/passenger transport intermediate network entity 201 (see, for example, FIG. 1N), which in some cases may be a network system such as a server[s], workstation[s], and so forth. In some cases, the package/passenger transport intermediate network entity 201 may be associated with (e.g., controlled by) a passenger transport company 2 (e.g., a transportation network company such as Uber, Lyft, Yellow Cab Company, and so forth). As illustrated, the package/passenger transport intermediate network entity 201 may include one or more modules/components including, in some cases, an end user transport request transmitting module 230, a transportation vehicle unit directive receiving module 231, and/or a transportation vehicle unit directing module 232. In various embodiments, the end user transport request transmitting module 230 may be configured to transmit a request for transporting one or more end users 10b (e.g., a request for one or more transportation vehicle units 207 to transport one or more end users 10b from one or more starting locations to one or more destination locations).

The transportation vehicle unit directive receiving module 231, on the other hand, may be configured to receive one or more directives that direct (e.g., instructs) one or more identified transportation vehicle units (e.g., transportation vehicle unit 207) to transport the one or more end users 10b, the one or more identified transportation vehicle units 207 having been identified or ascertained as not having one or more package delivery obligations (e.g., ascertained as not having any package delivery obligation) that would be violated if the one or more identified transportation vehicle units 207 transport the one or more end users 10b to one or more destination locations. In various embodiments, the one or more directives may be received from the package/passenger transport network system 200. For these embodiments, the reception of the one or more directives may be as a result of the end user transport request transmitting module 230 transmitting to the package/passenger transport network system 200 the request for transporting the one or more end users 10b.

In response, at least in part, on the transportation vehicle unit directive receiving module 231 receiving the one or more directives, the transportation vehicle unit directing module 232 may be configured to direct the one or more identified transportation vehicle units (e.g., transportation vehicle unit 207) to transport the one or more end users 10b to the one or more destination locations. In some embodiments, the transportation vehicle unit directing module 232 may further include one or more additional modules including a passenger obligation compliance determining module 240 and/or a replacement transportation vehicle unit directing module 241. The passenger obligation compliance determining module 240 may be configured to determine that at least one of the identified transportation vehicle units is unable to meet its passenger transport obligation[s] for transporting at least one of the one or more end users 10b. Upon the passenger obligation compliance determining module 240 determining that at least one of the identified transportation vehicle units is unable to meet its passenger transportation obligation[s], the replacement transportation vehicle unit directing module 241 may be configured to direct at least one replacement transportation vehicle unit 207 to replace at least one of the identified transportation vehicle units 207 in fulfilling the passenger transport obligation[s] of the at least one of the identified transportation vehicle units 207.

As further illustrated, the package/passenger transport intermediate network entity 201 may further include storage 291 (e.g., volatile and/or non-volatile memory for storing various data including package delivery and passenger transport assignments, end user preferences, driver preferences, current statuses of transportation vehicle units, etc.), an end user interfacing module 245 (which may be configured to receive one or more requests for transporting of one or more end users, and for transmitting to one or end user devices 20b confirmation that one or more transportation vehicle units 207 have been assigned to transport the one or more end users 10b), a transportation vehicle unit tracking module 246 (which may be designed to track location[s] and/or status[es] of one or more transportation vehicle units 207), and/or a update information transmitting/receiving module 247 (which may be designed to transmit updated information related to status[es]/location[s] of one or more transportation vehicle units 207 and/or end users 10b).

The package/passenger transport intermediate network entity 201 may additionally or alternatively include a package delivery request receiving module 250, a delivery vehicle identifying module 251, and/or a delivery directive transmitting module 252. The package delivery request receiving module 250 may be designed to receive one or more requests for delivering one or more packages, the one or more requests to be received may indicate one or more delivery requirements (e.g., requires vehicles with A/C, delivery deadline, delivery time window, etc.). The delivery vehicle identifying module 251, on the other hand, may be designed to identify or ascertain one or more transportation vehicle units 207 to deliver the one or more packages based at least in part on ability of the one or more identified transportation vehicle units 207 to deliver the one or more packages in accordance at least with the one or more delivery requirements indicated through the request received by the package delivery request receiving module 250. Meanwhile, the delivery directive transmitting module 252 may be designed to transmit to the one or more identified transportation vehicle units 207 one or more directives to deliver one or more packages.

Referring particularly now to the package/passenger transport computing device 205 of FIG. 1 (e.g., see bottom half of FIG. 1AJ) which may be a dedicated device or a general purpose computing device (e.g., a Smartphone or a tablet computer running one or more specialized applications) that may be in the possession of a driver or being carried by a transportation vehicle 206. In various embodiments, the package/passenger transport computing device 205 may include one or more modules including a package delivery directive receiving module 260 and/or an end user transport directive providing module 261. The package delivery directive receiving module 260 that may be designed to receive one or more package delivery directives that direct a transportation vehicle unit 207 to deliver one or more packages. In some cases, the one or more directives may be received from a package/passenger transport network system 200 or from a package/passenger transport intermediate network entity 201. In some cases, the package delivery directive receiving module 260 may further include a package delivery job confirmation transmitting module 263 that is configured to transmit (either to the package/passenger transport network system 200 or to the package/passenger transport intermediate network entity 201) confirmation of acceptance or rejection of package delivery assignment to deliver one or more packages (e.g., parcels).

In contrast, the end user transport directive providing module 261 may be designed to provide (e.g., produce or display) one or more end user transport directives that direct the transportation vehicle unit 207 to transport one or more end users 10b, the transport of the one or more end users 10b to be in accordance with the one or more end user transport directives and not to interfere with the delivery of the one or more packages in accordance with the one or more package delivery directives that was received by, for example, the package delivery directive receiving module 260. As further illustrated, in some cases, the end user transport directive providing module 261 may further include an end user transport directive receiving module 262 (which may be designed to receive the one or more end user transport directives that direct the transportation vehicle unit 207 to transport one or more end users 10b) and/or an end user transport directive receiving module 263 (which may be designed to determine that transport of one or more end users 10b in accordance with one or more received end user transport directives will not interfere with the successful delivery of the one or more packages in accordance with the one or more package delivery directives).

In the same or alternative embodiments, the package/passenger transport computing device 205 may additionally or alternative include one or more other modules including, for example, a package delivery obligation update transmitting module 265, an end user transport obligation update transmitting module 266, a transport status update transmitting module 267, and/or an end user transport job confirmation transmitting module 268. The package delivery obligation update transmitting module 265 may be configured to transmit package delivery obligation updates (e.g., updates that indicate that a package obligation can be cancelled as a result of successful delivery of a package) to, for example, the package/passenger transport intermediate network entity 201 and/or to the package/passenger transport network system 200. The end user transport obligation update transmitting module 266, on the other hand, may be designed to transmit end user transport obligation updates (e.g., updates that indicates current passenger transport obligations) to, for example, the package/passenger transport intermediate network entity 201 and/or to the package/passenger transport network system 200. Meanwhile, the transport status update transmitting module 267 may be designed to transmit status information (e.g., available for package or passenger transport, availability for a particular time window, etc.) related the associated transportation vehicle unit 207. In some cases, the status information may be transmitted to, for example, the package/passenger transport intermediate network entity 201 and/or to the package/passenger transport network system 200. Finally, the end user transport job confirmation transmitting module 268 may be designed to transmit (e.g., transmit to the package/passenger transport intermediate network entity 201 and/or to the package/passenger transport network system 200) confirmation of acceptance or rejection of end user transport assignment to transport one or more end users 10b.

Passenger Pooling Feature

Referring now to FIG. 1, in particular to FIGS. 1G and 1H, illustrating a group of independent end users 10c who may request, via end user devices 309, to be car-pooled using one or more transportation vehicle units 308 (e.g., a transportation vehicle 307, a human or robotic driver, and a passenger pooling transport computing device 205). The phrase “independent” end user or users will be used herein because the end users may be requesting carpooling services completely independently from each other. In response at least in part to the requests submitted by the group of independent end users 10c, one or more transportation vehicle units 308 may be directed to transport at least one subgroup of the group of independent end users 10c. In some cases, the matching or assigning of at least a subgroup of the group of independent end users 10c to a transportation vehicle unit 308 for purposes of carpooling may be accomplished, for example, by passenger pooling network system 302. Note that in various embodiments, the end user devices 309 of the group of independent end users 10c may be in direct communication with the passenger pooling network system 302 or may communicate with the passenger pooling network system 302 via a passenger pooling intermediate network entity 304.

Referring particularly now to the passenger pooling network system 302 of FIG. 1 (see, for example, FIG. 1J), which may be a network device such as a server or a workstation, or a plurality of network devices (e.g., servers, workstations, storage devices, etc., or “the cloud”). In some cases, the passenger pooling network system 302 may be associated with (e.g., controlled by) a small to mid-sized company (e.g., Uber, Lyft, Yellow Cab Company) or may be associated with, for example, a big data company 4 (e.g., Amazon, Google, Microsoft, etc.). In various embodiments, the passenger pooling network system 302 may include one or more modules/components including, for example, a transport requesting receiving module 310, an end user assigning module 311, and/or a result transmitting module 312.

In various embodiments, the transport request receiving module 310 may be designed to receive two or more requests to transport two or more independent end users 10c, respectively. In some cases, the different requests may be received separately from different end user devices 309. In other cases, the different requests may be received from a passenger pooling intermediate network entity 304. In contrast, the end user assigning module 311 may be designed to assign the two or more independent end users 10c to a transportation vehicle unit 308 for transporting the two or more end users 10c to one or more destination locations based, at least in part, on one or more driver inputs related to the two or more end users 10c.

As further illustrated, the end user assigning module 311 may further include one or more additional modules including, in some cases, a nearby end user determining module 316, a common destination end user determining module 317, and/or a preferred end user determining module 318. The nearby end user determining module 316 may be designed to determine which of a plurality of independent end users 10c who requested transportation are nearby end users 10c who are departing from the same location or from nearby locations. In contrast, the common destination end user determining module 317 may be designed to determine which of the nearby end users are common destination end users who are intending to travel to the same destination or to nearby destinations. Meanwhile the preferred end user determining module 318 may be designed to determine or select from the common destination end users the one or more independent end users 10c who may be assigned to the transportation vehicle unit 308 based, at least in part, one or more preferences (e.g., preference that passengers are going to the same destination, that all passengers have certain ratings, and so forth) of the driver of the transportation vehicle unit 308 and based, at least in part, on one or more preferences of the one or more independent end users 10c.

In the same or alternative embodiments, the end user assigning module 311 may additionally or alternatively include an available transportation vehicle unit determining module 320, an acceptable end user determining module 321, an acceptable transportation vehicle unit determining module 322, and/or a transportation vehicle unit selecting module 323. In various embodiments the available transportation vehicle unit determining module 320 may be designed to determine which of a plurality of transportation vehicle units 308 are available transportation vehicle units that are available to rendezvous with and transport the two or more independent end users 10c from one or more pickup locations to one or more destination locations. The acceptable end user determining module 321 may, on the other hand, be designed to determine whether the two or more independent end users 10c are acceptable by each of the driver[s] of each of the available transportation vehicle unit[s] 308. The acceptable transportation vehicle unit determining module 322 may be designed to determine which of the available transpiration vehicle units (and/or associated drivers) are acceptable to the two or more independent end users 10c. Meanwhile, the transportation vehicle unit selecting module 323 may be designed to select a transportation vehicle unit 308 to transport the two or more independent end users 10c based, at least in part, on the determining which of the plurality of transportation vehicle units are available transportation vehicle units, determining whether the two or more independent end users 10c are acceptable by each of the driver[s] of each of the available transportation vehicle unit[s], and determining which of the available transpiration vehicle units (and/or associated drivers) are acceptable to the two or more independent end users 10c.

In the same or alternative embodiments, the end user assigning module 311 may additionally or alternatively include a proposed passenger list transmitting module 324 (which may be designed to transmit to, for example, a transportation vehicle unit 308 a proposed passenger list), a driver approval receiving module 325 (which may be designed to receive from a driver approval of the each of passengers listed in the proposed passenger list), and a passenger listing modifying module 326 (which may be designed to modify a proposed passenger list if one or more of the listed passengers are not approved by the driver).

In contrast to the end user assigning module 311, the result transmitting module 312 may be designed to transmit one or more results of the assignments of the two or more independent end users 10c to one or more transportation vehicle units 308 for car-pooling transportation. In some embodiments, the results may be transmitted directly or indirectly (e.g., via passenger pooling intermediate network entity 304) to the one or more end user devices 309. In the same or different embodiments, the results may additionally or alternatively be transmitted directly or indirectly (e.g., via passenger pooling intermediate network entity 304) to one or more passenger pooling transport computing devices 306. In some cases, the result transmitting module 312 may further include a transport directive transmitting module 327 (which may be designed to transmit to the transportation vehicle unit 308 (which was selected for carpooling two or more independent end users 10c) one or more transport directives that direct the transportation vehicle unit 308 to transport the two or more independent end users 10c) and/or a passenger pooling directive transmitting module 328 (which may be configured to transmit to the two or more independent end users 10c one or more passenger pooling directives that directs the two or more end users 10c to the transportation vehicle unit 308 assigned to transport the two or more end users 10c).

As further illustrated, the passenger pooling network system 302 may further include other modules/components in various alternative embodiments including, in some cases, an end user replacement module 330 and/or storage 390 (e.g., volatile and/or non-volatile memory for storing various information including, for example, end user preferences, driver preferences, carpooling assignments of transportation vehicle units 308, and so forth). In various embodiments, the end user replacement module 330 may be designed to replace assignment of a first end user who previously was assigned to the transportation vehicle unit 308 with a replacement assignment of a second end user who satisfies the car-pooling criteria for the transportation vehicle unit 308.

In some embodiments, the end user replacement module 330 may further include one or more modules including, for example, a cancelling end user detecting module 331, a replacement end user seeking module 332, and/or an assignment notification transmitting module 333. The cancelling end user detecting module 331 may be designed to detect that one or more end users who were previously assigned to a transportation vehicle unit 308 is/are unable to rendezvous with the transportation vehicle unit 308 in accordance with the assignment. The replacement end user seeking module 332, in contrast, may be designed to seek one or more replacement end users to replace the one or more cancelling end users based on the one or more replacement end users satisfying the car-pooling criteria (e.g. all passengers going to same common destination, all passengers are males, and so forth) of the transpiration vehicle unit 308. While the assignment notification transmitting module 333 may be designed to transmit one or more notifications to one or more replacement end users as to their assignment[s] to the transportation vehicle unit 308 for transportation to one or more destination locations.

As illustrated in FIG. 1, in some embodiments, the passenger pooling network system 302 may communicate directly with end user devices 309 of end users 10c and/or passenger pooling transport computing devices 306 of transportation vehicle units 308. Alternatively, the passenger pooling network system 302 may communicate indirectly with end user devices 309 of end users 10c and/or passenger pooling transport computing devices 306 of transportation vehicle units 308 via passenger pooling intermediate network entity 304.

Referring particularly now to the passenger pooling intermediate network entity 304 of FIG. 1 (see, for example, FIG. 1s), which in some cases may be a network system such as a server[s], workstation[s], and so forth. In some cases, the passenger pooling intermediate network entity 304 may be associated with (e.g., controlled by) a passenger transport company 2 (e.g., a transportation network company such as Uber, Lyft, Yellow Cab Company, and so forth). As illustrated, the passenger pooling intermediate network entity 304 may include one or more modules/components including, among other things, a transport request transmitting module 340, a transport directive receiving module 341, and/or a transportation vehicle unit directing module 342. In various embodiments, the transport request transmitting module 340 may be configured to transmit one or more requests for, for example, a transportation vehicle unit 308 to transport two or more independent end users 10c. In some cases, the one or more requests may be transmitted to the passenger pooling network system 302.

The transport directive receiving module 341, in contrast, may be designed to receive one or more transport directives that direct a (identified) transportation vehicle unit 308 to transport two or more independent end users 10c who have been at least pre-approved by a driver (robotic or human driver) of the transportation vehicle unit 308 for transporting by the transportation vehicle unit 308. An independent end user 10c may be pre-approved by the driver if, for example, the independent end user 10c meets certain driver preference[s] (e.g., a particular gender, going to a particular destination location, currently located at a particular location, having no luggage or baggage, only passengers with high ratings, and so forth). In various embodiments, the one or more transport directives may be received from the passenger pooling network system 302 and may been have been as a result of transmitting the one or more requests by the transport request transmitting module 340.

In various embodiments, the transportation vehicle unit directing module 342 may be designed to direct the transportation vehicle unit 308 (e.g., driver) to transport the two or more independent end users 10c to one or more destination locations in response, at least in part, to the reception of the one or more transport directives by, for example, the transport directive receiving module 341. In various embodiments, the transportation vehicle unit directing module 342 may direct the transportation vehicle unit 308 by transmitting to the transportation vehicle unit 308 one or more directives (e.g., instructions) that directs the transportation vehicle unit 308 to transport two or more independent (and identified) end users 10c to one or more destination locations. As further illustrated, the transportation vehicle unit directing module 342 in some embodiments may further include one or more additional modules including, for example, a cancelling end user detecting module 343, a replacement end user information obtaining module 344, and/or an assignment notification transmitting module 345. In various embodiments, the cancelling end user detecting module 343 may be designed to detect that one or more of the independent end users 10c who were previously assigned to a transportation vehicle unit 308 for carpooling is/are unable to rendezvous with the transportation vehicle unit 308 in accordance with the one or more transport directive. In some cases, the detection may be based on, for example, a cancelling end user (the end user 10c) providing notification that the cancelling end user is cancelling his/her carpooling reservation. In other cases, the detection may be based on tracking data of an independent end user 10c (who appears not to be able to rendezvous with the carpooling transportation vehicle unit 308 based on the independent end user's location).

In response at least in part to the cancelling end user detecting module 343 detecting that one or more independent end users 10c previously assigned to a transportation vehicle unit 308 for car-pooling services are unable to rendezvous with their assigned transportation vehicle unit 308, the replacement end user information obtaining module 344 may be designed to obtain information identifying one or more replacement end users to replace the one or more cancelling independent end users and who satisfy the car-pooling criteria (e.g., to be picked up at the same or similar locations as those already assigned to the transportation vehicle unit, going to the same or similar destinations, etc.) of the transpiration vehicle unit 308. In some cases, the information may be obtained from storage 391. Alternatively, such information may be obtained from the passenger pooling network system 302.

In contrast to the replacement end user information obtaining module 344, the assignment notification transmitting module 345 may be designed to transmit notification[s] to the transportation vehicle unit 308 identifying the one or more replacement end users. In some cases, one or more notifications may also be transmitted to the one or more replacement end users (e.g., transmitted to one or more end user devices 309) notifying the replacement end users as to their carpooling assignments (e.g., identification of the carpooling transportation vehicle unit 308, pickup time, pickup location, etc.).

As further illustrated, in some embodiments, the passenger pooling intermediate network entity 304 may additionally or alternatively include one or more other modules including, for example, an end user interfacing module 346, a transportation vehicle unit tracking module 347, and/or an update information transmitting/receiving module 348. In various embodiments, the end user interfacing module 346 may be designed to receive an independent end user request for transportation (e.g., carpooling transportation), and for transmitting to the independent end user 10c (e.g., transmitting to an end user device 309) confirmation that one or more transportation vehicle units 308 have been assigned to transport the independent end user 10c. In contrast, the transportation vehicle unit tracking module 347 may be designed to track locations and/or statuses (e.g., currently available for transporting passengers) of one or more transportation vehicle units 308. The update information transmitting/receiving module 348, on the other hand, may be designed to transmit updated information related to statuses/locations of one or more transportation vehicle units 308 and/or independent end users 10c. Such information may be transmitted to, for example, the passenger pooling network system 302.

Referring now to the passenger pooling transport computing device 306 of FIG. 1 (see, for example, FIG. 1AO) which may be a dedicated device or a general purpose computing device (e.g., a Smartphone or a tablet computer running one or more specialized applications) that may be in the possession of a driver or being carried by a transportation vehicle 307. In various embodiments, the passenger pooling transport computing device 306 may include one or more modules/components including, among other things, a preference transmitting module 350, a transport directive receiving module 351, and/or a presenting module 352. In various embodiments, the preference transmitting module 350 may be configured to transmit one or more preferences related to preferred characteristics of independent end users 10c to be transported by a transportation vehicle unit 308. In some cases, the one or more preferences may be transmitted to the passenger pooling network system 302 or to the passenger pooling intermediate network entity 304 (which may or may not relay the preference information to the passenger pooling network system 302).

In contrast, the transport directive receiving module 351 may be designed to receive one or more transport directives that direct the transportation vehicle unit 308 to transport two or more independent end users 10c who are compliant with the one or more preferences. In various embodiments, the one or more transport directives may be received from the passenger pooling network system 302 or from the passenger pooling intermediate network entity 304. The presenting module 352, on the other hand, may be designed to present the one or more directives (e.g., via a user interface such as via a touchscreen).

As further illustrated, in various embodiments, the presenting module 352 may additionally or alternatively include one or more additional modules including, for example, an end user acceptance/rejection receiving module 354, a replacement end user identifying module 355, and/or a replacement end user notifying module 356. In various embodiments, the end user acceptance/rejection receiving module 354 may be designed to receive driver input indicting acceptance or rejection of one or more of the independent end users 10c assigned to be car-pooled by the transportation vehicle unit 308. In contrast, the replacement end user identifying module 355 may be designed to identify (ascertain), in response to rejection of one or more independent end users 10c, one or more replacement end users to replace those independent end users rejected by the (robotic or human) driver. Meanwhile, the replacement end user notifying module 356 may be designed to notify the one or more replacement end users to their assignment to the transportation vehicle unit 308 for carpooling transporting to one or more destination locations.

This application may include a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Those having skill in the art will recognize that the state of the art has progressed to the point where there is little distinction left between hardware, software (e.g., a high-level computer program serving as a hardware specification), and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software (e.g., a high-level computer program serving as a hardware specification), and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software (e.g., a high-level computer program serving as a hardware specification) implementation; or, yet again alternatively, the implementer may opt for some combination of hardware, software (e.g., a high-level computer program serving as a hardware specification), and/or firmware in one or more machines, compositions of matter, and articles of manufacture, limited to patentable subject matter under 35 U.S.C. §101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software (e.g., a high-level computer program serving as a hardware specification), and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high-level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In a general sense, those skilled in the art will recognize that the various embodiments described herein can be implemented, individually and/or collectively, by various types of electro-mechanical systems having a wide range of electrical components such as hardware, software (e.g., a high-level computer program serving as a hardware specification), firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software (e.g., a high-level computer program serving as a hardware specification), firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software (e.g., a high-level computer program serving as a hardware specification), and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, Verizon, AT&T, etc.), or (g) a wired/wireless services entity (e.g., Sprint, AT&T, Verizon, etc.), etc.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software (e.g., a high-level computer program serving as a hardware specification) components that deliver or assist in the delivery of computational and/or storage capacity, including, but not limited to, one or more of a client, an application, a platform, an infrastructure, and/or a server The cloud may refer to any of the hardware and/or software (e.g., a high-level computer program serving as a hardware specification) associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, an application back-end, and/or a programmed application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more program, module, and/or development tools hosted on an infrastructure (e.g., a computing platform and/or a solution stack from which the client can create software-based interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Referring now to the system, in an embodiment, a computationally-implemented method may include acquiring a source document, wherein the source document includes a particular set of one or more phrases, and providing an updated document in which at least one phrase of the particular set of phrases has been replaced with a replacement phrase, wherein the replacement phrase is based on one or more acquired potential reader factors that are used to analyze the document and the particular set of phrases.

Referring again to the system, in an embodiment, a computationally-implemented method may include one or more of accepting a submission of a document that includes a particular set of phrases, facilitating acquisition (e.g., by selecting one or more menu options in a UI) of one or more potential reader factors, and receiving an updated document in which at least one phrase of the particular set of phrases has been replaced with a replacement phrase, wherein the replacement phrase is based on one or more acquired potential reader factors that are used to analyze the document and the particular set of phrases.

Referring again to the system, in an embodiment, a computationally-implemented method may include one or more of receiving a corpus of related texts, generating organized data that regards the related texts in an organized format, and transmitting the organized data that regards the related texts in an organized format (e.g., a relational database) for use in an automated document analysis module, wherein the organized data that regards the related texts in an organized format is based on a performance of an analysis on the received corpus.

Referring again to the system, in an embodiment, a computationally-implemented method may include one or more of accepting a submission of a document (e.g., claim, brief, novel) to be evaluated, facilitating selection of a panel of judgment corpora (e.g., through a UI) that will be used as a basis for a predictive output (score, likelihood of reversal), and presenting the predictive output, wherein the predictive output is based on an analysis of the judgment corpora that is applied to the accepted submitted document.

Referring again to the system, in an embodiment, a computationally-implemented method may include one or more of acquiring a text that is configured to be transmitted to a social network for publication, performing analysis on the acquired text to determine a predictive output, and transmitting the predictive output configured to be presented prior to publication of the text to the social network.

Referring again to the system, in an embodiment, a computationally-implemented method may include accepting a submission of a text configured to be distributed to a social network, facilitating selection of post analytics (through the UI, whether to sample among everyone, friends, or a custom set), and presenting a predictive output that represents an estimated feedback to the text prior to distribution of the text to the social network.

Referring again to the system, in an embodiment, a computationally-implemented method may include accepting a source document (e.g., a patent document for which a claim chart will be generated), facilitating acquisition of a data structure that represents a lexical pairing of words in the source document, acquiring (e.g., receiving or generating) one or more target documents that are related to the source document, and presenting a chart document (e.g., a claim chart) that maps the source document to the target document.

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

Throughout this application, the terms “in an embodiment,” ‘in one embodiment,” “in some embodiments,” “in several embodiments,” “in at least one embodiment,” “in various embodiments,” and the like, may be used. Each of these terms, and all such similar terms should be construed as “in at least one embodiment, and possibly but not necessarily all embodiments,” unless explicitly stated otherwise. Specifically, unless explicitly stated otherwise, the intent of phrases like these is to provide non-exclusive and non-limiting examples of implementations of the invention. The mere statement that one, some, or may embodiments include one or more things or have one or more features, does not imply that all embodiments include one or more things or have one or more features, but also does not imply that such embodiments must exist. It is a mere indicator of an example and should not be interpreted otherwise, unless explicitly stated as such.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1.-4. (canceled)

5. A computationally-implemented method implemented by hardware, comprising:
transmitting a request for transporting one or more end users towards a destination location;
receiving the request for transporting the one or more end users towards the destination location;
providing a travel plan for facilitating the one or more end users to travel to the destination location from a starting location, the travel plan identifying at least two route legs including at least one transport route leg that calls for at least one transportation vehicle unit to transport the one or more end users over the transport route leg;
transmitting at least one or more portions of the travel plan;
receiving the at least one or more portions of the travel plan;
presenting the at least one or more portions of the travel plan including an end user option to accept or decline the travel plan;
transmitting confirmation data indicative of acceptance of the at least one transportation vehicle unit to transport the one or more end users over the transport route leg;
receiving the confirmation data;
directing, in response at least in part to receiving the confirmation data, the at least one transportation vehicle unit to rendezvous with the one or more end users at a rendezvous location in order to transport the one or more end users over the transport route leg;
transmitting a request for transporting one or more second end users to at least a second destination location;
receiving the request for transporting the one or more second end users to at least a second destination location;
identifying a second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit;
transmitting one or more directives that direct the second transportation vehicle unit to rendezvous with the one or more second end users in order to transport the one or more end users to at least the second destination location;
receiving the one or more directives;
transmitting one or more instructions to a transport computing device associated with the second transportation vehicle unit to transport the one or more second end users;
receiving one or more package delivery directives that direct the second transportation vehicle unit to deliver one or more packages;
receiving the one or more instructions to transport the one or more second end users, the transport of the one or more end users to be in accordance with the one or more instructions and not to interfere with the delivery of the one or more packages in accordance with the one or more package delivery directive;
presenting the one or more instructions to transport the one or more second end users;
transmitting two or more carpooling requests to respectively transport two or more independent end users including at least a first carpooling request to transport a first one or more independent end users and a second carpooling request to transport a second one or more end users;
receiving the two or more carpooling requests to transport the two or more independent end users;
assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle;
transmitting one or more results of assignment of the first one or more independent end users and the second one or more end users to the third transportation vehicle unit;
receiving the one or more results of the assignment of the first one or more independent end users and the second one or more end users to the third transportation vehicle unit;
transmitting to a transport computing device associated with the third transportation vehicle unit one or more transport directives to transport the first one or more independent end users and the second one or more end users to one or more destination locations in response to receiving the one or more results of the assignment of the first one or more independent end users and the second one or more end users to the third transportation vehicle unit;
transmitting one or more preferences of the driver associated with the third transportation vehicle related to preferred characteristics of independent end users to be selected for transport by the third transportation vehicle unit;
receiving the one or more transport directives to transport the first one or more independent end users and the second one or more end users to one or more destination locations; and
presenting the one or more transport directives.

6. The computationally-implemented method of claim 5, wherein said transmitting a request for transporting one or more end users towards a destination location comprises:
transmitting the request for transporting the one or more end users towards the destination location by relaying a request for transporting the one or more end users towards the destination location that was received from a computing device associated with at least one of the one or more end users.

7. The computationally-implemented method of claim 5, wherein said presenting the at least one or more portions of the travel plan including an end user option to accept or decline the travel plan comprises:
presenting the at least one or more portions of the travel plan by presenting at least one or more portions of a travel plan that calls for a first transportation vehicle to transport the one or more end users over a first route leg of the travel plan and a second transportation vehicle to transport the one or more end users over a second route leg.

8. The computationally-implemented method of claim 5, wherein said presenting the at least one or more portions of the travel plan including an end user option to accept or decline the travel plan further comprising:
presenting at least one or more portions of a travel plan for facilitating the one or more end users to travel towards the destination location from the starting location and that further identifies a rendezvous location and/or rendezvous time for the one or more end users to rendezvous with the at least one transportation vehicle unit, the at least one or more portions of the travel plan to be presented identifying the rendezvous location and/or rendezvous time for the one or more end users to rendezvous with the at least one transportation vehicle unit.

9. The computationally-implemented method of claim 8, wherein said presenting at least one or more portions of a travel plan for facilitating the one or more end users to travel to the destination location from the starting location and that further identifies a rendezvous location and/or time for the one or more end users to rendezvous with the at least one transportation vehicle unit, the at least one or more portions of the travel plan to be presented identifying the rendezvous location and/or time for the one or more end users to rendezvous with the at least one transportation vehicle unit further comprising:
presenting at least one or more portions of another travel plan for facilitating the one or more end users to travel to the destination location in response to determination that the one or more end users and/or the transportation vehicle unit is unable to rendezvous at the rendezvous location and/or rendezvous time.

10. The computationally-implemented method of claim 5, wherein said directing, in response at least in part to receiving the confirmation data, the at least one transportation vehicle unit to rendezvous with the one or more end users at a rendezvous location in order to transport the one or more end users over the transport route leg comprises:
directing the at least one transportation vehicle unit to rendezvous with the one or more end users in response to detecting that the one or more end users are within a predefined travel distance from the rendezvous location, a travel distance being the distance traveled by the one or more end users along at least a portion of a travel route defined by the travel plan.

11. The computationally-implemented method of claim 5, wherein said identifying a second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit comprises:
identifying the second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit, the one or more package delivery obligations being one or more obligations to deliver the one or more packages by a particular point or range in time.

12. The computationally-implemented method of claim 11, wherein said identifying the second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit, the one or more package delivery obligations being one or more obligations to deliver the one or more packages by a particular point or range in time further comprising:
identifying the second transportation vehicle unit to transport the one or more second end users to at least the second destination location based, at least in part, on determination that transporting by the second transportation vehicle unit of the one or more second end users will not violate one or more transport obligations for transporting the one or more second end users to the at least the second destination location.

13. The computationally-implemented method of claim 12, wherein said identifying the second transportation vehicle unit to transport the one or more second end users to at least the second destination location based, at least in part, on determination that transporting by the second transportation vehicle unit of the one or more second end users will not violate one or more transport obligations for transporting the one or more second end users to the at least the second destination location comprises:
identifying the second transportation vehicle unit to transport the one or more second end users to at least the second destination location based, at least in part, on determination that transporting by the second transportation vehicle unit of the one or more second end users will not violate one or more transport obligations for transporting the one or more second end users to the at least the second destination location, the one or more transport obligations being one or more obligations to transport to at least the second destination location one or more pieces of luggage and/or multiple end users.

14. The computationally-implemented method of claim 5, wherein said identifying a second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit comprises:
identifying the second transportation vehicle unit to transport the one or more second end users to at least the second destination location based, at least in part, on determination that the second transportation vehicle unit that is identified satisfying one or more transportation vehicle unit preferences of at least one of the one or more second end users.

15. The computationally-implemented method of claim 14, wherein said identifying the second transportation vehicle unit to transport the one or more second end users to at least the second destination location based, at least in part, on determination that the second transportation vehicle unit that is identified satisfying one or more transportation vehicle unit preferences of at least one of the one or more second end users comprises:
identifying the second transportation vehicle unit to transport the one or more second end users to at least the second destination location based, at least in part, on determination that the second transportation vehicle unit that is identified satisfying one or more transportation vehicle unit preferences of at least one of the one or more second end users, the one or more transportation vehicle unit preferences being one or more vehicle type preferences and/or driver one or more preferences.

16. The computationally-implemented method of claim 5, wherein said transmitting one or more instructions to a transport computing device associated with the second transportation vehicle unit to transport the one or more second end users comprises:
transmitting the one or more instructions to the transport computing device associated with the second transportation vehicle unit to transport the one or more second end users, the one or more instructions at least identifying rendezvous location and/or rendezvous time for rendezvousing with the one or more second end users.

17. The computationally-implemented method of claim 5, wherein said transmitting one or more instructions to a transport computing device associated with the second transportation vehicle unit to transport the one or more second end users comprises:
transmitting the one or more instructions to the transport computing device associated with the second transportation vehicle unit to transport the one or more second end users, the one or more instructions at least providing information identifying at least one of the one or more second end users.

18. The computationally-implemented method of claim 5, wherein said transmitting one or more instructions to a transport computing device associated with the second transportation vehicle unit to transport the one or more second end users further comprising:
transmitting one or more instructions to a transport computing device associated with a substitute transportation vehicle unit to transport the one or more second user upon determining that the transportation vehicle unit will not be able to rendezvous with the one or more second end user in order to transport the one or more second end users to the at least the second destination.

19. The computationally-implemented method of claim 5, wherein said receiving one or more package delivery directives that direct the second transportation vehicle unit to deliver one or more packages comprises:
receiving the one or more package delivery directives that direct the second transportation vehicle unit including receiving one or more package delivery directives that identifies one or more package pickup locations, one or more drop-off locations, one or more delivery deadlines, and/or number of packages for delivery.

20. The computationally-implemented method of claim 5, wherein said receiving one or more package delivery directives that direct the second transportation vehicle unit to deliver one or more packages further comprising:
transmitting a confirmation of acceptance of package delivery assignment as defined by the one or more package delivery directives.

21. The computationally-implemented method of claim 5, further comprising:
transmitting status information related to delivery of the one or more packages by the second transportation vehicle unit.

22. The computationally-implemented method of claim 5, wherein said transmitting two or more carpooling requests to respectively transport two or more independent end users including at least a first carpooling request to transport a first one or more independent end users and a second carpooling request to transport a second one or more end users comprises:
transmitting the two or more carpooling requests by relaying two or more carpooling requests received from two or more end user computing devices.

23. The computationally-implemented method of claim 5, wherein said receiving the two or more carpooling requests to transport the two or more independent end users comprises:
receiving the two or more carpooling requests including receiving information indicating one or more preferences of at least one of the end users of the first one or more independent end users and/or the second one or more end users related to other carpooling passengers.

24. The computationally-implemented method of claim 5, wherein said assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle comprises:
assigning the first one or more independent end users and the second one or more end users to the third transportation vehicle unit for transporting the first one or more independent end users and the second one or more end users, the first one or more independent end users and the second one or more independent end users having been determined to satisfy one or more end user preferences of the driver related to one or more end user characteristics related to gender, profession, interest, and/or group affiliation.

25. The computationally-implemented method of claim 5, wherein said assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle comprises:
assigning the first one or more independent end users and the second one or more end users to the third transportation vehicle unit for transporting the first one or more independent end users and the second one or more end users, the first one or more independent end users and the second one or more independent end users having been selected for transport by the third transportation vehicle unit based, at least in part, on determining that the first one or more independent end users and the second one or more independent end users are requesting to be transported to the same destination location.

26. The computationally-implemented method of claim 5, wherein said assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle comprises:
assigning the first one or more independent end users and the second one or more end users to the third transportation vehicle unit for transporting the first one or more independent end users and the second one or more end users, the first one or more independent end users and the second one or more independent end users having been selected for transport by the third transportation vehicle unit based, at least in part, on determining that the first one or more independent end users and the second one or more independent end users are located in the near vicinity of each other.

27. The computationally-implemented method of claim 5, wherein said transmitting one or more preferences of the driver associated with the third transportation vehicle related to preferred characteristics of independent end users to be selected for transport by the third transportation vehicle unit comprises:
transmitting the one or more preferences of the drivers by transmitting one or more preferences that one or more end users to be transported by the third transportation vehicle unit be destined for a particular geographic location or destined for a particular geographic area.

28. The computationally-implemented method of claim 5, wherein said transmitting one or more preferences of the driver associated with the third transportation vehicle related to preferred characteristics of independent end users to be selected for transport by the third transportation vehicle unit comprises:
transmitting the one or more preferences of the drivers by transmitting one or more preferences that one or more end users to be transported by the third transportation vehicle unit be of a particular gender, have the same interests, or be affiliated with a common group.

29. The computationally-implemented method of claim 5, wherein said presenting the one or more transport directives comprises:
identifying one or more replacement end users for transporting, the one or more replacement end users replacing one or more independent end users previously assigned to be transported by the third transportation vehicle unit through the one or more transport directives.

30. A system, comprising:
circuitry for transmitting a request for transporting one or more end users towards a destination location;
circuitry for receiving the request for transporting the one or more end users towards the destination location;
circuitry for providing a travel plan for facilitating the one or more end users to travel to the destination location from a starting location, the travel plan identifying at least two route legs including at least one transport route leg that calls for at least one transportation vehicle unit to transport the one or more end users over the transport route leg;
circuitry for transmitting at least one or more portions of the travel plan;
circuitry for receiving the at least one or more portions of the travel plan;
circuitry for presenting the at least one or more portions of the travel plan including an end user option to accept or decline the travel plan;
circuitry for transmitting confirmation data indicative of acceptance of the at least one transportation vehicle unit to transport the one or more end users over the transport route leg;
circuitry for receiving the confirmation data;
circuitry for directing, in response at least in part to receiving the confirmation data, the at least one transportation vehicle unit to rendezvous with the one or more end users at a rendezvous location in order to transport the one or more end users over the transport route leg;
circuitry for transmitting a request for transporting one or more second end users to at least a second destination location;
circuitry for receiving the request for transporting the one or more second end users to at least a second destination location;
circuitry for identifying a second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit;
circuitry for transmitting one or more directives that direct the second transportation vehicle unit to rendezvous with the one or more second end users in order to transport the one or more end users to at least the second destination location;
circuitry for receiving the one or more directives;
circuitry for transmitting one or more instructions to a transport computing device associated with the second transportation vehicle unit to transport the one or more second end users;
circuitry for receiving one or more package delivery directives that direct the second transportation vehicle unit to deliver one or more packages;
circuitry for receiving the one or more instructions to transport the one or more second end users, the transport of the one or more end users to be in accordance with the one or more instructions and not to interfere with the delivery of the one or more packages in accordance with the one or more package delivery directive;
circuitry for presenting the one or more instructions to transport the one or more second end users;
circuitry for transmitting two or more carpooling requests to respectively transport two or more independent end users including at least a first carpooling request to transport a first one or more independent end users and a second carpooling request to transport a second one or more end users;
circuitry for receiving the two or more carpooling requests to transport the two or more independent end users;
circuitry for assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle;
circuitry for transmitting one or more results of assignment of the first one or more independent end users and the second one or more end users to the third transportation vehicle unit;
circuitry for receiving the one or more results of the assignment of the first one or more independent end users and the second one or more end users to the third transportation vehicle unit;
circuitry for transmitting to a transport computing device associated with the third transportation vehicle unit one or more transport directives to transport the first one or more independent end users and the second one or more end users to one or more destination locations in response to receiving the one or more results of the assignment of the first one or more independent end users and the second one or more end users to the third transportation vehicle unit;
circuitry for transmitting one or more preferences of the driver associated with the third transportation vehicle related to preferred characteristics of independent end users to be selected for transport by the third transportation vehicle unit;
circuitry for receiving the one or more transport directives to transport the first one or more independent end users and the second one or more end users to one or more destination locations; and
circuitry for presenting the one or more transport directives.

31. A system, comprising:
means for transmitting a request for transporting one or more end users towards a destination location;
means for receiving the request for transporting the one or more end users towards the destination location;
means for providing a travel plan for facilitating the one or more end users to travel to the destination location from a starting location, the travel plan identifying at least two route legs including at least one transport route leg that calls for at least one transportation vehicle unit to transport the one or more end users over the transport route leg;
means for transmitting at least one or more portions of the travel plan;
means for receiving the at least one or more portions of the travel plan;
means for presenting the at least one or more portions of the travel plan including an end user option to accept or decline the travel plan;
means for transmitting confirmation data indicative of acceptance of the at least one transportation vehicle unit to transport the one or more end users over the transport route leg;
means for receiving the confirmation data;
means for directing, in response at least in part to receiving the confirmation data, the at least one transportation vehicle unit to rendezvous with the one or more end users at a rendezvous location in order to transport the one or more end users over the transport route leg;
means for transmitting a request for transporting one or more second end users to at least a second destination location;
means for receiving the request for transporting the one or more second end users to at least a second destination location;
means for identifying a second transportation vehicle unit to transport the one or more second end users to at least the second destination location based, at least in part, on determination that the second transportation vehicle unit that is identified would not violate one or more package delivery obligations of the second transportation vehicle unit if the one or more second end users are transported by the second transportation vehicle unit;
means for transmitting one or more directives that direct the second transportation vehicle unit to rendezvous with the one or more second end users in order to transport the one or more end users to at least the second destination location;
means for receiving the one or more directives;
means for transmitting one or more instructions to a transport computing device associated with the second transportation vehicle unit to transport the one or more second end users;
means for receiving one or more package delivery directives that direct the second transportation vehicle unit to deliver one or more packages;
means for receiving the one or more instructions to transport the one or more second end users, the transport of the one or more end users to be in accordance with the one or more instructions and not to interfere with the delivery of the one or more packages in accordance with the one or more package delivery directive;
means for presenting the one or more instructions to transport the one or more second end users;
means for transmitting two or more carpooling requests to respectively transport two or more independent end users including at least a first carpooling request to transport a first one or more independent end users and a second carpooling request to transport a second one or more end users;
means for receiving the two or more carpooling requests to transport the two or more independent end users;
means for assigning the first one or more independent end users and the second one or more end users to a third transportation vehicle unit for transporting the first one or more independent end users and the second one or more end users, the first one or more independent end users and the second one or more independent end users having been at least pre-approved for transport by a driver associated with the third transportation vehicle;
means for transmitting one or more results of assignment of the first one or more independent end users and the second one or more end users to the third transportation vehicle unit;
means for receiving the one or more results of the assignment of the first one or more independent end users and the second one or more end users to the third transportation vehicle unit;
means for transmitting to a transport computing device associated with the third transportation vehicle unit one or more transport directives to transport the first one or more independent end users and the second one or more end users to one or more destination locations in response to receiving the one or more results of the assignment of the first one or more independent end users and the second one or more end users to the third transportation vehicle unit;
means for transmitting one or more preferences of the driver associated with the third transportation vehicle related to preferred characteristics of independent end users to be selected for transport by the third transportation vehicle unit;
means for receiving the one or more transport directives to transport the first one or more independent end users and the second one or more end users to one or more destination locations; and
means for presenting the one or more transport directives.
